(19) United States
(12) Patent Application Publication
(10) Pub. No.: US 2023/0303872 A1
(43) Pub. Date: Sep. 28, 2023

(54) INK, INK SET, SET OF INK AND PRE-PROCESSING FLUID, METHOD OF DISCHARGING INK, AND INK DISCHARGING DEVICE

(71) Applicants: Hiroshi GOTOU, Kanagawa (JP); Toshiyuki Kobashi, Tokyo (JP); Daisuke Ozaki, Kanagawa (JP)

(72) Inventors: Hiroshi GOTOU, Kanagawa (JP); Toshiyuki Kobashi, Tokyo (JP); Daisuke Ozaki, Kanagawa (JP)

(73) Assignee: Ricoh Company, Ltd., Tokyo (JP)

(21) Appl. No.: 18/187,895

(22) Filed: Mar. 22, 2023

(30) Foreign Application Priority Data
Mar. 23, 2022 (JP) 2022-047183

(51) Int. Cl. C09D 11/36; C09D 11/40; C09D 11/54

(52) U.S. Cl. CPC C09D 11/36; C09D 11/40; C09D 11/54

(57) ABSTRACT

An ink contains a coloring material, an organic solvent comprising an organic solvent A and a compound represented by the following Chemical Formula I

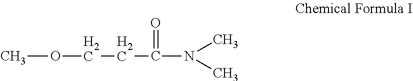

and a resin, wherein the proportion of the entire of the coloring material and the solid content of the resin to the entire of the ink is 15 percent by mass or greater, wherein the organic solvent A contains a polyol with a boiling point of 180 degrees C. or higher and with an equilibrium moisture content of 36 percent by mass or greater at 23 degrees C. and 80 percent RH.

### CROSS-REFERENCE TO RELATED APPLICATIONS

This patent application is based on and claims priority pursuant to 35 U.S.C. § 119 to Japanese Patent Application No. 2022-047183, filed on Mar. 23, 2022, in the Japan Patent Office, the entire disclosure of which is hereby incorporated by reference herein.

### BACKGROUND

### Technical Field

The present disclosure is related to an ink, an ink set, a set of ink and pre-processing fluid, a method of discharging ink, and an ink discharging device.

### Description of the Related Art

Inkjet printing has rapidly become popular because it can readily produce color images with low running costs.

Inkjet printing is employed among many production sites to produce various types of printed matter. It is a method of discharging ink from a discharging nozzle to attach it onto the surface of a substrate, such as paper and fabric. Many inks are now used for inkjet printing.

However, as this inkjet printing is widespread in various fields, the inks need more improvements to form vivid images with excellent rub resistance irrespective of the types of substrates.

### SUMMARY

According to embodiments of the present disclosure, an ink is provided which contains a coloring material, an organic solvent containing an organic solvent A and a compound represented by the following Chemical Formula I

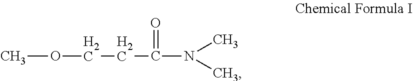

and a resin, wherein the proportion of the entire of the coloring material and the solid content of the resin to the entire of the ink is 15 percent by mass or greater, and the organic solvent A contains a polyol with a boiling point of 180 degrees C. or higher and with an equilibrium moisture content of 36 percent by mass or greater at 23 degrees C. and 80 percent RH.

As another aspect of embodiments of the present disclosure, an ink set is provided which contains a white ink of the ink mentioned above and a color ink of the ink mentioned above.

As another aspect of embodiments of the present disclosure, a set is provided which contains the ink mentioned above and a pre-processing fluid containing water and a flocculant, the flocculant containing at least one member selected from an inorganic metal salt, an organic acid metal salt, an organic acid ammonium salt, and a cationic polymer.

As another aspect of embodiments of the present disclosure, a method of discharging an ink is provided which includes applying the ink mentioned above to a printing medium.

As another aspect of embodiments of the present disclosure, an ink discharging device is provided which contains the ink mentioned above, a container containing the ink, and an ink applying unit for applying the ink to a printing medium.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating the ink discharging device according to an embodiment of the present disclosure;

FIG. 2 is a schematic diagram illustrating a container according to an embodiment of the present invention; and

FIG. 3 is a schematic diagram illustrating an example of an image chart printed with an ink discharging device according to an embodiment of the present disclosure.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Embodiments of the present invention are described in detail below with reference to accompanying drawings. In describing embodiments illustrated in the drawings, specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

According to the present disclosure, an ink is provided which forms an image on textile goods like clothes with excellent discharging stability and rub resistance.

Ink

The ink of the present disclosure contains a coloring material, an organic solvent, and resin. The ink preferably contains water, a surfactant, and other optional components.

The ink is preferably white ink or color ink.

The inks proposed in Japanese Patent Nos. 5900070 and 6766976 involve problems of discharging stability like clogging in discharging nozzles over time and misdirection of ink discharging because the discharging nozzles are temporarily decapped, thereby failing to keep the nozzles in a moisture state. The ink for use in printing on fabric constituting textile goods contains a relatively large amount of a coloring material and water-dispersible resin. Such an ink creates a concern about degradation of discharging stability and deterioration caused by decapping.

Using this ink also raises a concern about rub resistance, causing problems of attachability between a textile goods like clothes and white ink and between white ink and color ink when an image with the white ink and the color ink is formed on the textile goods.

The ink of the present disclosure contains an organic solvent A and the compound represented by the Chemical Formula I below. It preferably contains an organic solvent B.

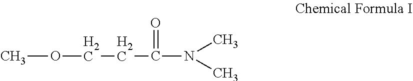

The organic solvent A is a polyol with a boiling point of 180 degrees C. or higher and with an equilibrium moisture content of 36 percent by mass or greater at 23 degrees C. and 80 percent RH.

The organic solvent A and the compound represented by the Chemical Formula I in the ink of the present disclosure improves compatibility with other materials, thereby lowering the viscosity of the ink containing a large amount of solid contents. The compound represented by the Chemical Formula I has an equilibrium moisture content on a par with that of glycerin, enhancing discharging stability.

The compound represented by the Chemical Formula I swells the water-dispersible resin contained in a pre-processing fluid, which is described later, and the water-dispersible resin contained in the ink. The compound thus enhances attachability between a textile goods and a white ink layer and between the white ink layer and a color ink layer, thereby ameliorating rub resistance of the image portion on a textile goods.

Organic Solvent

The organic solvent in the ink of the present disclosure contains the organic solvent A and the compound represented by the Chemical Formula I below. It preferably contains an organic solvent B.

The organic solvent A is a polyol with a boiling point of 180 degrees C. or higher and with an equilibrium moisture content of 36 percent by mass or greater at 23 degrees C. and 80 percent RH.

Inclusion of a polyol with a boiling point of 180 degrees C. or higher and with an equilibrium moisture content of 30 percent by mass or greater at 23 degrees C. and 80 percent RH in the ink of the present disclosure enhances discharging stability of the ink, thereby inhibiting waste ink from fixating on the maintenance mechanism in an image forming apparatus.

The polyol contained in the organic solvent A is not particularly limited and can be suitably selected to suit to a particular application as long as it has a boiling point of 180 degrees C. or higher and an equilibrium moisture content of 36 percent by mass or greater at 23 degrees C. and 80 percent RH. Specific examples include, but are not limited to, triethylene glycol (boiling point of 288 degrees C./760 mmHg, equilibrium moisture content of 39 percent by mass), tetraethylene glycol (boiling point of 328 degrees C./760 mmHg, equilibrium moisture content of 37 percent by mass), glycerin (boiling point of 290 degrees C./760 mmHg, equilibrium moisture content of 49 percent by mass), and diglycerin (boiling point of 265 to 270 degrees C./15 mmHg, equilibrium moisture content of 38 percent by mass). These can be used alone or in combination. Of these, glycerin is preferable.

The proportion of the of organic solvent A is not particularly limited and can be suitably selected to suit to a particular application. It is preferably from 15.0 percent by mass or greater and more preferably 20.0 percent by mass or greater. A proportion of 15.0 percent by mass or greater enhances discharging stability (i.e., continuous discharging or decapping property) of ink and inhibits fixation of waste ink on the maintenance unit of an image forming apparatus.

The method of measuring the equilibrium moisture content (percent by mass) of the organic solvent A is not particularly limited and can be suitably selected to suit to a particular application. One way of measuring is as follows.

A petri dish on which one gram of each organic solvent is placed is preserved in a desiccator at 23±1 degrees C. and 80±3 percent RH in the desiccator to measure the equilibrium moisture content, using a saturated aqueous solution of potassium chloride and sodium chloride. The equilibrium moisture content is calculated utilizing the following relationship:

Equilibrium moisture content (percent by mass)=[moisture content absorbed in organic solvent/(amount of organic solvent+moisture content absorbed in organic solvent)]×100

The organic solvent B preferably contains a polyol with a boiling point of from 140 degrees C. to lower than 250 degrees C. and more preferably with an equilibrium moisture content of 30 percent by mass or greater at 23 degrees C. and 80 percent RH. The organic solvent B inhibits waste ink of from fixating on the maintenance mechanism in an image forming apparatus.

The polyol contained as the organic solvent B is not particularly limited and can be suitably selected to suit to a particular application as long as it has a boiling point of from 140 to lower than 250 degrees C.

Specific example include, but are not limited to, 1,3-butanediol (boiling point (bp) of 207 degrees C./760 mmHg, equilibrium moisture content of 35 percent by mass), 1,2-butanediol (bp of 193 degree C./760 mmHg), 2-methyl-1,3-butanediol (bp of 214 degrees C./760 mmHg), 3-methyl-1,3-butanediol (bp of 203 degrees C./760 mmHg), dipropylene glycol (bp of 232 degrees C./760 mmHg), 1,5-pentanediol (bp of 242 degrees C./760 mmHg), propylene glycol (bp of 187 degrees C./760 mmHg), 2-methyl-2,4-pentanediol (bp of 197 degrees C./760 mmHg), 1,2-hexylene glycol (bp of 224 degrees C./760 mmHg), polypropylene glycol (bp of 187 degrees C./760 mmHg), and 1,2,6-hexanetriol (bp of 178 degrees C./760 mmHg). The method of measuring the equilibrium moisture content (percent by mass) of the organic solvent B can be the same as that for the organic solvent A.

The organic solvent in the present disclosure contains the compound represented by the Chemical formula I. The organic solvent represented below has a boiling point of 215.2 degrees C./760 mmHg and an equilibrium moisture content of 42 percent by mass.

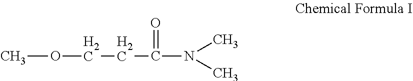

The organic solvent in the present disclosure may contain other organic solvents in addition to the organic solvent A, the organic solvent B, and the compound represented by the Chemical formula I.

The other organic solvent is not particularly limited and can be suitably selected to suit to a particular application.

Specific examples include, but are not limited to, 1,6-hexane diol (bp of 253 to 260 degrees C.), trimethylol ethane (melting point (mp) of 199 to 201 degrees C.), trimethylol propane (mp of 61 degrees C.), 3-ethyl-3-oxetane methanol (SP value of 11.31 (cal/cm³)^{1/2}), 3-methyl-3-oxetane methanol (SP value of 11.79 (cal/cm³)^{1/2}), β-methoxy-N,N-dimethyl propionamide (SP value of 9.19 (cal/cm³)^{1/2}), β-butoxy-N,N-dimethyl propionamide (SP value of 9.03 (cal/cm³)^{1/2}), 1,2-hexanediol (SP value of 11.8 (cal/cm³)^{1/2}), 2-ethyl-1,3-hexanediol (SP value of 11.07 (cal/cm³)^{1/2}), 2,2,4-trimethyl-1,3-pentanediol (SP value of 11.19 (cal/cm³)^{1/2}), diethylene glycol monoethyl ether (SP value of 10.14 (cal/cm³)^{1/2}), 3-methoxy-1-butanol (SP value of 9.64 (cal/cm³)^{1/2}), 3-methoxy-3-methyl-1-butanol (SP value of 9.64 (cal/cm³)^{1/2}), 3-methyl-1,5-pentanediol (SP value of 11.8 (cal/cm³)^{1/2}), methylpropylene triglycol (SP value of 9.43, (cal/cm³)^{1/2}) diethylene glycol mono-n-butyhlether (SP value of 9.86 (cal/cm³)^{1/2}), diethylene glycol monomethyl ether (SP value of 10.34 (cal/cm³)^{1/2}), triethylene glycol monomethylether (SP value of 10.12 (cal/cm³)^{1/2}), propylene glycol monopropyl ether (SP value of 9.82, (cal/cm³)^{1/2}) propylene glycol monomethyl ether (SP value of 10.19 (cal/cm³)^{1/2}), propylene glycol monobutyl ether (SP value of 9.69 (cal/cm³)^{1/2}), 3-methoxy-1-butanol (SP value of 10.65 (cal/cm³)^{1/2}), 3-methoxy-1-propanol (SP value of 10.41 (cal/cm³)^{1/2}), and dipropylene glycol monomethyl ether (SP value of 9.84 (cal/cm³)^{1/2}). These can be used alone or in combination.

The solution parameter (SP value) of the other organic solvents is not particularly limited and can be suitably selected to suit to a particular application. It is preferably from 9.0 to 11.8 (cal/cm³)^{1/2}) in terms of wettability to a substrate (medium).

SP value refers to a solution parameter and is generally used as an index for affinity and solubility of materials, such as a solvent, a resin, and a pigment dissolved or dispersed in water or a solvent for use.

The SP value can be obtained by various ways such as measuring by experiments, calculating by measuring physical properties such as immersion heat, or calculating from molecular structures. In the present disclosure, an SP value is obtained by the calculation method based on the molecule structure proposed by Fedors.

This method has the advantages that the SP value can be calculated for an available molecule structure and that the difference between the SP value calculated and the SP value measured in an experiment is slight.

In the Fedors method, the SP value can be obtained according to Formula A below based on the evaporation energy Δei and the molar volume Δvi of each atom or a group of atoms at 25 degrees C.

SP Value=(ΣΔei/Δvi)^{1/2} Formula A

In the present disclosure, according to the Method of Fedors, the SP value calculated from the molecular structure is used and represented in (cal/cm³)^{1/2}.

Also, in the present disclosure, the SP value at 25 degrees C. is used and not subjected to temperature conversion and others.

SP values can be calculated according to Fedors method disclosed in R. F. Fedors: Polym. Eng. Sci., 14[2], 147-154.

Specific examples of organic solvents having a solubility parameter of from 9.0 to less than 11.8 (cal/cm³)^{1/2} includes, but are not limited to, 3-ethyl-3-oxetane methanol (SP value of 11.31 (cal/cm³)^{1/2}), 3-methyl-3-oxetane methanol (SP value of 11.79 (cal/cm³)^{1/2}), β-methoxy-N,N-dimethyl propionamide (SP value of 9.19 (cal/cm³)^{1/2}), β-butoxy-N,N-dimethyl propionamide (SP value of 9.03 (cal/cm³)^{1/2}), 1,2-hexanediol (SP value of 11.8 (cal/cm³)^{1/2}), 2-ethyl-1,3-hexanediol (SP value of 11.07 (cal/cm³)^{1/2}), 2,2,4-trimethyl-1,3-pentanediol (SP value of 11.19 (cal/cm³)^{1/2}), diethylene glycol monoethyl ether (SP value of 10.14 (cal/cm³)^{1/2}), 3-methoxy-1-butanol (SP value of 9.64 (cal/cm³)^{1/2}), 3-methoxy-3-methyl-1-butanol (SP value of 9.64 (cal/cm³)^{1/2}), 3-methyl-1,5-pentanediol (SP value of 11.8 (cal/cm³)^{1/2}), methylpropylene triglycol (SP value of 9.43 (cal/cm³)^{1/2}), diethylene glycol mono-n-butyhlether (SP value of 9.86 (cal/cm³)^{1/2}), diethylene glycol monomethyl ether (SP value of 10.34 (cal/cm³)^{1/2}), triethylene glycol monomethylether (SP value of 10.12 (cal/cm³)^{1/2}), propylene glycol monopropyl ether (SP value of 9.82 (cal/cm³)^{1/2}), propylene glycol monomethyl ether (SP value of 10.19 (cal/cm³)^{1/2}), propylene glycol monobutyl ether (SP value of 9.69 (cal/cm³)^{1/2}), 3-methoxy-1-butanol (SP value of 10.65 (cal/cm³)^{1/2}), 3-methoxy-1-propanol (SP value of 10.41 (cal/cm³)^{1/2}), dipropylene glycol monomethyl ether (SP value of 9.84 (cal/cm³)^{1/2}), and 3-methyl-1,5-pentanediol (SP value of 11.80 (cal/cm³)^{1/2}). These can be used alone or in combination. The solution parameter (SP value) of the other organic solvents is not particularly limited and can be suitably selected to suit to a particular application. It is preferably from 9.0 to 11.8 (cal/cm³)^{1/2}) in terms of storage stability of ink.

The proportion of the organic solvent is not particularly limited and can be suitably selected to suit to a particular application. It is preferably from 15.0 to 50.0 percent by mass and more preferably from 20.0 to 45.0 percent by mass to the ink. A proportion of an organic solvent of 15.0 percent by mass or more enhances the moisturizing effect in each ink. A proportion of an organic solvent of 50.0 percent by mass or less quickly dries each ink on a printing medium.

The mass ratio of the organic solvent to the coloring material mentioned above is not particularly limited and coloring material and can be suitably selected to suit to a particular application. Preferably, the ratio is adjusted because it is related to enhancing the discharging stability of ink and inhibiting the fixation of waste ink on the maintenance mechanism of an image forming apparatus. If an inkjet head discharges ink containing the total of a coloring material and the solid content of a water-dispersible resin at a large proportion and an organic solvent at a small proportion, discharging defects may take place as the moisture evaporates around the ink meniscus of the nozzles of the head.

Coloring Material

The coloring material is not particularly limited and can be suitably selected to suit to a particular application. For example, pigments are usable.

Examples of the pigments include, but are not limited to, black pigments, yellow pigments, magenta pigments, cyan pigments, white pigments, green pigments, orange pigments, and gloss or metallic pigments of gold, silver, and others. The coloring material is a white coloring material when the ink of the present disclosure is a white ink. The coloring material is a color coloring material when the ink of the present disclosure is a color ink. In the present disclosure, the white coloring material and the colored coloring material are simply referred to as coloring materials when they are not distinguished from each other.

The pigment includes an inorganic pigment or organic pigment. These can be used alone or in combination.

Specific examples of the inorganic pigments include, but are not limited to, titanium oxide, iron oxide, calcium oxide, barium sulfate, aluminum hydroxide, barium yellow, cadmium red, chrome yellow, and carbon black. Of these, carbon black is preferable. Carbon black can be manufactured by a known method such as a contact method, a furnace method, and a thermal method.

Specific examples include, but are not limited to, channel black, furnace black, gas black, and lamp black.

Specific examples of the organic pigments include azo pigments, polycyclic pigments, dye chelates, nitoro pigments, nitroso pigments, and aniline black. Of these, azo pigments and polycyclic pigments are preferable.

Specific examples of the azo pigments include, but are not limited to, azo lake, insoluble azo pigments, azo pigment condensates, and chelate azo pigments.

Specific examples of the polycyclic pigments include, but are not limited to, phthalocyanine pigments, perylene pigments, perinone pigments, anthraquinone pigments, quinacridone pigments, dioxazine pigments, indigo pigments, thioindigo pigments, isoindolinone pigments, and quinofuranone pigments. Specific examples of the dye chelate include, but are not limited to, basic dye type chelates and acid dye type chelates.

Specific examples of the organic pigment include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 128, 139, 150, 151, 153, 155, 180, 183, 185 and 213; C.I. Pigment Orange 5, 13, 16, 17, 36, 43, and 51; C.I. Pigment Red 1, 2, 3, 5, 17, 22, 23, 31, 38, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 185, 190, 193, 209, and 219; C.I. Pigment Violet 1 (Rohdamine Lake), 3, 5:1, 16, 19, 23, and 38; C.I. Pigment Blue 1, 2, 15 (Phthalocyanine Blue), 15:1, 15:2, 15:3 (Phthalocyanine Blue), 16, 17:1, 56, 60, and 63; and C.I. Pigment Green 1, 4, 7, 8, 10, 17, 18, and 36.

The BET specific surface area of a pigment is preferably from 10 to 1,500 m²/g, more preferably from 20 to 600 m²/g, and particularly preferably from 50 to 300 m²/g. To obtain a pigment with a target BET specific surface area, the pigment is subjected to a typical size reduction treatment or pulverization using a ball mill, a jet mill, or ultrasonic wave.

The 50 percent cumulative volume particle diameter D₅₀ of a pigment is preferably from 50 to 350 nm in each ink.

For white ink, the total proportion of the coloring material and the solid content of the resin, which is described later, is preferably from 15 to 30 percent by mass and more preferably from 17 to 25 percent by mass to enhance the concealing property (white concealing property) for fabric when the white ink is used as an undercoating layer. The proportion of water to color ink is preferably from 10 to 25 percent by mass and more preferably from 15 to 20 percent by mass to strike a balance between coloring and discharging stability.

The proportion of the resin in ink is 3.0 percent by mass or greater and the total solid contents of the coloring material and the resin is 15 percent by mass or greater when the ink is applied to a textile, such as fabric. The mass ratio of the coloring material to the resin is preferably at 1.0:0.5 to 10. When the ink is applied to textile, such as fabric, a proportion of the entire of the coloring material and the solid content of resin particles of 15 percent by mass or greater particularly enhances the image quality, such as image density and white concealing property.

The proportion of the coloring material to the ink is preferably from 1.0 to less than 15.0 percent by mass and more preferably from 1.5 to 10.0 percent by mass. A proportion of 1.0 percent by mass or greater enhances the coloring of each ink and image density. A proportion of 15.0 percent by mass or lower stabilizes discharging of each ink.

The coloring material can be an organic pigment or a complex pigment covering an inorganic pigment particle with an organic pigment or carbon black. The complex pigment can be manufactured by precipitating organic pigments under the presence of inorganic pigment particles or mechanically mixing and grinding inorganic pigments and organic pigments, which is referred to as the mechanochemical method. It is possible to provide an organosilane compound layer formed of polysiloxane and alkylsilane between inorganic pigments and organic pigments to improve attachability between them.

The mass ratio of inorganic pigment particles or organic pigment particles to an organic pigment covering these particles or carbon black is preferably from 3:1 to 1:3 and more preferably from 3:2 to 1:2 to achieve good coloring, color tone, and transparency.

Specific examples of the procurable complex pigments include, but are not limited to, products with small particle diameter, such as silica/carbon black complex material, silica/phthalocyanine complex material PB15:3, silica/disazo yellow complex material, and silica/quinacridone complex material PR122, all manufactured by TODAKOGYO CORP.

Complex pigments of inorganic pigment particles with a primary particle diameter of nm covered with an equivalent amount of an organic pigment have a primary particle diameter of about 25 nm. If such complex pigments are dispersed with a suitable dispersant to their primary particles, ultrafine complex pigment dispersion ink with a dispersion particle diameter of 25 nm can be manufactured. The organic pigment forming the surface of a complex pigment enhances dispersion. A pigment dispersant is selected to stably disperse both the organic pigment and inorganic pigment at the same time, considering that the feature of the inorganic pigment at the center of the complex pigment demonstrates through a thin organic pigment layer with a thickness of about 2.5 nm.

The coloring material is preferably anionic and more preferably an anionic pigment if a pre-processing fluid is used in addition to the white ink and the color ink in an ink set, which is described later. Examples of the anionic pigment include, but are not limited to, a surfactant dispersion pigment in which a pigment is dispersed with a surfactant, a resin dispersion pigment in which a pigment is dispersed with a resin, a resin coated pigment dispersion in which the surface of a pigment is coated with a resin, a self-dispersion pigment in which a hydrophilic group is provided to the surface of a pigment. Water-dispersible pigments are preferable in any of these dispersion forms.

When the anionic pigment is a resin coted pigment dispersion or self-dispersion pigment, it preferably has at least one hydrophilic group on its surface. Specific examples of such hydrophilic groups include, but are not limited to, —COOM, —SO₃M, —PO₃HM, —PO₃M₂, —CONM₂, —SO₃NM₂, —NH—C₆H₄—COOM, —NH—C₆H₄— SO₃M, —NH—C₆H₄—PO₃HM, —NH—C₆H₄—PO₃M₂, —NH—C₆H₄—CONM₂, and —NH—C₆H₄—SO₃NM₂. These hydrophilic groups can be introduced by known methods.

M in the hydrophilic group is preferably a counter ion or quaternary ammonium ion. Specific examples of the quaternary ammonium ions include, but are not limited to, tetramethyl ammonium ion, tetraethyl ammonium ion, tetrapropyl ammonium ion, tetrabutyl ammonium ion, tetra pentyl ammonium ion, benzyl trimethyl ammonium ion, benzyl triethyl ammonium ion, and tetrahexyl ammonium ion. Of these, tetraethyl ammonium ion, tetrabutyl ammonium ion, and benzyl trimethyl ammonium ion are preferable and tetrabutyl ammonium ion is more preferable. Each ink using the pigment mentioned above demonstrates excellent storage stability over time and minimizes an increase in viscosity during moisture vaporing. Due to the hydrophilic group having a quaternary ammonium ion, pigments are considered to be stably dispersed even in an organic rich solvent resulting from moisture evaporation of a water rich solvent.

Other than the pigments having a surface with the hydrophilic group mentioned above, polymer emulsions in which polymer particulates contain a pigment are preferable. The pigment can be encapsulated in a polymer particulate or adsorbed to the surface thereof. All of the pigment particles are not necessarily encapsulated or adsorbed. Some of them may be dispersed in an emulsion.

Specific examples of the polymer for polymer particulate include, but are not limited to, vinyl-based polymers, polyester-based polymers, and polyurethane-based polymers. Of these, vinyl-based polymers and polyester-based polymers are particularly suitable.

Resin

The resin mentioned above is not particularly limited and can be suitably selected to suit to a particular application. It is good for image forming when the resin has excellent film forming property with anti-solvent property, water resistance, and weatherability. Condensation-based synthetic resin, addition-based synthetic resin, and natural polymers are preferable. A water-dispersible resin is preferable in a resin particle form.

When the ink set, which is described later, further contains a pre-processing fluid in addition to the white ink and the color ink, it is preferably anionic.

Specific examples of the condensation-based synthetic resins include, but are not limited to, polyester resins, polyurethane resins, polyepoxy resins, polyamide resins, polyether resins, poly(meth)acrylic resins, acrylic-silicone resins, and fluorochemical resins.

Specific examples of the addition-based synthetic resin include, but are not limited to, polyolefine resin, polystyrene resin, polyvinyl alcohol resin, polyvinyl ester resin, polyacrylic acid resin, and unsaturated carboxylic acid resin.

Specific examples of the natural polymer include, but are not limited to, celluloses, rosins, and natural rubber.

Acrylic resin, polyester resin, and polyurethane resin are preferably used to improve fixability of ink when the ink is applied to a low or non-permeating printing medium, such as textile (typically, fabric), commercial printing paper, and film.

This polyurethane resin preferably has a structure derived from polyol having the structure represented by Chemical Structure A below to further enhance the fixability of ink.

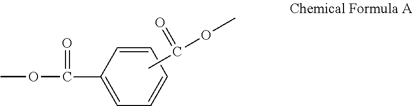

Specific examples of the polyol material with a structure represented by the Chemical Structure A include, but are not limited to, terephthalic acid and isophthalic acid.

The proportion of the polyol material with the structure represented by the Chemical Structure A is preferably from 10 to 30 percent by mass to the entire materials of polyurethane resin and about 50 percent by mass to the entire of polyol materials. Alcohol resistance is enhanced when the proportion of the polyol material with the structure represented by the Chemical Structure A is within the range specified above.

As the resin mentioned above, a resin with a hydrophilic group, which imparts self-dispersibility, and a resin to which dispersibility is imparted by a surfactant or another resin with a hydrophilic group can be used. Of these, an emulsion of resin particles obtained by emulsifying or suspending ionomers or unsaturated monomers of polyester resin or polyurethane resin is preferable.

It is easy to obtain a resin by emulsification polymerization of an unsaturated monomer because a resin emulsion is obtained by allowing to react substances such as an unsaturated monomer, polymerization initiator, surfactant, chain transfer agent, chelate agent, and pH regulator in water. In addition, the target properties of a resin can be readily obtained by changing resin prescription.

The pH of ink is preferably from 4 to 12 to prevent cleavage of molecule chains caused by dispersion breakage or hydrolysis in a strong alkali or acidic environment. The pH is more preferably from 7 to 11 and furthermore preferably from 8 to 10.5 in terms of miscibility with water-dispersible coloring material.

The resin mentioned above fixes a water-dispersible coloring material onto a printing medium and forms a film at room temperature or higher, which improves the fixability of the coloring material. Therefore, the minimum film-forming temperature (MFT) of the resin is preferably 100 degrees C. or lower.

The glass transition temperature of the resin is preferably from −60 to lower than 70 degrees C. and more preferably from −40 to lower than 30 degrees C. A resin with a glass transition temperature of 0 degrees C. or lower enhances rub resistance to fabric constituting a textile goods.

The proportion of the solid content of the resin to the mass of ink is preferably from 0.5 to 20.0 percent by mass and more preferably from 1.0 to 15.0 percent by mass.

When ink is applied to a textile goods, such as fabric, using a polyurethane resin, the proportion of the polyurethane resin in the ink is preferably 3.0 percent by mass or greater.

The proportion of the solid content of the resin to the mass of pre-processing fluid is preferably from 0.5 to 20.0 percent by mass and more preferably from 5.0 to 10.0 percent by mass. A proportion of the resin of from 0.5 to 20.0 percent by mass enhances the attachability between white ink, color ink, and a printing medium.

For white ink, the total proportion of the coloring material and the solid content of the resin, which is described later, is preferably from 15 to 30 percent by mass and more preferably from 17 to 25 percent by mass to conceal fabric, or white concealing property, when the white ink is used as an undercoating layer. For color ink, the proportion is preferably from 10 to 25 percent by mass and more preferably from 15 to 20 percent by mass to enhance coloring and discharging stability.

Preferably, the proportion of the resin in the ink is 3.0 percent by mass or greater and the entire of the coloring material and the solid content of the resin is 15 percent by mass or greater when the ink is applied to a textile, such as fabric. The mass ratio of the coloring material to the resin is preferably at 1.0:0.5 to 10. When ink is applied especially to a textile, such as fabric, a proportion of the entire of the coloring material and the solid content of the resin particles of 15 percent by mass or greater enhances the image quality, such as image density and white concealing property.

The mass ratio of the coring material to the resin is not particularly limited and can be suitably selected to suit to a particular application. The proportion of the coloring material to the resin is preferably from a factor of 2 or greater.

Surfactant

The surfactant is not particularly limited and can be suitably selected to suit to a particular application.

It includes polyether-modified siloxane compound, acetylene-based surfactant, and acetylene alcohol surfactant.

Fluorochemical surfactants and silicone-based surfactants can be used in combination with the surfactants mentioned above. Using a surfactant inhibits discharging defects and enhances discharging stability because each ink is readily wet on the repellent ink film on the nozzle plate of an inkjet head, thereby being prevented from fixating on the nozzles of the plates.

The polyether-modified siloxane compound mentioned above is preferably represented by the Chemical Formulae 1 to 5 below.

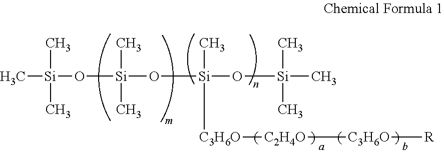

In the Chemical Formula 1, R represents a hydrogen atom or an alkyl group having 1 to 4 carbon atoms, m represents 0 or an integer of from 1 to 23, n represents an integer of from 1 to 10, a represents an integer of from 1 to 23, and b represents 0 or an integer of from 1 to 23.

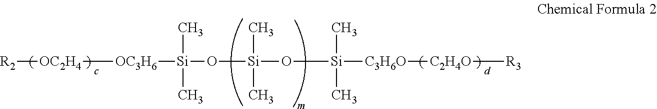

In the Chemical Formula 2, R₂ and R₃ each, independently represent hydrogen atoms or alkyl groups having 1 to 4 carbon, m represents an integer of from 1 to 8, and c and d each, independently represent integers of from 1 to 10.

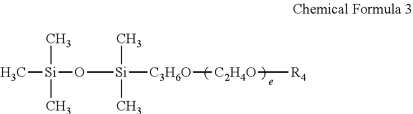

In the Chemical Formula 3, R₄ represents a hydrogen atom or an alkyl group having 1 to 4 carbon atoms and e represents an integer of 1 to 8.

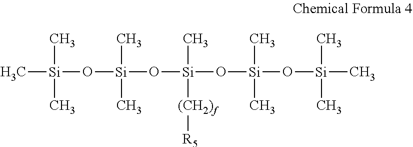

In the Chemical Formula 4, R₅ represents a polyether group represented by the following Formula 5 and f represents an integer of from 1 to 8.

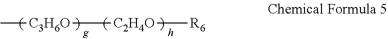

In the Chemical Formula 5, R₆ represents a hydrogen atom or an alkyl group having 1 to 4 carbon atoms, g represents 0 or an integer of from 1 to 23, and h represents 0 or an integer of from 1 to 23, excluding the case in which g and h are simultaneously 0.

The compound represented by the Chemical Formula 1 includes, but are not limited to, the compound represented by the Chemical Structures 1 to 8 below.

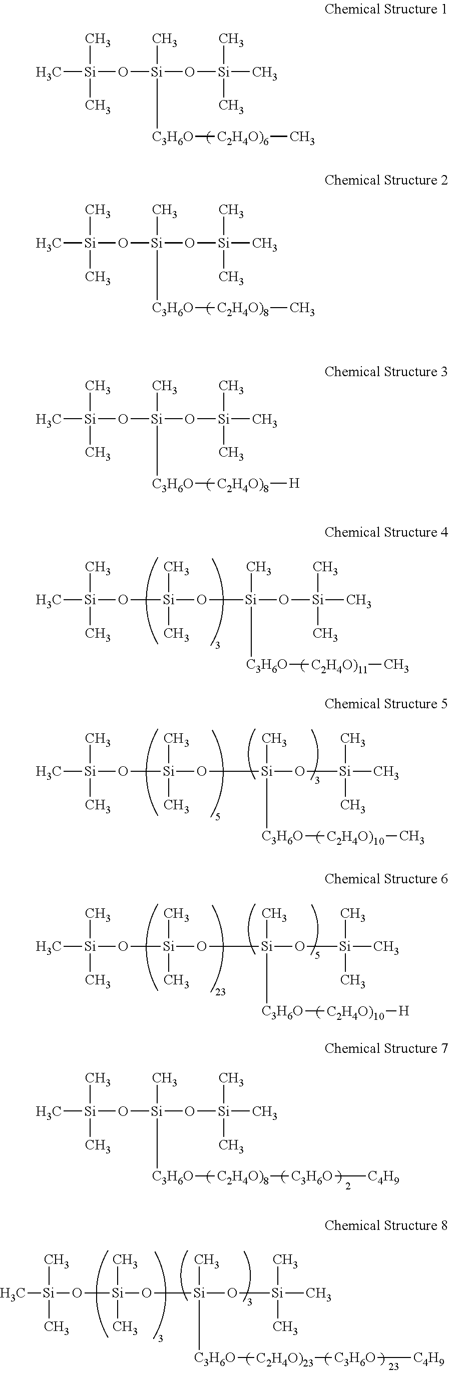

The compound represented by the Chemical Formula 2 includes, but are not limited to, the compound represented by Chemical Structure 9 below.

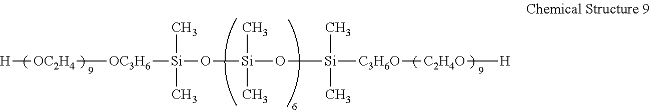

The compound represented by the Chemical Formula 3 includes, but are not limited to, the compound represented by Chemical Structure 10 below.

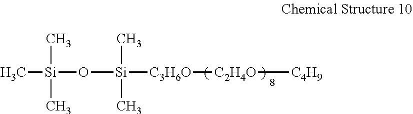

The compound represented by the Chemical Formula 4 includes the compound represented the Chemical Structures 11 to 13 below.

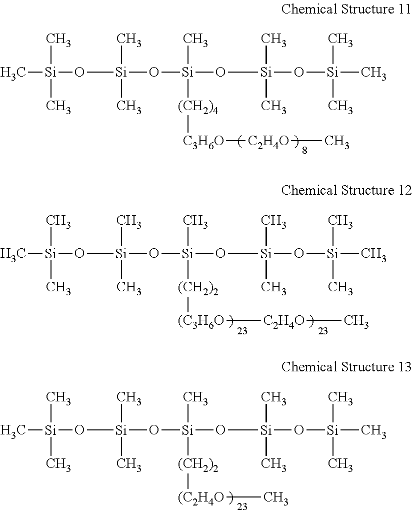

Furthermore, specific examples of procurable polyether-modified siloxane compound include, but are not limited to, 71 ADDITIVE, 74 ADDITIVE, 57 ADDITIVE, 8029 ADDITIVE, 8054 ADDITIVE, 8211 ADDITIVE, 8019 ADDITIVE, 8526 ADDITIVE, and FZ-2123, FZ-2191, all manufactured by Dow Corning Toray Co., Ltd., TSF 4440, TSF 4441, TSF 4445, TSF 4446, TSF 4450, TSF 4452, and TSF 4460, all manufactured by Momentive Performance Materials Inc., SILFACE SAG 002, SILFACE SAG 003, SILFACE SAG 005, SILFACE SAG 503A, SILFACE SAG 008, and SILFACE SJM 003, all manufactured by Nisshin Chemical Co., Ltd., TEGO WetKL 245, TEGO Wet 250, TEGO Wet 260, TEGO Wet 265, TEGO Wet 270, and TEGO Wet 280, all manufactured by Evonik Industries AG, and BYK-345, BYK-347, BYK-348, BYK-375, and BYK-377, all manufactured by BYK Japan KK.

Acetylene glycol surfactant or acetylene alcohol surfactant is procurable.

Specific examples include, but are not limited to, Surfynol 104, Surfynol 104E, Surfynol 420, Surfynol 440, Surfynol 465, Surfynol SE, Surfynol SEF, Surfynol PSA-336, Surfynol DF110D, Surfynol DF58, OLFINE^{registered} E1004, OLFINE^{registered} E1010, OLFINE^{registered} E1020, OLFINE^{registered} PD-001, OLFINE^{registered} PD-002W, OLFINE^{registered} PD-004, OLFINE^{registered} PD-005, OLFINE^{registered} EXP.4001, OLFINE^{registered} EXP. 4200, OLFINE^{registered} EXP. 4123, and OLFINE^{registered} EXP.4300 (all manufactured by Nissin Chemical co., ltd.)

The proportion of the surfactant is not particularly limited and it can be suitably selected to suit to a particular application. It is preferably from 0.001 to 5.0 percent by mass and more preferably from 0.5 percent by mass to 3.0 percent by mass to the total content of ink. A proportion of surfactant of 0.001 percent by mass or more has a good impact on ink properties. A proportion of surfactant of 5.0 percent by mass or lower has a good impact on ink properties.

Other Optional Components

As the other components, known additives can be used, including foam inhibitors (defoaming agent), pH regulators, preservatives and fungicides, chelate reagents, corrosion inhibitors, anti-oxidants, ultraviolet absorbers, oxygen absorbers, and photostabilizing agents.

Foam Inhibitor

A foam inhibitor is added in a small amount to ink to prevent foaming in the ink. Foaming refers to enclosing air with a thin liquid film. Forming foams is related to the properties of ink, such as surface tension and viscosity. That is, liquid such as water with a strong surface tension makes the surface area as small as possible so it does not readily foam. Conversely, sticky ink with high permeability is likely to foam because it has low surface tension. The foam formed due to this high viscosity does not readily break but is maintained.

Normally, a foam inhibitor breaks foams by locally lowering the surface tension of foam film. Alternatively, a foam inhibitor insoluble in a foaming liquid breaks foams by dotting on the surface of the foaming liquid. A foaming inhibitor utilizing the former mechanism cannot break foams when a polyether-modified siloxane compound is used as surfactant because it extremely reduces the surface tension. The latter foam inhibitor is thus preferable; however, this inhibitor may degrade the stability of ink since it is not dissolved in the solution. Conversely, the foam inhibitor represented by the following Chemical Formula 6 is less able to reduce the surface tension than a polyether-modified siloxane compound but highly compatible with the compound. Thus, foam film is considered to take in the foam inhibitor efficiently and locally becomes unstable due to the difference in the surface tension between the inhibitor and a polyether-modified siloxane compound. Resultantly, the foam finally breaks.

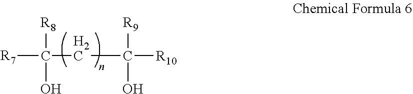

In the Chemical Formula 6, R₇ and R₈ each, independently represent alkyl groups having 3 to 6 carbon atoms, R₉ and R₁₀ each, independently represent alkyl groups having one or two carbon atoms, and n represents an integer of from one to six.

Specific examples of the compound represented by the Chemical Formula 6 include, but are not limited to, 2,4,7,9-tetramethyldecane-4,7-diol and 2,5,8,11-tetramethyl dodecane-5,8-diol. Of these, considering the impact of inhibiting foaming and compatibility with ink, 2,5,8,11-tetramethyldodecane-5,8-diol is preferable.

The proportion of the foam inhibitor to the mass of ink is preferably from 0.01 to 10.0 percent by mass and more preferably from 0.1 to 5.0 percent by mass. A proportion of 0.01 percent by mass or more reduces forming. A proportion of 10 percent by mass or less minimizes adverse impacts on the ink properties, such as viscosity and particle diameter.

pH Regulator

The pH regulator mentioned above is not particularly limited as long as it can adjust the pH of ink and can be suitably selected to suit to a particular application.

Specific examples include, but are not limited to, alcohol amines, hydroxides of alkali metal, ammonium hydroxides, phosphonium hydoxides, and carbonates of alkali metal. The pH of ink is preferably from 7 to 11 to discharge the ink stably.

Specific examples of the alcohol amines include, but are not limited to, diethanolamine, triethanolamine, and 2-amino-2-ethyl-1,3-propanediol.

Specific examples of the hydroxides of alkali metal elements include, but are not limited to, lithium hydroxide, sodium hydroxide, and potassium hydroxide.

Specific examples of the hydroxides of ammonium include, but are not limited to, ammonium hydroxides and quaternary ammonium hydroxides.

A specific example of the phosphonium hydroxides is quaternary phosphonium hydroxide.

Specific examples of the carbonates of alkali metal include, but are not limited to, lithium carbonate, sodium carbonate, and potassium carbonate.

Preservatives and Fungicides

Specific examples of the preservatives and fungicides include, but are not limited, dehydrosodium acetate, sodium sorbinate, 2-pyridine thiol-1-oxide sodium, sodium benzoate, and pentachlorophenol sodium.

Chelate Reagent

Specific examples of the chelate reagents include, but are not limited to, ethylene diamine sodium tetraacetate, nitrilo sodium triacetate, hydroxyethylethylene diamine sodium tri-acetate, diethylenetriamine sodium quinternary acetate, and uramil sodium diacetate.

Corrosion Inhibitor

Specific examples of the anti-corrosion agents include, but are not limited to, acid sulfite, thiosodium sulfate, ammonium thiodiglycolate, diisopropyl ammonium nitrite, pentaerythritol quaternary nitrite, and dicyclohexyl ammonium nitrite.

Anti-Oxidant

Specific examples of the anti-oxidants include, but are not limited to, phenol-based anti-oxidants (including hindered phenol-based anti-oxidants), amino-based anti-oxidants, sulfur-based anti-oxidants, and phosphorous-based anti-oxidants.

Ultraviolet Absorber

Specific examples of the ultraviolet absorbent include, but are not limited to, a benzophenone-based ultraviolet absorbent, a benzotriazole-based ultraviolet absorbent, a salicylate-based ultraviolet absorbent, a cyanoacrylate-based ultraviolet absorbent, and a nickel complex salt-based ultraviolet absorbent.

One way of quantitatively and qualitatively analyzing the organic solvents, resin, coloring materials, surfactants, and other components contained in ink is to utilize a method, such as gas chromatography mass spectrometry (GC-MS). Using GCMS-QP2020NX, manufactured by Shimadzu Corporation is suitable, for example.

The moisture contained in the ink can be measured by an available method, such as quantitative analysis of the volatile components by GC-MS or mass variation by thermogravimeter-differential thermal analysis (TG-DTA).

Property of Ink

The properties of each ink are not particularly limited and can be suitably selected to suit to a particular application.

Viscosity of the ink at 25 degrees C. is preferably from 5 to 25 mPa·s and more preferably from 6 to 20 mPa·s. An ink viscosity of 5 mPa·s or greater enhances the image density and text quality of ink. An ink viscosity of 25 mPa·s or less enhances ink di schargeability.

Viscosity can be measured at 25 degree C. by an instrument such as a viscometer (RE-85L, manufactured by TOKI SANGYO CO., LTD.).

Method of Manufacturing Each Ink

Each ink can be manufactured by stirring and mixing materials and heating the obtained mixture at a temperature range of from 40 degrees C. to lower than 70 degrees C. for at least six hours. The materials are stirred and mixed by a device, such as a sand mill, homogenizer, ball mill, paint shaker, and ultrasonic dispersion.

Ink Set

The ink set of the present disclosure contains the ink of the present disclosure and a pre-processing fluid.

The ink proposed in Japanese Patent No. 5601075 contains a solid content of as small as about 10 percent by mass, so it is not suitable to form an image on textile goods, such as clothes.

The ink is preferably a white ink or a color ink. Two or more types of white inks and color inks can be used as the inks.

The white ink and color ink in the ink set of the present disclosure are not necessarily integrally present. It is possible to integrally or separately manufacture or sell a container containing white ink and a container containing color ink as a set. If a white ink container and a color ink container are independently manufactured or sold but the white ink and the color ink are used or substantially used in combination, the white ink and the color ink constitute the set mentioned above.

The white ink in the present disclosure is a liquid composition for forming a white image on a printing medium by applying it onto the medium. When a pre-processing fluid is used, the white ink is a liquid composition for forming a white image by applying it to the region of a printing medium where the pre-processing fluid has been applied. A white image formed with the white ink on a printing medium serves as a backdrop of a color image formed with the color ink to be applied to the region where the white ink has been applied. The white image enhances the coloring of the color image. In the present disclosure, “white” is a color referred to as white appropriately accepted under normal social conventions and includes slightly colored white.

The color ink in the present disclosure is a liquid composition for forming a color image by applying to the region of a printing medium where the white ink has been applied. The color excludes the above white and includes black, cyan, magenta, and yellow.

The pre-processing fluid in the present disclosure is applied to a printing medium to aggregate or thicken the white ink or color ink applied later to the pre-processing fluid applied region.

Pre-Processing Fluid

The pre-processing fluid mentioned above contains a flocculant and other optional substances such as resin particles, wax particles, organic solvents, water, and surfactants.

Flocculant

The flocculant in the present disclosure refers to a component for aggregating or thickening white ink or color ink upon a contact between the pre-processing fluid and the white or color ink. One of the flocculants is a component for aggregating water-dispersible particles such as the anionic compound mentioned above including the coloring material or resin contained in a white ink or color ink. A white or color ink aggregates or becomes sticky when it contacts a pre-processing fluid containing such a flocculant, so the white or color ink stays on the surface of a printing medium.

Examples of the flocculant include, but are not limited to, cationic compounds such as inorganic metal salts, organic acid metal salts, organic acid ammonium salts, and cationic polymers.

Specific examples of the inorganic metal salt include, but are not limited to, magnesium sulfate, aluminum sulfate, manganese sulfate, nickel sulfate, iron (II) sulfate, copper (II) sulfate, zinc sulfate, iron (II) nitrate, iron (III) nitrate, cobalt nitrate, strontium nitrate, copper (II) nitrate, nickel (II) nitrate, lead (II) nitrate, manganese (II) nitrate, nickel (II) chloride, calcium chloride, tin (II) chloride, strontium chloride, barium chloride, magnesium chloride, sodium sulfate, potassium sulfate, lithium sulfate, sodium hydrogensulfate, potassium hydrogensulfate, sodium nitrate, potassium nitrate, sodium carbonate, potassium carbonate, sodium hydrogencarbonate, potassium hydrogencarbonate, sodium chloride, and potassium chloride,

Specific examples of the organic acid metal salts include, but are not limited to, L-sodium aspartate, L-magnesium aspartate, calcium ascorbate, L-sodium ascorbate, sodium succinate, disodium succinate, aluminum citrate, potassium citrate, calcium citrate, tripotassium citrate, trisodium citrate, diammonium citrate, disodium citrate, zinc lactate, aluminum lactate, potassium lactate, calcium lactate, sodium lactate, magnesium lactate, calcium acetate, potassium tartrate, calcium tartrate, DL-sodium tartrate, and sodium potassium tartrate.

The inorganic metal salt and organic metal salt are preferably at least one member selected from the group consisting of a calcium salt, a magnesium salt, a nickel salt, and aluminum salt. These salts enhance aggregating water-dispersible particles contained in white or color ink and minimizes the occurrence of color bleed and beading. They are also preferable to store a pre-processing fluid stably.

Specific examples of the organic acid ammonium salt include, but are not limited to, ammonium acetate, ammonium propionate, ammonium oxalate, ammonium tartrate, ammonium succinate (diammonium succinate), diammonium maronate, diammonium hydrogen citrate, hydrogen citrate, triammonium citrate, and ammonium L-glutaminate.

As the cationic polymer, quaternary ammonium salt type cationic polymers are preferable. Specific examples include, but are not limited to, polymers of dialkylaryl ammonium chloride, polymers of dialkyl aminoethyl (meth)acrylate quaternary ammonium salts, polymers of modified polyvinyl alcohol dialkyl ammonium salts, and polymers of dialkyl diallyl ammonium salts.

Specific examples of the other cationic polymers include, but are not limited to, cationic specially-modified polyamine compounds, cationic polyamide polyamine compounds, cationic urea-formarine resin compounds, cationic polyacrylic amide compounds, cationic alkyl ketene dimers, cationic dicyane diamide compounds, cationic dicyan diamide-formarine condensation compounds, cationic dicyan diamide-polyamine condensation compounds, cationic polyvinyl formamide compounds, cationic polyvinyl pyridine compounds, cationic polyalkylene polyamine compounds, and cationic epoxy polyamide compounds.

The compounds represented by the Chemical Formulae 7 to 9 below are especially preferable as the cationic polymer.

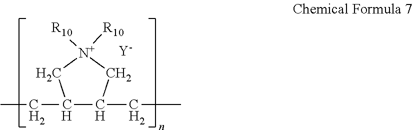

In the Chemical Formula 7, R₁₀ represents a methyl or ethyl group and Y⁻ represents a halogen ion, and n represents an integer.

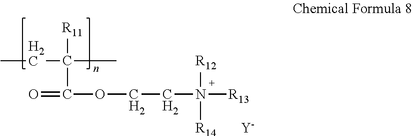

In the Chemical Formula 8, Y⁻ represents a halogen ion, nitrate ion, nitrite ion, or acetate ion, Ru represent a hydrogen or CH₃, R₁₂, R₁₃, and R₁₄ each, independently represent hydrogens or alkyl groups, and N represents an integer.

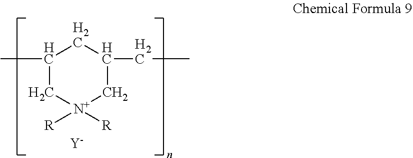

In the Chemical Formula 9, R represents a methyl or ethyl group and Y⁻ represents a halogen ion, nitrate ion, nitrite ion, or acetate ion, and n represents an integer. The proportion of a flocculant to the mass of pre-processing fluid is from 0.1 to 30.0 percent by mass and more preferably from 1.0 to 20.0 percent by mass to enhance the solubility of flocculant and minimize the occurrence of color bleed and beading.

Resin Particle

It is preferable that the pre-processing fluid contain resin particles. A pre-processing fluid containing resin particles strongly attaches white ink and color ink to a printing medium.

In order that the resin particles are coexistent with a flocculant as a cationic compound in a pre-processing fluid, the resin particles are not preferably a commonly used electron repulsion emulsion but nonionic resin particles dispersed by a steric barrier so as to achieve long-term storage stability. Anionic resin particles of an electron repulsion emulsion agglomerate when coexistent with an inorganic metal salt, an example of the flocculant.

This agglomeration takes place instantly when the inorganic metal salt is a polyvalent metal salt that produces tri-valent cations at dissociation. Cationic resin particles are sufficiently stable when left in a room temperature environment. However, the cationic resin particles become sticky if heated and allowed to stand in an acceleration test for long-term stability.

The resin particle is thus preferably a nonionic resin particle as described above.

There is no specific limitation to the method for determining whether resin particles are nonionic resin particles. One way of determination is to isolate the solid contents of a pre-processing fluid by centrifugal and show that the isolated solid content is free of a material having an acidic functional group such as carboxyl or sulfo, or basic functional group such as amino by a thermal decomposition gas chromatography mass spectroscopy analysis (GC-MS) instrument such as GC-17A, manufactured by Shimadzu Corporation.

Specific examples of the nonionic resin particle include, but are not limited to, polyolefin resin, chlorinated polyolefin resin, polyvinyl acetate resin, polyester resin, polyurethane resin, acrylic resin, styrene butadiene resin, and copolymers of polymerizable compounds for use in polymerization of these resins. Ethylene-vinyl acetate copolymer resin, ethylene-vinyl acetate-vinyl chloride copolymer resin, and chlorinates olefin resin are more preferable. These resins enhance the attachability between white ink, color ink and a printing medium.

The glass transition temperature (Tg) of the nonionic resin particle is preferably from −30 to 30 degrees C. and more preferably from −25 to 25 degrees C. A Tg of −30 degrees C. or higher strengthens a resin film, which toughens a layer formed of a pre-processing fluid. A Tg of 30 degrees C. or lower readily forms a resin film and maintains the film's flexibility, thereby improving the attachability between white ink, color ink, and a printing medium.

The proportion of the solid content of resin particles to the mass of a pre-processing fluid is preferably from 0.5 to 20.0 percent by mass. A proportion of from 0.5 to 20.0 percent by mass strongly attaches the white ink and color ink to a printing medium.

Wax

The wax mentioned above is not particularly limited. Water-dispersible wax can be used. The wax is preferably present in a particle form.

Specific examples include, but are not limited to, plant and animal wax such as carnauba wax, Carnauba wax, bee wax, rice wax, and lanoline, petrol-based wax such as polyethylene wax, microcrystalline wax, polyethylene wax, polypropylene wax, oxidized polyethylene wax, and pterolatum, mineral wax such as montan wax and ozokerite, synthetic wax such as carbon wax, Hoechst wax, polyethylene wax, and stearic acid amide. Of these, paraffin wax and polyethylene wax are preferable in terms of attachability between white ink, color ink, and a printing medium and dispersibility in pre-processing fluid.

The wax preferably has a melting point of from 50 to 130 degrees C. and more preferably from 60 to 120 degrees C. A melting point in the range specified above strongly attaches the white ink and color ink to a printing medium.

The proportion of the solid content of a wax to the mass of a pre-processing fluid is preferably from 0.05 to 5.0 percent by mass and more preferably from 0.1 to 3.0 percent by mass. A proportion of from 0.05 to 5.0 percent by mass makes white ink stay around a printing medium's surface, enhancing Hunter's Brightness.

Organic Solvent

The organic solvent mentioned above is not particularly limited. It includes water-soluble organic solvents. Examples of the water-soluble organic solvent are polyols, ethers such as polyol alkylethers and polyol arylethers, nitrogen-containing heterocyclic compounds, amides, amines, and sulfur-containing compounds.

Specific examples of the water-soluble organic solvent include, but are not limited to: polyhydric alcohols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trimethyl-1,3-pentanediol, and petriol; polyol alkyl ethers such as ethylene glycol monoethyl ether, ethylene glycol monobutyl ether, diethylene glycol monomethyl ether, diethylene glycol monoethyl ether, diethylene glycol monobutyl ether, tetraethylene glycol monomethyl ether, and propylene glycol monoethyl ether; polyol aryl ethers such as ethylene glycol monophenyl ether and ethylene glycol monobenzyl ether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-butoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent with a boiling point of 250 or lower degrees C., which serves as a humectant while drying quickly.

An organic solvent containing at least one of 1,2-propane diol, 1,3-butane diol, and 1,2-butane diol is likely to wet on the surface of a printing medium, which is preferable.

The proportion of organic solvents in the first processing fluid is not particularly limited and can be suitably selected to suit a particular application. It is preferably from 5.0 to 60.0 percent by mass and more preferably from 10.0 to 30.0 percent by mass to quickly dry and reliably discharge the pre-processing fluid.

Water

As water, pure water and hyper pure water such as deionized water, ultrafiltered water, reverse osmosis water, and distilled water can be used.

The proportion of water in the processing fluid is not particularly limited and it can be suitably selected to suit to a particular application. It is preferably from 10.0 to 90.0 percent by mass and more preferably from 20.0 to 60.0 percent by mass to dry the pre-processing fluid quickly.

Surfactant

Examples of the surfactant include, but are not limited to, silicone-based surfactants, fluorochemical surfactants, amphoteric surfactants, nonionic surfactants, and anionic surfactants.

The silicone-based surfactant is not particularly limited and can be suitably selected to suit to a particular application. Of these, the surfactants not decomposable in a high pH environment are preferable. Examples include, but are not limited to, side chain modified polydimethyl siloxane, both terminal-modified polydimethyl siloxane, one-terminal-modified polydimethyl siloxane, and side-chain-both-terminal-modified polydimethyl siloxane. Silicone-based surfactants having a polyoxyethylene group or a polyoxyethylene polyoxypropylene group as a modification group are particularly preferable because such an aqueous surfactant demonstrates good properties. The silicone-based surfactant can be a polyether-modified silicone-based surfactant. One of the surfactants is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are preferable because they do not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid.

Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the amphoteric surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

Other Components

Examples of other components include, but are not limited to, defoaming agents, preservatives and fungicides, and corrosion inhibitors.

Defoaming Agent

The defoaming agent has no particular limit. Examples include, but are not limited to silicon-based defoaming agents, polyether-based defoaming agents, and aliphatic acid ester-based defoaming agents. These can be used alone or in combination. Of these, silicone-based defoaming agents are preferable to enhance the ability of braking foams.

Preservatives and Fungicides

The preservatives and fungicides are not particularly limited. One specific example is 1,2-benzisothiazoline-3-one.

Corrosion Inhibitor

The corrosion inhibitor has no particular limitation. It includes, but are not limited to, 1,2,3-benzotriazole, acid sulfite, and sodium thiosulfate.

The organic solvent, resin, pigment, surfactant, and other components contained in the pre-processing fluid can be measured by the same method as the qualitative and quantitative method of the components contained in the ink.

The moisture in the pre-processing fluid can be measured by the same manner as that of measuring the moisture in the ink.

Printing Medium

The printing medium, where white ink, color ink, and pre-processing fluid are applied is not particularly limited and can be suitably selected to suit to a particular application. Such media include, but are not limited to, plain paper, gloss paper, special paper, cloth, film, transparent sheets, and print sheet for general purpose. Of these, the printing media with poor permeation, which are subject to color bleed and beading, such as commercial printing paper, non-permeating printing media for signage, and fabric, are preferable because the ink set of the present disclosure can significantly demonstrate its effects on them. Unlike film and paper, the surface of fabric is greatly rough. The amount of white ink and color ink applied to fabric is thus likely to increase.

Also, printing media, media, and substrates have the same meaning in the present disclosure unless otherwise specified.

The non-permeable printing medium in the present disclosure has a surface with low moisture permeability and absorbency. It includes a material with a number of hollow spaces inside that are not open to the outside. To be more quantitative, the medium has a water-absorbency of 10 or less mL/m² from the start of the contact until 30 msec^{1/2} after the contact according to Bristow's method.

Specific examples of the non-permeable printing media include, but are not limited to, polyvinyl chloride resin film, polyethylene terephthalate (PET) film, polypropylene film, polyethylene film, and polycarbonate, and nylon film.

Fabric, as an example of the printing media, is described. “Fabric” in the present disclosure refers to a substance like textile, knitted work, and non-woven fabric, manufactured from fiber. The fiber is preferably organic fiber including synthetic fiber, semi-synthetic fiber, regenerated fiber, and natural fiber.

Specific examples of synthetic fiber include, but are not limited to, polyester, polyamide, acrylic, polyolefin, polyvinyl alcohol, polyvinyl chloride, polyurethane, and polyimide. Specific examples of semi-synthetic fiber include, but are not limited to, acetate, diaceate, and triacetate.

Specific examples of regenerated fiber include, but are not limited to, polynosic, rayon, lyocell, and cupra.

Specific examples of natural fiber include, but are not limited to, cotton, hemp, silk, and wool. Of the fibers that form fabric, synthetic fiber, such as polyester, is difficult to hold white ink on its surface compared to natural fiber, such as cotton. However, the ink set of the present disclosure works on such fabric, thereby holding white ink on the surface of the fabric.

Fabric is preferably dark-colored by chemically or physically retaining a coloring material, such as a pigment or dye, inside or on the fabric's surface. For dark-colored fabric, white background can be formed between the fabric and a color image to enhance the coloring of the color image. The ink set of the present disclosure containing white ink and color ink can suitably be used to form this background.

“Dark-colored fabric” in the present disclosure satisfies the following relationships: 60>L*, preferably 50>L*, more preferably 40>L*, and furthermore preferably 30>L*, and particularly preferably 20>L* when the luminosity (L*) of the fabric is measured by a spectrophotometer, e.g., X-rite exact (manufactured by X-Rite Inc.).

Ink Discharging Device and Method of Discharging Ink

The ink discharging device contains the ink of the present disclosure, a container containing the ink, an ink discharging unit for discharging the ink to a printing medium, and other optional elements. The other optional elements include, for example, a container containing a white ink, a container containing a color ink, a container containing a pre-processing fluid, a pre-processing fluid applying unit for applying the pre-processing fluid to a printing medium, a white ink applying unit for applying the white ink to the printing medium, a color ink applying unit for applying the color ink to the printing medium, and a unit for heating the fluids such as the white ink, color ink, and pre-processing fluid applied to the printing medium. The ink applying unit for applying the white ink applies the ink to the region of the printing medium where the pre-processing fluid has been applied when an image forming apparatus includes a container containing the pre-processing fluid and a pre-processing fluid applying unit for applying the pre-processing fluid.

The image forming method includes applying ink to a printing medium and other optional processes. The other optional processes include, for example, applying a pre-processing fluid to the region of a printing medium where the ink is to be applied before the ink is applied thereto, applying a white ink to the printing medium, applying the color ink to the printing medium, and heating the white ink, the color ink, and the pre-processing fluid applied to the printing medium. In the applying ink, the ink is applied to the region of a printing medium where the pre-processing fluid has been applied when the image forming method includes applying the pre-processing fluid. It is preferable to apply a color ink to the region of a printing medium where the white ink has been applied after the pre-processing fluid and the white ink are applied to the region of the printing medium where the pre-processing fluid has been applied when the printing medium is dark-colored fabric. Due to this color ink application, a vivid image can be formed regardless of the color of a printing medium.

The ink discharging device of the present disclosure can be suitably used for a printing device employing inkjet printing, such as a printer, facsimile machine, photocopier, multifunction peripheral (serving as a printer, a facsimile machine, and a photocopier), and solid freeform fabrication device such as a 3D printer and additive manufacturing device.

In the present disclosure, the ink discharging device and the method of discharging ink respectively represent a device capable of discharging fluids such as ink and processing fluids to a printing medium and a method of printing utilizing the device. The printing medium refers to an item to which ink or processing fluids can be temporarily or permanently attached. Furthermore, this printing device includes a desktop printer, an ink discharging device capable of printing images on a wide printing medium having, for example, AO size, and a continuous printer capable of using continuous paper rolled up in a roll-like form as a printing medium.

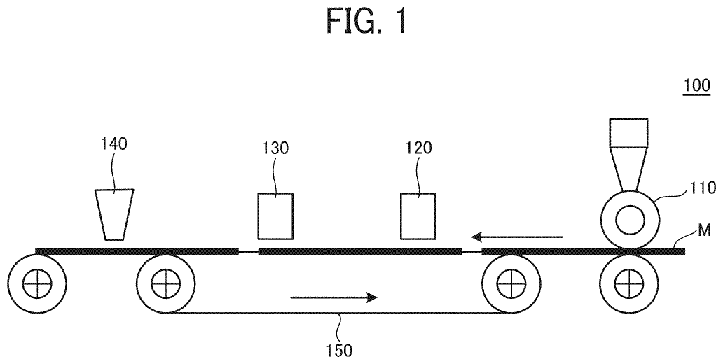

FIG. 1 is a diagram illustrating an example of the image forming apparatus including the ink discharging device of the present disclosure.

It is possible to apply the ink and the pre-processing fluid with a single printing device or separate printing devices.

An image forming apparatus 100 illustrated in FIG. 1 includes a pre-processing fluid applying unit 110, an ink applying unit 120, a post-processing fluid applying unit 130, a drying unit 140, and a conveyance unit 150. The pre-processing fluid applying unit 110 applies a pre-processing fluid to a printing medium M.

The pre-processing fluid applying unit 110, the post-processing fluid applying unit 130, the drying unit 140, and the conveyance unit 150 can be omitted.

The method of applying a pre-processing fluid is not particularly limited. Specific examples include, but are not limited to, inkjetting, spray coating, roller coating, gravure coating, gravure offset coating, bar coating, roll coating, knife coating, air knife coating, comma coating, U comma coating, AKKU coating, smoothing coating, MICROGRAVURE™ coating, reverse roll coating, four or five roll coating, dip coating, curtain coating, slide coating, and die coating.

The pre-processing fluid applying unit 110 can be omitted since the image forming apparatus may print after manually applying a pre-processing fluid to a printing medium by a method such as bar coating.

The ink applying unit 120 applies inkjet ink to the surface of the printing medium M where the pre-processing fluid has been applied.

Any known inkjet head can be used as the ink applying unit 120.

The ink applying unit 120 can be a head for discharging ink of any color. Heads for discharging ink of color like Y (yellow), M (magenta), C (cyan), K (black), and W (white) can be optionally disposed, for example.

The post-processing fluid applying unit 130 applies a post-processing fluid to the region of the surface of the printing medium M where the inkjet ink has been applied. In addition to an inkjet head, a spray or a roller can be used as the post-processing fluid applying unit 130.

The post-processing fluid applying unit 130 can be omitted.

The method of applying a post-processing fluid is not particularly limited.

Specific examples include, but are not limited to, inkjetting, roller coating, gravure coating, gravure offset coating, bar coating, roll coating, knife coating, air knife coating, comma coating, U comma coating, AKKU coating, smoothing coating, MICROGRAVURE™ coating, reverse roll coating, four or five roll coating, dip coating, curtain coating, slide coating, and die coating.

The drying unit 140 dries the printing medium M to which the pre-processing fluid, ink, and post-processing fluid have been applied.

The printing medium M where an ink has been applied is dried if the ink is applied to the printing medium M without applying a pre-processing fluid thereto.

The printing medium M where a pre-processing fluid and an ink have been applied is dried if the ink and the pre-processing fluid are applied to the printing medium M.

Optionally, the printing medium M can be dried after a pre-processing fluid is applied.

Optionally, the printing medium M can be dried after an ink is applied in the same manner as described above when a post-processing fluid is applied.

The drying unit 140 can be omitted if there is no post-processing fluid applying unit to an image forming apparatus.

The drying unit 140 can use infrared, microwave, a roll heater, a heat press, and a fixing roller for heating instead of heated wind and drying the printing medium M onto which the post-processing fluid is already applied. It is also possible to naturally dry the printing medium M onto which the post-processing fluid is already applied without operating the drying unit 140.

The conveyance unit 150 conveys the printing medium M.

There is no specific limit to the conveyance unit 150 as long as it can convey the printing medium M. The conveyance unit 150 can be a conveyance belt or a platen.

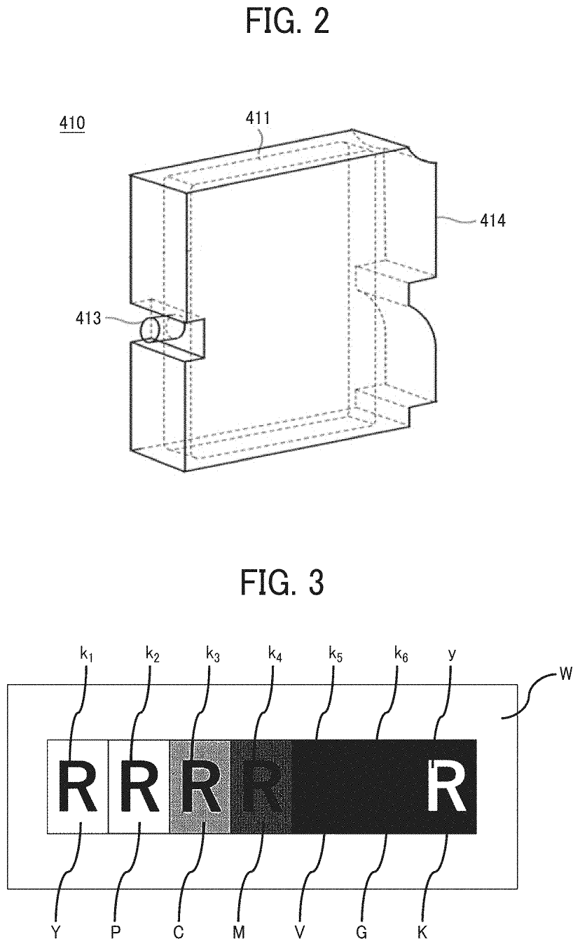

FIG. 2 is a schematic diagram illustrating an example of the processing fluid container or ink container.

A container 411 is housed in a unit such as a plastic container housing unit 414. Each container 410 is used in a form of cartridge. An ink discharging outlet 413 of the container 410 communicates with an inkjet discharging head so that the inkjet discharging head can discharge a processing fluid and white ink to a printing medium.

Method of Applying

According to the image forming method, white ink, color ink, and pre-processing fluid can be independently applied by discharging or coating. It is preferable to apply white ink and color ink by discharging and more preferable by inkjetting.

The method of discharging is not particularly limited and can be suitably selected to suit to a particular application. For example, it is possible to discharge a processing fluid by using a piezoelectric element actuator, thermal energy, actuator utilizing an electrostatic force, or a continuous jetting charging control head.

Specific examples of coating include, but are not limited to, blade coating, gravure coating, gravure offset coating, wire-bar coating, bar coating, roll coating, knife coating, air knife coating, comma coating, U comma coating, AKKU coating, smoothing coating, MICROGRAVURE™ coating, reverse roll coating, four or five roll coating, dip coating, curtain coating, slide coating, and die coating.

The image forming method may furthermore optionally include heating the white ink, color ink, or pre-processing fluid applied to the printing medium. The white ink is heated and dried to inhibit rub resistance from deteriorating as a result of insufficient drying of the white ink; however, it is preferable to apply no heat to the printing medium where the white ink has been applied between the white ink application and the color ink application.

The amount of white ink applied to a printing medium during the application of white ink significantly varies depending on the type of the printing medium. It is, for example, preferably from 1 to 500 g/m² and more preferably from 5 to 400 g/m² to enhance the image quality and drying property. For fabric, it is preferably from 50 to 500 g/m², more preferably from 100 to 400 g/m², and furthermore preferably from 150 to 300 g/m².

The amount of color ink applied to a printing medium significantly varies during the color ink application depending on the type of the printing medium. It is, for example, preferably from 1 to 50 g/m² and more preferably from 5 to 30 g/m². For fabric, it is preferably from 5 to 50 g/m² and more preferably from 10 to 30 g/m².

Pre-Processing Fluid Applying Unit and Applying Processing Fluid

The pre-processing fluid applying unit applies the processing fluid mentioned above in the processing fluid container mentioned above to a printing medium.

In the application of processing fluid, the processing fluid mentioned above in the processing fluid container mentioned above is applied to a printing medium.

The application of processing fluid is not particularly limited and can be suitably selected to suit to a particular application. It includes discharging and coating.

This discharging is not particularly limited and can be suitably selected to suit to a particular application. For example, it is possible to discharge processing fluid by using a piezoelectric element actuator, thermal energy, actuator utilizing an electrostatic force, or a continuous jetting charging control head.

Specific examples of coating include, but are not limited to, blade coating, gravure coating, gravure offset coating, wire-bar coating, bar coating, roll coating, knife coating, air knife coating, comma coating, U comma coating, AKKU coating, smoothing coating, MICROGRAVURE™ coating, reverse roll coating, four or five roll coating, dip coating, curtain coating, slide coating, and die coating.

The amount of pre-processing fluid applied to a printing medium significantly varies during the application of pre-processing fluid depending on the type of the printing medium. It is, for example, preferably from 0.1 to 500 g/m² and more preferably from 1 to 400 g/m² to enhance the image quality and drying property. For fabric, it is preferably from 100 to 500 g/m², more preferably from 200 to 500 g/m², and furthermore preferably from 300 to 400 g/m².

Other Optional Unit and Other Optional Step

The other optional units are not particularly limited and can be suitably selected to suit to a particular application. They include, but are not limited to, a post-processing unit, a first drying unit, and a second drying unit.

The other optional processes are not particularly limited and can be suitably selected to suit to a particular application. They include, but are not limited to, post-processing, first drying, and second drying.

Post-Processing Unit and Post-Processing

The post-processing device is to apply a post-processing fluid.

In the post-processing, a post-processing fluid is applied.

The post-processing fluid is not particularly limited as long as a transparent layer can be formed with the post-processing fluid.

Materials such as organic solvents, water, resins, surfactants, defoaming agents, pH regulators, preservatives and fungicides, and corrosion inhibitors are suitably selected based on a necessity basis and mixed to obtain post-processing fluid.

The post-processing fluid can be applied to the entire printing region formed on a printing medium or only the region on which an ink image is formed.

The method of applying the post-processing fluid is not particularly limited. The same method as that of applying the processing fluid can be used.

The post-processing fluid applying unit and the application of a post-processing fluid are optional.

First Drying Unit and First Drying

The first drying unit dries a printing medium on which the processing fluid is already applied.

In the first drying, the printing medium on which the processing fluid mentioned above is applied is dried.

The first drying unit and first drying are not particularly limited as long as they can dry a printing medium. It is preferably heating.

The printing medium on which the processing fluid is applied can be dried by drying (also referred to as first drying) after the application of the processing fluid.

The processing fluid applied to the printing medium is dried during the first drying.

The first drying unit is not particularly limited. Any available heating device can be used as the first drying unit. A device such as a roll heater, drum heater, fan heater, or heat press can be used to dry by heating.

Second Drying Unit and Second Heating

The second drying unit dries a printing medium on which the processing fluid and the ink are already applied after the ink is applied.

In the second drying, the printing medium on which the processing fluid and the ink mentioned above are already applied is dried after the ink is applied.

The processing fluid and ink applied onto a printing medium are dried during the second drying.

The second drying device and second drying are not particularly limited as long as they can dry a printing medium. It is preferably heating.

The second drying unit is not particularly limited. Any available heating device can be used as the second drying unit. A device such as a roll heater, drum heater, fan heater, or heat press can be used to dry by heating.

If cotton fabric is used as the printing medium, the first drying after the pre-processing fluid is applied is preferably conducted at 120 to 200 degrees C. for 30 to 300 seconds and the second drying after the color ink is applied is preferably conducted at 120 to 180 degrees C. for 30 to 300 seconds to enhance the productivity.

If polyester fabric is used as the printing medium, the first drying after the pre-processing fluid is applied is preferably conducted at 100 to 160 degrees C. for 60 to 300 seconds and the second drying after the color ink is applied is preferably conducted at 100 to 150 degrees C. for 60 to 300 seconds to prevent the dye from transferring from dyed fabric.

In the case of a non-permeable printing medium, the second drying after the color ink is applied is preferably conducted at 50 to 100 degrees C. for 60 to 400 seconds.

Method of Manufacturing Ink Discharged Matter and Discharging Device

The method of manufacturing discharged matter of the ink of the present disclosure includes applying an ink and other optional processes. The ink contains water, a coloring material, an organic solvent, and resin, wherein the entire of the coloring material and the solid content of the resin is 15 percent by mass or greater to the ink, the organic solvent contains an organic solvent A and the compound represented by the Chemical Formula I, and the organic solvent A is a polyol with a boiling point of 180 degrees C. or higher and an equilibrium moisture content of 36 percent by mass or higher at 23 degrees C. and 80 percent RH.

In the ink in the method of manufacturing discharged matter of the ink of the present disclosure and the device for manufacturing printed matter, the entire of the coloring material and the solid contents of the resin is 15 percent by mass or greater to the ink, the organic solvent contains an organic solvent A and the compound represented by the Chemical Formula I, and the organic solvent A is a polyol with a boiling point of 180 degrees C. or higher and an equilibrium moisture content of 36 percent by mass or higher at 23 degrees C. and 80 percent RH.

The method of manufacturing discharged matter of the ink of the present disclosure is the same as that of discharging the ink for image forming of the present disclosure. The device for manufacturing printed matter is the same as the ink discharging device of the present disclosure.

The terms of image forming, recording, and printing in the present disclosure represent the same meaning.

Also, recording media, media, and print substrates in the present disclosure have the same meaning unless otherwise specified.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

### Preparation Example 1 of Pigment Dispersion

A total of 100 g of Black Pearls^{registered} 1000 (carbon black with a BET specific surface area of 343 m²/g and an absorbing amount of dibutylphthalate (DBPA) of 105 ml/100 g, manufactured by Cabot Corporation), 100 milimole of sulfanilic acid, and 1 litter of highly deionized water were mixed with a Silverson Mixer at 6,000 rpm in a room temperature environment.

Thereafter, 100 milimole of nitric acid was added to the thus-obtained slurry. Thirty minutes later, 100 milimole of sodium nitrite dissolved in a 10 mL of highly deionized water was slowly added to the slurry. Furthermore, the resulting material was heated to 60 degrees C. while being stirred to allow reaction for one hour to obtain a reformed pigment in which sulfanilic acid was added to carbon black.

Next, the pH of the product was adjusted to 9 with tetrabutyl ammonium hydroxide solution (methanol solution) at 10 percent by mass to obtain a reformed pigment dispersion 30 minutes later. Thereafter, the dispersion obtained and highly deionized water were subjected to ultrafiltering with dialysis membrane followed by ultrasonic dispersion to obtain a surface reformed black pigment dispersion with a solid content of 20 percent by mass. The degree of surface reforming of the thus-obtained surface reformed pigment dispersion was 0.75 mmol/g and the 50 percent cumulative volume particle diameter D₅₀ was 120 nm as measured with a particle size distribution measuring instrument (NANOTRAC UPA-EX150, manufactured by NIKKISO CO., LTD.).

### Preparation Example 2 of Pigment Dispersion

A total of 1 kg of SMART Magenta 3122BA (Pigment Red 122 surface treated dispersion, solid content of 14.5 percent by mass, manufactured by SENSIENT Corporation) was subjected to acid deposition with 0.1 normal HCL aqueous solution.

Next, the pH of the product was adjusted to 9 with tetraethyl ammonium hydroxide aqueous solution at 10 percent by mass to obtain a reformed pigment dispersion 30 minutes later. The thus-obtained reformed pigment dispersion containing a pigment bonded to at least one amino benzoate group or amino benzoate tetraethyl ammonium salt was subjected to ultrafiltering by dialysis membrane with highly deionized water, followed by ultrasonic dispersion to obtain a surface reformed magenta pigment dispersion having a pigment solid content of 20 percent by mass.

The surface reformed magenta pigment dispersion had a 50 percent cumulative volume particle diameter D₅₀ of 104 nm as measured by a particle size distribution measuring instrument (NANOTRAC UPA-EX150, manufactured by NIKKISO CO., LTD.).

### Preparation Example 3 of Pigment Dispersion

A total of 1 kg of SMART Cyan 3154BA (Pigment Blue 15:4 surface reformed dispersion, solid portion: 14.5 percent by mass, manufactured by SENSIENT Corporation) was subjected to acid deposition with 0.1 normal HCL aqueous solution.

Next, the pH of the product was adjusted to 9 with benzyl trimethyl ammonium hydroxide solution (methanol solution) at 40 percent by mass to obtain a reformed pigment dispersion 30 minutes later. The thus-obtained reformed pigment dispersion including a pigment bonded to at least one amino benzoate group or amino benzoate benzyltrimethyl ammonium salt was subjected to ultrafiltering by dialysis membrane with highly deionized water, followed by ultrasonic dispersion to obtain a surface reformed cyan pigment dispersion having a pigment solid content of 20 percent by mass.

The surface reformed cyan pigment dispersion had a 50 percent cumulative volume particle diameter (D₅₀) of 116 nm as measured by a particle size distribution measuring instrument (NANOTRAC UPA-EX150, manufactured by NIKKISO CO., LTD.).

### Preparation Example 4 of Pigment Dispersion

The pH of 1 kg of SMART Yellow 3074BA (Pigment Yellow 74 surface treated dispersion, solid content: 14.5 percent by mass, manufactured by SENSIENT Corporation) was adjusted to 9 with tetrabutyl ammonium hydroxide solution (methanol solution) at 10 percent by mass to obtain a reformed pigment dispersion 30 minutes later. The thus-obtained reformed pigment dispersion including a pigment bonded to at least one amino benzoate group or amino benzoate tetrabutyl ammonium salt was subjected to ultrafiltering by dialysis membrane with highly deionized water, followed by ultrasonic dispersion to obtain a surface reformed yellow pigment dispersion with a pigment solid content of 20 percent by mass.

The surface reformed yellow pigment dispersion had a 50 percent cumulative volume particle diameter D₅₀ of 145 nm as measured by a particle size distribution measuring instrument (NANOTRAC UPA-EX150, manufactured by NIKKISO CO., LTD.).

### Preparation Example 5 of Pigment Dispersion

After sufficient replacement with nitrogen gas in a 1 L flask equipped with a mechanical stirrer, a thermometer, a nitrogen gas introducing tube, a reflux tube, and a dripping funnel, 11.2 g of styrene, 2.8 g of acrylic acid, 12.0 g of lauryl methacrylate, 4.0 g of polyethylene glycol methacrylate, 4.0 g of styrene macromer, and 0.4 g of mercapto ethanol were mixed in the flask and heated to 65 degrees C. Next, a liquid mixture of 100.8 g of styrene, 25.2 g of acrylic acid, 108.0 g of lauryl methacrylate, 36.0 g of polyethylene glycol methacrylate, 60.0 g of hydroxyethyl methacrylate, 36.0 g of styrene macromer, 3.6 g of mercapto ethanol, 2.4 g of azobismethyl valeronitrile, and 18 g of methylethyl ketone was added dropwise to the flask in two and a half hours. Subsequently, a liquid mixture of 0.8 g of azobismethyl valeronitrile and 18 g of methylethyl ketone was added dropwise to the flask in half an hour. After one-hour stirring at 65 degrees C., 0.8 g of azobismethyl valeronitrile was added followed by stirring for another hour. After the reaction was complete, 364 g of methylethyl ketone was added to the flask to obtain 800 g of a polymer solution A having a concentration of 50 percent by mass.

Next, 28 g of the polymer solution A, 42 g of C.I. Pigment Red 122, 13.6 g of 1 mol/L potassium hydroxide aqueous solution, 20 g of methyl ethyl ketone, and 13.6 g of deionized water were thoroughly stirred followed by kneading using a roll mill to obtain a paste. The obtained paste was placed in 200 g of deionized water followed by sufficiently stirring. Methylethyl ketone and water were distilled away using an evaporator. The thus-obtained liquid dispersion was filtered under pressure with a polyvinylidene fluoride membrane filter having an average pore diameter of 5.0 μm to obtain a liquid dispersion of polymer particulate containing a magenta pigment in an amount of 15 percent by mass at a solid content of 20 percent by mass.

The liquid dispersion of polymer particulates containing a magenta pigment had a 50 percent cumulative volume particle diameter D₅₀ of 127 nm as measured by a particle size distribution measuring instrument (NANOTRAC UPA-EX150, manufactured by NIKKISO CO., LTD.).

### Preparation Example 6 of Pigment Dispersion

Liquid dispersion of polymer particulate containing a cyan pigment was prepared in the same manner as in Preparation Example 5 of pigment dispersion except that C.I. Pigment red 122 as the pigment was changed to a phthalocyanine pigment (C.I. Pigment Blue 15:3).

The cumulative average particle diameter D₅₀ of the polymer particulate in the liquid dispersion of polymer particulate containing a cyan pigment obtained was 93 nm as measured with a particle size distribution measuring instrument (NANOTRAC UPA-EX150, manufactured by NIKKISO CO., LTD.).

### Preparation Example 7 of Pigment Dispersion

A liquid dispersion of polymer particulates containing a yellow pigment was prepared in the same manner as in Preparation Example 5 except that C.I. Pigment Red 122 was replaced with bisazo yellow pigment (C.I. Pigment Yellow 155). The liquid dispersion of polymer particulates containing a yellow pigment had a 50 percent cumulative volume particle diameter (D₅₀) of 76 nm as measured by a particle size distribution measuring instrument (NANOTRAC UPA-EX150, manufactured by NIKKISO CO., LTD.).

### Preparation Example 8 of Pigment Dispersion

A liquid dispersion of polymer particulates containing a black pigment was prepared in the same manner as in Preparation Example 5 except that C.I. Pigment Red 122 serving as pigment was changed to carbon black (FW100, manufactured by Degussa AG). The cumulative average particle diameter D₅₀ of the polymer particulate in the liquid dispersion of polymer particulate containing a black pigment obtained was 104 nm as measured with a particle size distribution measuring instrument (NANOTRAC UPA-EX150, manufactured by NIKKISO CO., LTD.).

### Preparation Example 9 of Pigment Dispersion

A total of 55.6 g of copolymer solution of DISPERBYK-2081 (manufactured by BYK Japan), 517 g of titanium oxide (TITONE R-25, manufactured by SAKAI CHEMICAL INDUSTRY CO., LTD.), 50 g of β-methoxy-N,N-dimethyl-propionamide, and 377.4 g of deionized water were sufficiently stirred, placed in a bead mill (DYNO-MILL), and dispersed until the 50 percent cumulative volume particle diameter D₅₀ reached 300 nm or less. This liquid dispersion was filtered with a polyvinylidene fluoride membrane filter having an average pore diameter of 5.0 μm under pressure to remove coarse particles. A liquid dispersion of polymer containing a white pigment was obtained which had a solid content of 54.5 percent by mass and a white pigment concentration of 50 percent by mass. The cumulative average particle diameter D₅₀ of the liquid dispersion of the polymer particulate containing white pigment was 283 nm as measured by particle size distribution measuring instrument (NANOTRAC UPA-EX150, manufactured by NIKKISO CO., LTD.).

### Synthesis Example 1 of Resin

After sufficient replacement with nitrogen gas in a flask (1 L) equipped with a mechanical stirrer, a thermometer, a nitrogen gas introducing tube, a reflux tube, and a dripping funnel, 8.0 g of LATEMUL S-180 (reactive anionic surfactant, manufactured by Kao Corporation) was admixed with 350 g of deionized water and heated to 65 degrees C. Thereafter, 3.0 g of t-butylperoxy benzoate serving as reaction initiator and 1.0 g of sodium isoascorbiate were added to the mixture. Five minutes later, a mixture of 45 g of methylmethacrylate, 160 g of methacrylic acid-2-ethylhexyl, 5 g of acrylic acid, 45 g of butylmethacrylate, 30 g of cyclohexyl methacrylate, 15 g of vinyltriethoxysilane, 8.0 g of LATEMUL S-180, and 340 g of deionized water were dripped in the flask in three hours. Subsequent to heating at 80 degrees C. for two-hour aging, the resulting matter was cooled down to room temperature. pH of the resulting matter was adjusted to 7 to 8 by sodium hydroxide.

Thereafter, ethanol was distilled away with an evaporator followed by moisture adjustment to obtain 730 g of water dispersion containing acrylic-silicone resin with a solid content of 40 percent by mass. In addition, the 50 percent cumulative volume particle diameter D₅₀ of the resin in the water dispersion was 80 nm as measured with a particle size distribution measuring instrument (NANOTRAC UPA-EX150, manufactured by NIKKISO CO., LTD.). The glass transition temperature Tg was −10 degrees C.

### Manufacturing Example 1 of Ink

A total of 5.00 parts by mass of 1,2-hexane diol, 24.00 parts by mass of glycerin, 5.00 parts by mass of the compound represented by the Chemical Formula I, 0.20 parts by mass of 2,5,8,11-tetramethyl decane-5,8-diol, and 1.00 parts by mass of EMULGEN LS-106 were mixed and stirred in a container equipped with a stirrer for 30 minutes. Thereafter, 0.05 parts by mass of preservatives and fungicides (Proxel GXL, manufactured by Avecia Inkjet Limited), 0.20 parts by mass of 2-amino-2-ethyl-1,3-propane diol, 26.67 parts by mass of the liquid dispersion of polymer particulate containing magenta pigment of Preparation Example 5, 31.58 parts by mass of SUPERFLEX® 860, and a balance of highly pure water to make the total 100 parts were added to the mixture followed by mixing and stirring for 60 minutes. Thereafter, the thus-obtained mixture was filtered with a polyvinilydene fluoride membrane filter having an average pore diameter of 5 μm under pressure to remove coarse particles and dust. Thus, ink 1 was obtained.

### Manufacturing Examples 2 to 45 of Ink

Inks 2 to 45 were obtained in the same manner as in Manufacturing Example 1 except that the prescription of ink was changed to those shown in Tables 1 to 8. The content of each material is represented in percent by mass in Tables 1 to 8 below. It does not represent the content of solid portion or effective component but all included.

The details of each material shown in Tables 1 to 8 below are as follows.

Coloring Agent
AC-AW-62: White pigment liquid dispersion, pigment solid content of 50.0 percent by mass, manufactured by Dainichiseika Color & Chemicals Mfg. Co., Ltd.

Resin
SUPERFLEX® 460: Polyurethane resin dispersion (solid content: 38.0 percent by mass, glass transition temperature (Tg): −21 degrees C., manufactured by DKS Co., Ltd.) SUPERFLEX 460S: Polyurethane resin dispersion (solid content: 38.0 percent by mass, glass transition temperature (Tg): −31 degrees C., manufactured by DKS Co., Ltd.)
SUPERFLEX® 470: Polyurethane resin dispersion (solid content: 38.0 percent by mass, glass transition temperature (Tg): −31 degrees C., manufactured by DKS Co., Ltd.)
SUPERFLEX® 860: Polyurethane resin dispersion (solid content: 40.0 percent by mass, glass transition temperature (Tg): 36 degrees C., manufactured by DKS Co., Ltd.)
TAKELAC^{trademark} W-6061: Polyurethane resin dispersion, solid content of 30.0 percent by mass, glass transition temperature (Tg) of 25 degrees C., manufactured by Mitsui Chemicals, Inc.
TAKELAC^{trademark} WS-6021: Polyurethane resin dispersion, solid content of 30.0 percent by mass, glass transition temperature (Tg) of −60 degrees C., manufactured by Mitsui Chemicals, Inc.
TAKELAC^{trademark} W-6110: Polyurethane resin dispersion, solid content of 33.4 percent by mass, glass transition temperature (Tg) of −20 degrees C., manufactured by Mitsui Chemicals, Inc.

Surfactant
TEGO Wet 270 (polyether-modified siloxane compound (manufactured by Evonik Industries AG, effective component: 100 percent)
SILFACE SAG503A: (polyether-modified siloxane compound (effective component: 100 percent, manufactured by Nisshin Chemical Co., Ltd.)
Surfynol 104E (effective component: 50 percent, manufactured by Nissin Chemical co., ltd.)
UNIDYNE^{trademark} DSN403N: Polyoxyethylene perfluoroalkyl ether, effective component of 100 percent by mass, manufactured by DAIKIN INDUSTRIES, Ltd.
EMALGEN LS-106 (polyoxyethylene polyoxypropylene alkyl ether, effective component of 100 percent by mass, manufactured by KAO CORPORATION)

Mildew-Proofing Agent
PROXEL GXL: mildew-proofing agent mainly composed of 1,2-benzisothiazolin-3-one, component of 20 percent, containing dipropylene glycol, manufactured by Avecia Inkjet Limited

TABLE 1

| | | | | | Manufac- | Manufac- | Manufac- | Manufac- | Manufac- |
|---|---|---|---|---|---|---|---|---|---|
| | | | Effective | | turing | turing | turing | turing | turing |
| Total (percent by mass) | | | component | | Example 1 | Example 2 | Example 3 | Example 4 | Example 5 |
| Coloring material | | Surface-modified black pigment | 20.0 | percent | — | — | — | — | — |
| (pigment dispersion) | | dispersion, (Preparation Example | | | | | | | |
| | | 1, pigment solid content of 20 | | | | | | | |
| | | percent by mass) | | | | | | | |
| | | Surface-modified magenta pigment | 20.0 | percent | — | — | — | — | — |
| | | dispersion, (Preparation Example | | | | | | | |
| | | 2, pigment solid content of 20 | | | | | | | |
| | | percent by mass) | | | | | | | |
| | | Surface-modified cyan pigment | 20.0 | percent | — | — | — | — | — |
| | | dispersion, (Preparation Example | | | | | | | |
| | | 3, pigment solid content of 20 | | | | | | | |
| | | percent by mass) | | | | | | | |
| | | Surface-modified yellow pigment | 20.0 | percent | — | — | — | — | — |
| | | dispersion, (Preparation Example | | | | | | | |
| | | 4, pigment solid content of 20 | | | | | | | |
| | | percent by mass) | | | | | | | |
| | | Liquid dispersion of fine polymer | 20.0 | percent | 26.67 | — | — | — | — |
| | | particle containing magenta pigment | | | | | | | |
| | | (Preparation Example 5, pigment | | | | | | | |
| | | solid content of 15 percent by | | | | | | | |
| | | mass) | | | | | | | |
| | | Liquid dispersion of fine polymer | 20.0 | percent | — | 26.67 | — | — | — |
| | | particle containing cyan pigment | | | | | | | |
| | | (Preparation Example 6, pigment | | | | | | | |
| | | solid content of 15 percent by | | | | | | | |
| | | mass) | | | | | | | |
| | | Liquid dispersion of fine polymer | 20.0 | percent | — | — | 26.67 | — | — |
| | | particle containing yellow pigment | | | | | | | |
| | | (Preparation Example 7, pigment | | | | | | | |
| | | solid content of 15 percent by | | | | | | | |
| | | mass) | | | | | | | |
| | | Liquid dispersion of fine polymer | 20.0 | percent | — | — | — | 33.33 | — |
| | | particle containing carbon black | | | | | | | |
| | | pigment (Preparation Example 8, | | | | | | | |
| | | pigment solid content of 15 | | | | | | | |
| | | percent by mass) | | | | | | | |
| | | Liquid dispersion of polymer | 54.5 | percent | — | — | — | — | — |
| | | dispersion containing white | | | | | | | |
| | | pigment (Preparation Example | | | | | | | |
| | | 9, pigment solid content of | | | | | | | |
| | | 50 percent by mass) | | | | | | | |
| | | Liquid dispersion of polymer | 52.5 | percent | — | — | — | — | 18.00 |
| | | dispersion containing white | | | | | | | |
| | | pigment (AC-AW62, pigment | | | | | | | |
| | | solid content of 50 percent | | | | | | | |
| | | by mass, manufactured by | | | | | | | |
| | | Dainichiseika Color & | | | | | | | |
| | | Chemicals Mfg. Co., Ltd.) | | | | | | | |
| Resin | Urethane | SUPERFLEX ® 460 | 38.0 | percent | — | — | — | — | — |
| | resin | (Resin solid portion of | | | | | | | |
| | | 38 percent by mass, Tg | | | | | | | |
| | | of −21 degrees C.) | | | | | | | |
| | | SUPERFLEX ® 460S | 38.0 | percent | — | — | — | — | — |
| | | (Resin solid portion of | | | | | | | |
| | | 38 percent by mass, Tg | | | | | | | |
| | | of −28 degrees C.) | | | | | | | |
| | | SUPERFLEX ® 470 | 38.0 | percent | — | — | — | — | — |
| | | (Resin solid portion of | | | | | | | |
| | | 38 percent by mass, Tg | | | | | | | |
| | | of −31 degrees C.) | | | | | | | |
| | | SUPERFLEX ® 420 | 32.0 | percent | — | — | — | — | — |
| | | (Resin solid portion of | | | | | | | |
| | | 32 percent by mass, Tg | | | | | | | |
| | | of −10 degrees C.) | | | | | | | |
| | | TAKELAC ™ WS-6021 | 30.0 | percent | — | — | — | — | — |
| | | (Resin solid portion of | | | | | | | |
| | | 30 percent by mass, Tg | | | | | | | |
| | | of −60 degrees C.) | | | | | | | |
| | | TAKELAC ™ W-6110 | 33.4 | percent | — | — | — | — | — |
| | | (Resin solid portion of | | | | | | | |
| | | 33.4 percent by mass, Tg | | | | | | | |
| | | of −20 degrees C.) | | | | | | | |
| | | TAKELAC ™ W-6061 | 30.0 | percent | 33.33 | 33.33 | 33.33 | 33.33 | 30.00 |
| | | (Resin solid portion of | | | | | | | |
| | | 30 percent by mass, Tg | | | | | | | |
| | | of 25 degrees C.) | | | | | | | |
| | Acrylic | Acrylic silicone resin | 40.0 | percent | — | — | — | — | — |
| | resin | (Synthesis Example 1, | | | | | | | |
| | | resin solid portion | | | | | | | |
| | | of 40 percent by mass, | | | | | | | |
| | | Tg of −10 degrees C.) | | | | | | | |
| Organic | Organic | Glycerin (boiling | 100 | percent | 19.00 | 19.00 | 19.00 | 17.00 | 15.00 |
| solvent | solvent A | point of 290 degree C./ | | | | | | | |
| | | 760 mmHg, equilibrium moisture | | | | | | | |
| | | content of 49 weight percent) | | | | | | | |
| | | Diglycerin (boiling | 100 | percent | — | — | — | — | — |
| | | point of 265 to 270 degree C./ | | | | | | | |
| | | 15 mmHg, equilibrium moisture | | | | | | | |
| | | content of 38 weight percent) | | | | | | | |
| | | Tetraethylene glycol (boiling | 100 | percent | — | — | — | — | — |
| | | point of 328 degrees C./ | | | | | | | |
| | | 760 mmHg, equilibrium | | | | | | | |
| | | moisture content of 37 | | | | | | | |
| | | weight percent) | | | | | | | |
| | | Triethylene glycol (boiling | 100 | percent | — | — | — | — | — |
| | | point of 288 degree C./ | | | | | | | |
| | | 760 mmHg, equilibrium | | | | | | | |
| | | moisture content of 39 | | | | | | | |
| | | weight percent) | | | | | | | |
| | | Ethylene glycol (boiling | 100 | percent | — | — | — | — | — |
| | | point of 197.3 degree C./ | | | | | | | |
| | | 760 mmHg, equilibrium | | | | | | | |
| | | moisture content of 44 | | | | | | | |
| | | weight percent) | | | | | | | |
| | Other organic | 1,3-butane diol | 100 | percent | — | — | — | — | — |
| | solvent | Propylene glycol | 100 | percent | — | — | — | — | — |
| | | 3-methyl-1,3-butane diol | 100 | percent | — | — | — | — | — |
| | | 1,2-butanediol | 100 | percent | — | — | — | — | — |
| | | 1,2-hexane diol | 100 | percent | 7.00 | 7.00 | 7.00 | 7.00 | 5.00 |
| | | Triethylene glycol | 100 | percent | — | — | — | — | — |
| | | monobutyl ether | | | | | | | |
| | | 2-ethyl-1,3- | 100 | percent | — | — | — | — | — |
| | | hexanediol | | | | | | | |
| | | 2,2,4-trimethyl-1,3- | 100 | percent | — | — | — | — | — |
| | | pentanediol | | | | | | | |

| | | | | | | | |
|---|---|---|---|---|---|---|---|
| Compound represented by | 100 | percent | 6.00 | 6.00 | 6.00 | 6.00 | 8.00 |
| Chemical Formula I (boiling | | | | | | | |
| point of 215.2 degrees C./ | | | | | | | |
| 760 mmHg, equilibrium moisture | | | | | | | |
| content of 42 weight percent) | | | | | | | |

| Surfactant | TEGO Wet 270 | 100 | percent | — | — | — | — | — |
|---|---|---|---|---|---|---|---|---|
| | SILFACE SAG503A | 100 | percent | — | — | — | — | — |
| | Surfynol 104E (effective | 50.0 | percent | — | — | — | — | — |
| | component: 50 percent) | | | | | | | |
| | UNIDYNE ™ DSN403N | 100 | percent | — | — | — | — | — |
| | EMULGEN LS-106 | 100 | percent | 1.00 | 1.00 | 1.00 | 1.00 | 1.00 |
| Mildew-proofing agent | Proxel GXL | 20.0 | percent | 0.05 | 0.05 | 0.05 | 0.05 | 0.05 |
| Foam inhibitor | 2,4,7,9- | 100 | percent | — | — | — | — | — |
| (defoaming agent) | tetramethyldecane- | | | | | | | |
| | 4,7-diol | | | | | | | |
| | 2,5,8,11- | 100 | percent | 0.20 | 0.20 | 0.20 | 0.20 | 0.20 |
| | tetramethyldodecane- | | | | | | | |
| | 5,8-diol | | | | | | | |
| pH regulator | 2-amino-2-ethyl-1,3- | 100 | percent | 0.20 | 0.20 | 0.20 | 0.20 | 0.20 |
| | propane diol | | | | | | | |

| | | | | | |
|---|---|---|---|---|---|
| Highly pure water | Balance | Balance | Balance | Balance | Balance |
| Total (percent by mass) | 100 | 100 | 100 | 100 | 100 |
| Proportion of organic solvent A | 19.0 | 19.0 | 19.0 | 17.0 | 15.0 |
| Entire of coloring material and solid content of resin | 15.3 | 15.3 | 15.3 | 16.7 | 18.5 |

TABLE 2

| | | | | | Manufac- | Manufac- | Manufac- | Manufac- | Manufac- |
|---|---|---|---|---|---|---|---|---|---|
| | | | Effective | | turing | turing | turing | turing | turing |
| Component (percent by mass) | | | component | | Example 6 | Example 7 | Example 8 | Example 9 | Example 10 |
| Coloring material | | Surface-modified black pigment | 20.0 | percent | — | — | — | — | — |
| (pigment dispersion) | | dispersion, (Preparation Example | | | | | | | |
| | | 1, pigment solid content of 20 | | | | | | | |
| | | percent by mass) | | | | | | | |
| | | Surface-modified magenta pigment | 20.0 | percent | — | — | — | — | — |
| | | dispersion, (Preparation Example | | | | | | | |
| | | 2, pigment solid content of 20 | | | | | | | |
| | | percent by mass) | | | | | | | |
| | | Surface-modified cyan pigment | 20.0 | percent | — | — | — | — | — |
| | | dispersion, (Preparation Example | | | | | | | |
| | | 3, pigment solid content of 20 | | | | | | | |
| | | percent by mass) | | | | | | | |
| | | Surface-modified yellow pigment | 20.0 | percent | — | — | — | — | — |
| | | dispersion, (Preparation Example | | | | | | | |
| | | 4, pigment solid content of 20 | | | | | | | |
| | | percent by mass) | | | | | | | |
| | | Liquid dispersion of fine polymer | 20.0 | percent | 26.67 | — | — | — | — |
| | | particle containing magenta pigment | | | | | | | |
| | | (Preparation Example 5, pigment | | | | | | | |
| | | solid content of 15 percent by mass) | | | | | | | |
| | | Liquid dispersion of fine polymer | 20.0 | percent | — | 26.67 | — | — | — |
| | | particle containing cyan pigment | | | | | | | |
| | | (Preparation Example 6, pigment | | | | | | | |
| | | solid content of 15 percent by mass) | | | | | | | |
| | | Liquid dispersion of fine polymer | 20.0 | percent | — | — | 26.67 | — | — |
| | | particle containing yellow | | | | | | | |
| | | pigment (Preparation Example 7, | | | | | | | |
| | | pigment solid content of 15 | | | | | | | |
| | | percent by mass) | | | | | | | |
| | | Liquid dispersion of fine polymer | 20.0 | percent | — | — | — | 33.33 | — |
| | | particle containing carbon black | | | | | | | |
| | | pigment (Preparation Example 8, | | | | | | | |
| | | pigment solid content of 15 percent | | | | | | | |
| | | by mass) | | | | | | | |
| | | Liquid dispersion of polymer | 54.5 | percent | — | — | — | — | — |
| | | dispersion containing white pigment | | | | | | | |
| | | (Preparation Example 9, pigment | | | | | | | |
| | | solid content of 50 percent by mass) | | | | | | | |
| | | Liquid dispersion of polymer | 52.5 | percent | — | — | — | — | 20.00 |
| | | dispersion containing white pigment | | | | | | | |
| | | (AC-AW62, pigment solid content of | | | | | | | |
| | | 50 percent by mass, manufactured by | | | | | | | |
| | | Dainichiseika Color & Chemicals Mfg. | | | | | | | |
| | | Co., Ltd.) | | | | | | | |
| Resin | Urethane | SUPERFLEX ® 460 (Resin | 38.0 | percent | 31.58 | 31.58 | 31.58 | 31.58 | — |
| | resin | solid portion of 38 percent by | | | | | | | |
| | | mass, Tg of −21 degrees C.) | | | | | | | |
| | | SUPERFLEX ® 460S (Resin | 38.0 | percent | — | — | — | — | 31.58 |
| | | solid portion of 38 percent by | | | | | | | |
| | | mass, Tg of −28 degrees C.) | | | | | | | |
| | | SUPERFLEX ® 470 (Resin | 38.0 | percent | — | — | — | — | — |
| | | solid portion of 38 percent by | | | | | | | |
| | | mass, Tg of −31 degrees C.) | | | | | | | |
| | | SUPERFLEX ® 420 (Resin | 32.0 | percent | — | — | — | — | — |
| | | solid portion of 32 percent by | | | | | | | |
| | | mass, Tg of −10 degrees C.) | | | | | | | |
| | | TAKELAC ™ WS-6021 (Resin | 30.0 | percent | — | — | — | — | — |
| | | solid portion of 30 percent by | | | | | | | |
| | | mass, Tg of −60 degrees C.) | | | | | | | |
| | | TAKELAC ™ W-6110 (Resin | 33.4 | percent | — | — | — | — | — |
| | | solid portion of 33.4 percent | | | | | | | |
| | | by mass, Tg of −20 degrees C.) | | | | | | | |
| | | TAKELAC ™ W-6061 (Resin | 30.0 | percent | — | — | — | — | — |
| | | solid portion of 30 percent by | | | | | | | |
| | | mass, Tg of 25 degrees C.) | | | | | | | |
| | Acrylic | Acrylic silicone resin (Synthesis | 40.0 | percent | — | — | — | — | — |
| | resin | Example 1, resin solid portion | | | | | | | |
| | | of 40 percent by mass, Tg | | | | | | | |
| | | of −10 degrees C.) | | | | | | | |
| Organic | Organic | Glycerin (boiling point | 100 | percent | 22.00 | 21.00 | 21.00 | 20.00 | 19.00 |
| solvent | solvent | of 290 degree C./760 mmHg, | | | | | | | |
| | A | equilibrium moisture content | | | | | | | |
| | | of 49 weight percent) | | | | | | | |
| | | Diglycerin (boiling point | 100 | percent | — | — | — | — | — |
| | | of 265 to 270 degree C./15 mmHg, | | | | | | | |
| | | equilibrium moisture content | | | | | | | |
| | | of 38 weight percent) | | | | | | | |
| | | Tetraethylene glycol (boiling point | 100 | percent | — | — | — | — | — |
| | | of 328 degrees C./760 mmHg, | | | | | | | |
| | | equilibrium moisture content | | | | | | | |
| | | of 37 weight percent) | | | | | | | |
| | | Triethylene glycol (boiling point | 100 | percent | 2.00 | 3.00 | 3.00 | 2.00 | — |
| | | of 288 degree C./760 mmHg, | | | | | | | |
| | | equilibrium moisture content | | | | | | | |
| | | of 39 weight percent) | | | | | | | |
| | | Ethylene glycol (boiling point | 100 | percent | 6.00 | 6.00 | 6.00 | 6.00 | 6.00 |
| | | of 197.3 degree C./760 mmHg, | | | | | | | |
| | | equilibrium moisture content | | | | | | | |
| | | of 44 weight percent) | | | | | | | |
| | Other organic | 1,3-butane diol | 100 | percent | — | — | — | — | — |
| | solvent | Propylene glycol | 100 | percent | — | — | — | — | — |
| | | 3-methyl-1,3-butane | 100 | percent | — | — | — | — | — |
| | | diol | | | | | | | |
| | | 1,2-butanediol | 100 | percent | — | — | — | — | — |
| | | 1,2-hexane diol | 100 | percent | — | — | — | — | — |
| | | Triethylene glycol | 100 | percent | — | — | — | — | — |
| | | monobutyl ether | | | | | | | |
| | | 2-ethyl-1,3- | 100 | percent | — | — | — | — | — |
| | | hexanediol | | | | | | | |
| | | 2,2,4-trimethyl-1,3- | 100 | percent | — | — | — | — | — |
| | | pentanediol | | | | | | | |

| | | | | | | | |
|---|---|---|---|---|---|---|---|
| Compound represented by Chemical Formula I | 100 | percent | 6.00 | 6.00 | 6.00 | 6.00 | 6.00 |
| (boiling point of 215.2 degrees C./ | | | | | | | |
| 760 mmHg, equilibrium moisture | | | | | | | |
| content of 42 weight percent) | | | | | | | |

| Surfactant | TEGO Wet 270 | 100 | percent | 0.20 | 0.20 | 0.20 | 0.20 | 0.20 |
|---|---|---|---|---|---|---|---|---|
| | SILFACE SAG503A | 100 | percent | — | — | — | — | — |
| | Surfynol 104E (effective | 50.0 | percent | — | — | — | — | — |
| | component: 50 percent) | | | | | | | |
| | UNIDYNE ™ DSN403N | 100 | percent | — | — | — | — | — |
| | EMULGEN LS-106 | 100 | percent | — | — | — | — | — |
| Mildew-proofing | Proxel GXL | 20.0 | percent | 0.05 | 0.05 | 0.05 | 0.05 | 0.05 |
| agent | | | | | | | | |
| Foam inhibitor | 2,4,7,9- | 100 | percent | 0.30 | 0.30 | 0.30 | 0.30 | 0.30 |
| (defoaming agent) | tetramethyldecane- | | | | | | | |
| | 4,7-diol | | | | | | | |
| | 2,5,8,11- | 100 | percent | — | — | — | — | — |
| | tetramethyldodecane- | | | | | | | |
| | 5,8-diol | | | | | | | |
| pH regulator | 2-amino-2-ethyl-1,3- | 100 | percent | 0.30 | 0.30 | 0.30 | 0.30 | 0.30 |
| | propane diol | | | | | | | |

| | | | | | |
|---|---|---|---|---|---|
| Highly pure water | Balance | Balance | Balance | Balance | |
| Total (percent by mass) | 100 | 100 | 100 | 100 | 100 |
| Proportion of organic solvent A | 30.0 | 30.0 | 30.0 | 28.0 | 25.0 |
| Entire of coloring material and solid content of resin | 17.3 | 17.3 | 17.3 | 18.7 | 22.5 |

TABLE 3

| | | | Effective | | Manufacturing | Manufacturing | Manufacturing |
|---|---|---|---|---|---|---|---|
| Component (percent by mass) | | | component | | Example 11 | Example 12 | Example 13 |
| Coloring material | | Surface-modified black | 20.0 | percent | — | — | — |
| (pigment dispersion) | | pigment dispersion, | | | | | |
| | | (Preparation Example 1, | | | | | |
| | | pigment solid content of | | | | | |
| | | 20 percent by mass) | | | | | |
| | | Surface-modified | 20.0 | percent | — | — | — |
| | | magenta pigment | | | | | |
| | | dispersion, (Preparation | | | | | |
| | | Example 2, pigment | | | | | |
| | | solid content of 20 | | | | | |
| | | percent by mass) | | | | | |
| | | Surface-modified cyan | 20.0 | percent | — | — | — |
| | | pigment dispersion, | | | | | |
| | | (Preparation Example 3, | | | | | |
| | | pigment solid content of | | | | | |
| | | 20 percent by mass) | | | | | |
| | | Surface-modified yellow | 20.0 | percent | — | — | — |
| | | pigment dispersion, | | | | | |
| | | (Preparation Example 4, | | | | | |
| | | pigment solid content of | | | | | |
| | | 20 percent by mass) | | | | | |
| | | Liquid dispersion of | 20.0 | percent | 26.67 | — | — |
| | | fine polymer particle | | | | | |
| | | containing magenta | | | | | |
| | | pigment (Preparation | | | | | |
| | | Example 5, pigment | | | | | |
| | | solid content of 15 | | | | | |
| | | percent by mass) | | | | | |
| | | Liquid dispersion of | 20.0 | percent | — | 26.667 | — |
| | | fine polymer particle | | | | | |
| | | containing cyan pigment | | | | | |
| | | (Preparation Example 6, | | | | | |
| | | pigment solid content of | | | | | |
| | | 15 percent by mass) | | | | | |
| | | Liquid dispersion of | 20.0 | percent | — | — | 26.67 |
| | | fine polymer particle | | | | | |
| | | containing yellow | | | | | |
| | | pigment (Preparation | | | | | |
| | | Example 7, pigment | | | | | |
| | | solid content of 15 | | | | | |
| | | percent by mass) | | | | | |
| | | Liquid dispersion of | 20.0 | percent | — | — | — |
| | | fine polymer particle | | | | | |
| | | containing carbon black | | | | | |
| | | pigment (Preparation | | | | | |
| | | Example 8, pigment | | | | | |
| | | solid content of 15 | | | | | |
| | | percent by mass) | | | | | |
| | | Liquid dispersion of | 54.5 | percent | — | — | — |
| | | polymer dispersion | | | | | |
| | | containing white | | | | | |
| | | pigment (Preparation | | | | | |
| | | Example 9, pigment | | | | | |
| | | solid content of 50 | | | | | |
| | | percent by mass) | | | | | |
| | | Liquid dispersion of | 52.5 | percent | — | — | — |
| | | polymer dispersion | | | | | |
| | | containing white | | | | | |
| | | pigment (AC-AW62, | | | | | |
| | | pigment solid content | | | | | |
| | | of 50 percent by | | | | | |
| | | mass, manufactured | | | | | |
| | | by Dainichiseika | | | | | |
| | | Color & Chemicals | | | | | |
| | | Mfg. Co., Ltd.) | | | | | |
| Resin | Urethane | SUPERFLEX ® 460 | 38.0 | percent | — | — | — |
| | resin | (Resin solid portion of | | | | | |
| | | 38 percent by mass, Tg | | | | | |
| | | of −21 degrees C.) | | | | | |
| | | SUPERFLEX ® 460S | 38.0 | percent | — | — | — |
| | | (Resin solid portion of | | | | | |
| | | 38 percent by mass, Tg | | | | | |
| | | of −28 degrees C.) | | | | | |
| | | SUPERFLEX ® 470 | 38.0 | percent | — | — | — |
| | | (Resin solid portion of | | | | | |
| | | 38 percent by mass, Tg | | | | | |
| | | of −31 degrees C.) | | | | | |
| | | SUPERFLEX ® 420 | 32.0 | percent | 34.38 | 34.38 | 34.38 |
| | | (Resin solid portion of | | | | | |
| | | 32 percent by mass, Tg | | | | | |
| | | of −10 degrees C.) | | | | | |
| | | TAKELAC ™ WS-6021 | 30.0 | percent | — | — | — |
| | | (Resin solid portion of | | | | | |
| | | 30 percent by mass, Tg | | | | | |
| | | of −60 degrees C.) | | | | | |
| | | TAKELAC ™ W-6110 | 33.4 | percent | — | — | — |
| | | (Resin solid portion of | | | | | |
| | | 33.4 percent by mass, Tg | | | | | |
| | | of −20 degrees C.) | | | | | |
| | | TAKELAC ™ W-6061 | 30.0 | percent | — | — | — |
| | | (Resin solid portion of | | | | | |
| | | 30 percent by mass, Tg | | | | | |
| | | of 25 degrees C.) | | | | | |
| | Acrylic | Acrylic silicone resin | 40.0 | percent | — | — | — |
| | resin | (Synthesis Example 1, | | | | | |
| | | resin solid portion of | | | | | |
| | | 40 percent by mass, Tg | | | | | |
| | | of −10 degrees C.) | | | | | |
| Organic | Organic | Glycerin (boiling point | 100 | percent | 18.00 | 18.00 | 18.00 |
| solvent | solvent A | of 290 degree C./760 | | | | | |
| | | mmHg, equilibrium | | | | | |
| | | moisture content of | | | | | |
| | | 49 weight percent) | | | | | |
| | | Diglycerin (boiling | 100 | percent | — | — | — |
| | | point of 265 to 270 | | | | | |
| | | degree C./15 mmHg, | | | | | |
| | | equilibrium moisture | | | | | |
| | | content of 38 | | | | | |
| | | weight percent) | | | | | |
| | | Tetraethylene glycol | 100 | percent | | | |
| | | (boiling point of 328 | | | | | |
| | | degrees C./760 mmHg, | | | | | |
| | | equilibrium moisture | | | | | |
| | | content of 37 | | | | | |
| | | weight percent) | | | | | |
| | | Triethylene glycol | 100 | percent | — | — | — |
| | | (boiling point of 288 | | | | | |
| | | degree C./760 mmHg, | | | | | |
| | | equilibrium moisture | | | | | |
| | | content of 39 | | | | | |
| | | weight percent) | | | | | |
| | | Ethylene glycol (boiling | 100 | percent | 9.00 | 9.00 | 9.00 |
| | | point of 197.3 degree | | | | | |
| | | C./760 mmHg, | | | | | |
| | | equilibrium moisture | | | | | |
| | | content of 44 | | | | | |
| | | weight percent) | | | | | |
| | Other | 1,3-butane diol | 100 | percent | — | — | — |
| | organic | Propylene glycol | 100 | percent | — | — | — |
| | solvent | 3-methyl-1,3-butane | 100 | percent | — | — | — |
| | | diol | | | | | |
| | | 1,2-butanediol | 100 | percent | — | — | — |
| | | 1,2-hexane diol | 100 | percent | — | — | — |
| | | Triethylene glycol | 100 | percent | — | — | — |
| | | monobutyl ether | | | | | |
| | | 2-ethyl-1,3-hexanediol | 100 | percent | 2.00 | 2.00 | 2.00 |
| | | 2,2,4-trimethyl-1,3- | 100 | percent | — | — | — |
| | | pentanediol | | | | | |

| | | | | | |
|---|---|---|---|---|---|
| Compound represented by | 100 | percent | 5.00 | 5.00 | 5.00 |
| Chemical Formula I (boiling point | | | | | |
| of 215.2 degrees C./760 mmHg, | | | | | |
| equilibrium moisture content of | | | | | |
| 42 weight percent) | | | | | |

| | | | | | | |
|---|---|---|---|---|---|---|
| Surfactant | TEGO Wet 270 | 100 | percent | — | — | — |
| | SILFACE SAG503A | 100 | percent | 0.30 | 0.30 | 0.30 |
| | Surfynol 104E (effective | 50.0 | percent | — | — | — |
| | component: 50 percent) | | | | | |
| | UNIDYNE ™ | 100 | percent | — | — | — |
| | DSN403N | | | | | |
| | EMULGEN LS-106 | 100 | percent | — | — | — |
| Mildew-proofing | Proxel GXL | 20.0 | percent | 0.05 | 0.05 | 0.05 |
| agent | | | | | | |
| Foam inhibitor | 2,4,7,9- | 100 | percent | — | — | — |
| (defoaming agent) | tetramethyldecane- | | | | | |
| | 4,7-diol | | | | | |
| | 2,5,8,11- | 100 | percent | 0.20 | 0.20 | 0.20 |
| | tetramethyldodecane- | | | | | |
| | 5,8-diol | | | | | |
| pH regulator | 2-amino-2-ethyl-1,3- | 100 | percent | 0.30 | 0.30 | 0.30 |
| | propane diol | | | | | |

| | | | |
|---|---|---|---|
| Highly pure water | Balance | Balance | Balance |
| Total (percent by mass) | 100 | 100 | 100 |
| Proportion of organic solvent A | 27.0 | 27.0 | 27.0 |
| Entire of coloring material and solid content of resin | 16.3 | 16.3 | 16.3 |

| | | | Effective | | Manufacturing | Manufacturing |
|---|---|---|---|---|---|---|
| Component (percent by mass) | | | component | | Example 14 | Example 15 |
| Coloring material | | Surface-modified black | 20.0 | percent | — | — |
| (pigment dispersion) | | pigment dispersion, | | | | |
| | | (Preparation Example 1, | | | | |
| | | pigment solid content of | | | | |
| | | 20 percent by mass) | | | | |
| | | Surface-modified | 20.0 | percent | — | — |
| | | magenta pigment | | | | |
| | | dispersion, (Preparation | | | | |
| | | Example 2, pigment | | | | |
| | | solid content of 20 | | | | |
| | | percent by mass) | | | | |
| | | Surface-modified cyan | 20.0 | percent | — | — |
| | | pigment dispersion, | | | | |
| | | (Preparation Example 3, | | | | |
| | | pigment solid content of | | | | |
| | | 20 percent by mass) | | | | |
| | | Surface-modified yellow | 20.0 | percent | — | — |
| | | pigment dispersion, | | | | |
| | | (Preparation Example 4, | | | | |
| | | pigment solid content of | | | | |
| | | 20 percent by mass) | | | | |
| | | Liquid dispersion of | 20.0 | percent | — | — |
| | | fine polymer particle | | | | |
| | | containing magenta | | | | |
| | | pigment (Preparation | | | | |
| | | Example 5, pigment | | | | |
| | | solid content of 15 | | | | |
| | | percent by mass) | | | | |
| | | Liquid dispersion of | 20.0 | percent | — | — |
| | | fine polymer particle | | | | |
| | | containing cyan pigment | | | | |
| | | (Preparation Example 6, | | | | |
| | | pigment solid content of | | | | |
| | | 15 percent by mass) | | | | |
| | | Liquid dispersion of | 20.0 | percent | — | — |
| | | fine polymer particle | | | | |
| | | containing yellow | | | | |
| | | pigment (Preparation | | | | |
| | | Example 7, pigment | | | | |
| | | solid content of 15 | | | | |
| | | percent by mass) | | | | |
| | | Liquid dispersion of | 20.0 | percent | 26.67 | — |
| | | fine polymer particle | | | | |
| | | containing carbon black | | | | |
| | | pigment (Preparation | | | | |
| | | Example 8, pigment | | | | |
| | | solid content of 15 | | | | |
| | | percent by mass) | | | | |
| | | Liquid dispersion of | 54.5 | percent | — | 22.00 |
| | | polymer dispersion | | | | |
| | | containing white | | | | |
| | | pigment (Preparation | | | | |
| | | Example 9, pigment | | | | |
| | | solid content of 50 | | | | |
| | | percent by mass) | | | | |
| | | Liquid dispersion of | 52.5 | percent | — | — |
| | | polymer dispersion | | | | |
| | | containing white | | | | |
| | | pigment (AC-AW62, | | | | |
| | | pigment solid content | | | | |
| | | of 50 percent by | | | | |
| | | mass, manufactured | | | | |
| | | by Dainichiseika | | | | |
| | | Color & Chemicals | | | | |
| | | Mfg. Co., Ltd.) | | | | |
| Resin | Urethane | SUPERFLEX ® 460 | 38.0 | percent | — | — |
| | resin | (Resin solid portion of | | | | |
| | | 38 percent by mass, Tg | | | | |
| | | of −21 degrees C.) | | | | |
| | | SUPERFLEX ® 460S | 38.0 | percent | — | — |
| | | (Resin solid portion of | | | | |
| | | 38 percent by mass, Tg | | | | |
| | | of −28 degrees C.) | | | | |
| | | SUPERFLEX ® 470 | 38.0 | percent | — | — |
| | | (Resin solid portion of | | | | |
| | | 38 percent by mass, Tg | | | | |
| | | of −31 degrees C.) | | | | |
| | | SUPERFLEX ® 420 | 32.0 | percent | 34.38 | — |
| | | (Resin solid portion of | | | | |
| | | 32 percent by mass, Tg | | | | |
| | | of −10 degrees C.) | | | | |
| | | TAKELAC ™ WS-6021 | 30.0 | percent | — | 18.33 |
| | | (Resin solid portion of | | | | |
| | | 30 percent by mass, Tg | | | | |
| | | of −60 degrees C.) | | | | |
| | | TAKELAC ™ W-6110 | 33.4 | percent | — | — |
| | | (Resin solid portion of | | | | |
| | | 33.4 percent by mass, Tg | | | | |
| | | of −20 degrees C.) | | | | |
| | | TAKELAC ™ W-6061 | 30.0 | percent | — | 18.33 |
| | | (Resin solid portion of | | | | |
| | | 30 percent by mass, Tg | | | | |
| | | of 25 degrees C.) | | | | |
| | Acrylic | Acrylic silicone resin | 40.0 | percent | — | — |
| | resin | (Synthesis Example 1, | | | | |
| | | resin solid portion of | | | | |
| | | 40 percent by mass, Tg | | | | |
| | | of −10 degrees C.) | | | | |
| Organic | Organic | Glycerin (boiling point | 100 | percent | 18.00 | 18.00 |
| solvent | solvent A | of 290 degree C./760 | | | | |
| | | mmHg, equilibrium | | | | |
| | | moisture content of | | | | |
| | | 49 weight percent) | | | | |
| | | Diglycerin (boiling | 100 | percent | — | — |
| | | point of 265 to 270 | | | | |
| | | degree C./15 mmHg, | | | | |
| | | equilibrium moisture | | | | |
| | | content of 38 | | | | |
| | | weight percent) | | | | |
| | | Tetraethylene glycol | 100 | percent | | 2.00 |
| | | (boiling point of 328 | | | | |
| | | degrees C./760 mmHg, | | | | |
| | | equilibrium moisture | | | | |
| | | content of 37 | | | | |
| | | weight percent) | | | | |
| | | Triethylene glycol | 100 | percent | — | — |
| | | (boiling point of 288 | | | | |
| | | degree C./760 mmHg, | | | | |
| | | equilibrium moisture | | | | |
| | | content of 39 | | | | |
| | | weight percent) | | | | |
| | | Ethylene glycol (boiling | 100 | percent | 9.00 | — |
| | | point of 197.3 degree | | | | |
| | | C./760 mmHg, | | | | |
| | | equilibrium moisture | | | | |
| | | content of 44 | | | | |
| | | weight percent) | | | | |
| | Other | 1,3-butane diol | 100 | percent | — | 5.00 |
| | organic | Propylene glycol | 100 | percent | — | — |
| | solvent | 3-methyl-1,3-butane | 100 | percent | — | — |
| | | diol | | | | |
| | | 1,2-butanediol | 100 | percent | — | — |
| | | 1,2-hexane diol | 100 | percent | — | — |
| | | Triethylene glycol | 100 | percent | — | — |
| | | monobutyl ether | | | | |
| | | 2-ethyl-1,3-hexanediol | 100 | percent | 2.00 | 2.00 |
| | | 2,2,4-trimethyl-1,3- | 100 | percent | | |
| | | pentanediol | | | — | — |

| | | | | |
|---|---|---|---|---|
| Compound represented by | 100 | percent | | |
| Chemical Formula I (boiling point | | | | |
| of 215.2 degrees C./760 mmHg, | | | | |
| equilibrium moisture content of | | | | |
| 42 weight percent) | | | 5.00 | 5.00 |

| | | | | | |
|---|---|---|---|---|---|
| Surfactant | TEGO Wet 270 | 100 | percent | — | — |
| | SILFACE SAG503A | 100 | percent | 0.30 | 0.30 |
| | Surfynol 104E (effective | 50.0 | percent | — | — |
| | component: 50 percent) | | | | |
| | UNIDYNE ™ | 100 | percent | — | — |
| | DSN403N | | | | |
| | EMULGEN LS-106 | 100 | percent | — | — |
| Mildew-proofing | Proxel GXL | 20.0 | percent | 0.05 | 0.05 |
| agent | | | | | |
| Foam inhibitor | 2,4,7,9- | 100 | percent | — | — |
| (defoaming agent) | tetramethyldecane- | | | | |
| | 4,7-diol | | | | |
| | 2,5,8,11- | 100 | percent | 0.20 | 0.20 |
| | tetramethyldodecane- | | | | |
| | 5,8-diol | | | | |
| pH regulator | 2-amino-2-ethyl-1,3- | 100 | percent | 0.30 | 0.30 |
| | propane diol | | | | |

| | | |
|---|---|---|
| Highly pure water | Balance | Balance |
| Total (percent by mass) | 100 | 100 |
| Proportion of organic solvent A | 27.0 | 20.0 |
| Entire of coloring material and solid content of resin | 16.3 | 23.0 |

TABLE 4

| | | | Effective | | Manufacturing | Manufacturing | Manufacturing |
|---|---|---|---|---|---|---|---|
| Component (percent by mass) | | | component | | Example 16 | Example 17 | Example 18 |
| Coloring material | | Surface-modified black | 20.0 | percent | 30.00 | — | — |
| (pigment dispersion) | | pigment dispersion, | | | | | |
| | | (Preparation Example 1, | | | | | |
| | | pigment solid content of | | | | | |
| | | 20 percent by mass) | | | | | |
| | | Surface-modified | 20.0 | percent | — | 25.00 | — |
| | | magenta pigment | | | | | |
| | | dispersion, (Preparation | | | | | |
| | | Example 2, pigment | | | | | |
| | | solid content of 20 | | | | | |
| | | percent by mass) | | | | | |
| | | Surface-modified cyan | 20.0 | percent | — | — | 25.00 |
| | | pigment dispersion, | | | | | |
| | | (Preparation Example 3, | | | | | |
| | | pigment solid content of | | | | | |
| | | 20 percent by mass) | | | | | |
| | | Surface-modified yellow | 20.0 | percent | — | — | — |
| | | pigment dispersion, | | | | | |
| | | (Preparation Example 4, | | | | | |
| | | pigment solid content of | | | | | |
| | | 20 percent by mass) | | | | | |
| | | Liquid dispersion of | 20.0 | percent | — | — | — |
| | | fine polymer particle | | | | | |
| | | containing magenta | | | | | |
| | | pigment (Preparation | | | | | |
| | | Example 5, pigment | | | | | |
| | | solid content of 15 | | | | | |
| | | percent by mass) | | | | | |
| | | Liquid dispersion of | 20.0 | percent | — | — | — |
| | | fine polymer particle | | | | | |
| | | containing cyan pigment | | | | | |
| | | (Preparation Example 6, | | | | | |
| | | pigment solid content of | | | | | |
| | | 15 percent by mass) | | | | | |
| | | Liquid dispersion of | 20.0 | percent | — | — | — |
| | | fine polymer particle | | | | | |
| | | containing yellow | | | | | |
| | | pigment (Preparation | | | | | |
| | | Example 7, pigment | | | | | |
| | | solid content of 15 | | | | | |
| | | percent by mass) | | | | | |
| | | Liquid dispersion of | 20.0 | percent | — | — | — |
| | | fine polymer particle | | | | | |
| | | containing carbon black | | | | | |
| | | pigment (Preparation | | | | | |
| | | Example 8, pigment | | | | | |
| | | solid content of 15 | | | | | |
| | | percent by mass) | | | | | |
| | | Liquid dispersion of | 54.5 | percent | — | — | — |
| | | polymer dispersion | | | | | |
| | | containing white | | | | | |
| | | pigment (Preparation | | | | | |
| | | Example 9, pigment | | | | | |
| | | solid content of 50 | | | | | |
| | | percent by mass) | | | | | |
| | | Liquid dispersion of | 52.5 | percent | — | — | — |
| | | polymer dispersion | | | | | |
| | | containing white | | | | | |
| | | pigment (AC-AW62, | | | | | |
| | | pigment solid content | | | | | |
| | | of 50 percent by | | | | | |
| | | mass, manufactured | | | | | |
| | | by Dainichiseika | | | | | |
| | | Color & Chemicals | | | | | |
| | | Mfg. Co., Ltd.) | | | | | |
| Resin | Urethane | SUPERFLEX ® 460 | 38.0 | percent | — | — | — |
| | resin | (Resin solid portion of | | | | | |
| | | 38 percent by mass, Tg | | | | | |
| | | of −21 degrees C.) | | | | | |
| | | SUPERFLEX ® 460S | 38.0 | percent | — | — | — |
| | | (Resin solid portion of | | | | | |
| | | 38 percent by mass, Tg | | | | | |
| | | of −28 degrees C.) | | | | | |
| | | SUPERFLEX ® 470 | 38.0 | percent | — | — | — |
| | | (Resin solid portion of | | | | | |
| | | 38 percent by mass, Tg | | | | | |
| | | of −31 degrees C.) | | | | | |
| | | SUPERFLEX ® 420 | 32.0 | percent | — | — | — |
| | | (Resin solid portion of | | | | | |
| | | 32 percent by mass, Tg | | | | | |
| | | of −10 degrees C.) | | | | | |
| | | TAKELAC ™ WS-6021 | 30.0 | percent | — | — | — |
| | | (Resin solid portion of | | | | | |
| | | 30 percent by mass, Tg | | | | | |
| | | of −60 degrees C.) | | | | | |
| | | TAKELAC ™ W-6110 | 33.4 | percent | 35.93 | 35.93 | 35.93 |
| | | (Resin solid portion of | | | | | |
| | | 33.4 percent by mass, Tg | | | | | |
| | | of −20 degrees C.) | | | | | |
| | | TAKELAC ™ W-6061 | 30.0 | percent | — | — | — |
| | | (Resin solid portion of | | | | | |
| | | 30 percent by mass, Tg | | | | | |
| | | of 25 degrees C.) | | | | | |
| | Acrylic | Acrylic silicone resin | 40.0 | percent | — | — | — |
| | resin | (Synthesis Example 1, | | | | | |
| | | resin solid portion of | | | | | |
| | | 40 percent by mass, Tg | | | | | |
| | | of −10 degrees C.) | | | | | |
| Organic | Organic | Glycerin (boiling point | 100 | percent | 15.00 | 15.00 | 15.00 |
| solvent | solvent A | of 290 degree C./760 | | | | | |
| | | mmHg, equilibrium | | | | | |
| | | moisture content of | | | | | |
| | | 49 weight percent) | | | | | |
| | | Diglycerin (boiling | 100 | percent | 3.00 | 5.00 | 5.00 |
| | | point of 265 to 270 | | | | | |
| | | degree C./15 mmHg, | | | | | |
| | | equilibrium moisture | | | | | |
| | | content of 38 | | | | | |
| | | weight percent) | | | | | |
| | | Tetraethylene glycol | 100 | percent | — | — | — |
| | | (boiling point of 328 | | | | | |
| | | degrees C./760 mmHg, | | | | | |
| | | equilibrium moisture | | | | | |
| | | content of 37 | | | | | |
| | | weight percent) | | | | | |
| | | Triethylene glycol | 100 | percent | — | — | — |
| | | (boiling point of 288 | | | | | |
| | | degree C./760 mmHg, | | | | | |
| | | equilibrium moisture | | | | | |
| | | content of 39 | | | | | |
| | | weight percent) | | | | | |
| | | Ethylene glycol (boiling | 100 | percent | 5.00 | 5.00 | 5.00 |
| | | point of 197.3 degree | | | | | |
| | | C./760 mmHg, | | | | | |
| | | equilibrium moisture | | | | | |
| | | content of 44 | | | | | |
| | | weight percent) | | | | | |
| | Other | 1,3-butane diol | 100 | percent | — | — | — |
| | organic | Propylene glycol | 100 | percent | — | — | — |
| | solvent | 3-methyl-1,3-butane | 100 | percent | 3.00 | 2.00 | 2.00 |
| | | diol | | | | | |
| | | 1,2-butanediol | 100 | percent | — | — | — |
| | | 1,2-hexane diol | 100 | percent | — | — | — |
| | | Triethylene glycol | 100 | percent | — | — | — |
| | | monobutyl ether | | | | | |
| | | 2-ethyl-1,3-hexanediol | 100 | percent | — | — | — |
| | | 2,2,4-trimethyl-1,3- | 100 | percent | 2.00 | 2.00 | 2.00 |
| | | pentanediol | | | | | |

| | | | | | |
|---|---|---|---|---|---|
| Compound represented by | 100 | percent | 5.00 | 6.00 | 6.00 |
| Chemical Formula I (boiling point | | | | | |
| of 215.2 degrees C./760 mmHg, | | | | | |
| equilibrium moisture content of | | | | | |
| 42 weight percent) | | | | | |

| | | | | | | |
|---|---|---|---|---|---|---|
| Surfactant | TEGO Wet 270 | 100 | percent | — | — | — |
| | SILFACE SAG503A | 100 | percent | — | — | — |
| | Surfynol 104E (effective | 50.0 | percent | 0.50 | 0.50 | 0.50 |
| | component: 50 percent) | | | | | |
| | UNIDYNE ™ | 100 | percent | — | — | — |
| | DSN403N | | | | | |
| | EMULGEN LS-106 | 100 | percent | — | — | — |
| Mildew-proofing | Proxel GXL | 20.0 | percent | 0.05 | 0.05 | 0.05 |
| agent | | | | | | |
| Foam inhibitor | 2,4,7,9- | 100 | percent | — | — | — |
| (defoaming agent) | tetramethyldecane- | | | | | |
| | 4,7-diol | | | | | |
| | 2,5,8,11- | 100 | percent | 0.30 | 0.30 | 0.30 |
| | tetramethyldodecane- | | | | | |
| | 5,8-diol | | | | | |
| pH regulator | 2-amino-2-ethyl-1,3- | 100 | percent | 0.20 | 0.20 | 0.20 |
| | propane diol | | | | | |

| | | | |
|---|---|---|---|
| Highly pure water | Balance | Balance | Balance |
| Total (percent by mass) | 100 | 100 | 100 |
| Proportion of organic solvent A | 23.0 | 25.0 | 25.0 |
| Entire of coloring material and solid content of resin | 18.0 | 17.0 | 17.0 |

| | | | Effective | | Manufacturing | Manufacturing |
|---|---|---|---|---|---|---|
| Component (percent by mass) | | | component | | Example 19 | Example 20 |
| Coloring material | | Surface-modified black | 20.0 | percent | — | — |
| (pigment dispersion) | | pigment dispersion, | | | | |
| | | (Preparation Example 1, | | | | |
| | | pigment solid content of | | | | |
| | | 20 percent by mass) | | | | |
| | | Surface-modified | 20.0 | percent | — | — |
| | | magenta pigment | | | | |
| | | dispersion, (Preparation | | | | |
| | | Example 2, pigment | | | | |
| | | solid content of 20 | | | | |
| | | percent by mass) | | | | |
| | | Surface-modified cyan | 20.0 | percent | — | — |
| | | pigment dispersion, | | | | |
| | | (Preparation Example 3, | | | | |
| | | pigment solid content of | | | | |
| | | 20 percent by mass) | | | | |
| | | Surface-modified yellow | 20.0 | percent | 25.00 | — |
| | | pigment dispersion, | | | | |
| | | (Preparation Example 4, | | | | |
| | | pigment solid content of | | | | |
| | | 20 percent by mass) | | | | |
| | | Liquid dispersion of | 20.0 | percent | — | — |
| | | fine polymer particle | | | | |
| | | containing magenta | | | | |
| | | pigment (Preparation | | | | |
| | | Example 5, pigment | | | | |
| | | solid content of 15 | | | | |
| | | percent by mass) | | | | |
| | | Liquid dispersion of | 20.0 | percent | — | — |
| | | fine polymer particle | | | | |
| | | containing cyan pigment | | | | |
| | | (Preparation Example 6, | | | | |
| | | pigment solid content of | | | | |
| | | 15 percent by mass) | | | | |
| | | Liquid dispersion of | 20.0 | percent | — | — |
| | | fine polymer particle | | | | |
| | | containing yellow | | | | |
| | | pigment (Preparation | | | | |
| | | Example 7, pigment | | | | |
| | | solid content of 15 | | | | |
| | | percent by mass) | | | | |
| | | Liquid dispersion of | 20.0 | percent | — | — |
| | | fine polymer particle | | | | |
| | | containing carbon black | | | | |
| | | pigment (Preparation | | | | |
| | | Example 8, pigment | | | | |
| | | solid content of 15 | | | | |
| | | percent by mass) | | | | |
| | | Liquid dispersion of | 54.5 | percent | — | 16.51 |
| | | polymer dispersion | | | | |
| | | containing white | | | | |
| | | pigment (Preparation | | | | |
| | | Example 9, pigment | | | | |
| | | solid content of 50 | | | | |
| | | percent by mass) | | | | |
| | | Liquid dispersion of | 52.5 | percent | — | — |
| | | polymer dispersion | | | | |
| | | containing white | | | | |
| | | pigment (AC-AW62, | | | | |
| | | pigment solid content | | | | |
| | | of 50 percent by | | | | |
| | | mass, manufactured | | | | |
| | | by Dainichiseika | | | | |
| | | Color & Chemicals | | | | |
| | | Mfg. Co., Ltd.) | | | | |
| Resin | Urethane | SUPERFLEX ® 460 | 38.0 | percent | — | — |
| | resin | (Resin solid portion of | | | | |
| | | 38 percent by mass, Tg | | | | |
| | | of −21 degrees C.) | | | | |
| | | SUPERFLEX ® 460S | 38.0 | percent | — | — |
| | | (Resin solid portion of | | | | |
| | | 38 percent by mass, Tg | | | | |
| | | of −28 degrees C.) | | | | |
| | | SUPERFLEX ® 470 | 38.0 | percent | — | — |
| | | (Resin solid portion of | | | | |
| | | 38 percent by mass, Tg | | | | |
| | | of −31 degrees C.) | | | | |
| | | SUPERFLEX ® 420 | 32.0 | percent | — | — |
| | | (Resin solid portion of | | | | |
| | | 32 percent by mass, Tg | | | | |
| | | of −10 degrees C.) | | | | |
| | | TAKELAC ™ WS-6021 | 30.0 | percent | — | — |
| | | (Resin solid portion of | | | | |
| | | 30 percent by mass, Tg | | | | |
| | | of −60 degrees C.) | | | | |
| | | TAKELAC ™ W-6110 | 33.4 | percent | 35.93 | 38.92 |
| | | (Resin solid portion of | | | | |
| | | 33.4 percent by mass, Tg | | | | |
| | | of −20 degrees C.) | | | | |
| | | TAKELAC ™ W-6061 | 30.0 | percent | — | — |
| | | (Resin solid portion of | | | | |
| | | 30 percent by mass, Tg | | | | |
| | | of 25 degrees C.) | | | | |
| | Acrylic | Acrylic silicone resin | 40.0 | percent | — | — |
| | resin | (Synthesis Example 1, | | | | |
| | | resin solid portion of | | | | |
| | | 40 percent by mass, Tg | | | | |
| | | of −10 degrees C.) | | | | |
| Organic | Organic | Glycerin (boiling point | 100 | percent | 15.00 | 15.00 |
| solvent | solvent A | of 290 degree C./760 | | | | |
| | | mmHg, equilibrium | | | | |
| | | moisture content of | | | | |
| | | 49 weight percent) | | | | |
| | | Diglycerin (boiling | 100 | percent | 5.00 | 2.00 |
| | | point of 265 to 270 | | | | |
| | | degree C./15 mmHg, | | | | |
| | | equilibrium moisture | | | | |
| | | content of 38 | | | | |
| | | weight percent) | | | | |
| | | Tetraethylene glycol | 100 | percent | — | — |
| | | (boiling point of 328 | | | | |
| | | degrees C./760 mmHg, | | | | |
| | | equilibrium moisture | | | | |
| | | content of 37 | | | | |
| | | weight percent) | | | | |
| | | Triethylene glycol | 100 | percent | — | — |
| | | (boiling point of 288 | | | | |
| | | degree C./760 mmHg, | | | | |
| | | equilibrium moisture | | | | |
| | | content of 39 | | | | |
| | | weight percent) | | | | |
| | | Ethylene glycol (boiling | 100 | percent | 5.00 | 5.00 |
| | | point of 197.3 degree | | | | |
| | | C./760 mmHg, | | | | |
| | | equilibrium moisture | | | | |
| | | content of 44 | | | | |
| | | weight percent) | | | | |
| | Other | 1,3-butane diol | 100 | percent | — | — |
| | organic | Propylene glycol | 100 | percent | — | — |
| | solvent | 3-methyl-1,3-butane | 100 | percent | 2.00 | 2.00 |
| | | diol | | | | |
| | | 1,2-butanediol | 100 | percent | — | — |
| | | 1,2-hexane diol | 100 | percent | — | — |
| | | Triethylene glycol | 100 | percent | — | — |
| | | monobutyl ether | | | | |
| | | 2-ethyl-1,3-hexanediol | 100 | percent | — | — |
| | | 2,2,4-trimethyl-1,3- | 100 | percent | 2.00 | 2.00 |
| | | pentanediol | | | | |

| | | | | |
|---|---|---|---|---|
| Compound represented by | 100 | percent | 6.00 | 5.00 |
| Chemical Formula I (boiling point | | | | |
| of 215.2 degrees C./760 mmHg, | | | | |
| equilibrium moisture content of | | | | |
| 42 weight percent) | | | | |

| | | | | | |
|---|---|---|---|---|---|
| Surfactant | TEGO Wet 270 | 100 | percent | — | — |
| | SILFACE SAG503A | 100 | percent | — | — |
| | Surfynol 104E (effective | 50.0 | percent | 0.50 | 0.50 |
| | component: 50 percent) | | | | |
| | UNIDYNE ™ | 100 | percent | — | — |
| | DSN403N | | | | |
| | EMULGEN LS-106 | 100 | percent | — | — |
| Mildew-proofing | Proxel GXL | 20.0 | percent | 0.05 | 0.05 |
| agent | | | | | |
| Foam inhibitor | 2,4,7,9- | 100 | percent | — | — |
| (defoaming agent) | tetramethyldecane- | | | | |
| | 4,7-diol | | | | |
| | 2,5,8,11- | 100 | percent | 0.30 | 0.30 |
| | tetramethyldodecane- | | | | |
| | 5,8-diol | | | | |
| pH regulator | 2-amino-2-ethyl-1,3- | 100 | percent | 0.20 | 0.20 |
| | propane diol | | | | |

| | | |
|---|---|---|
| Highly pure water | Balance | Balance |
| Total (percent by mass) | 100 | 100 |
| Proportion of organic solvent A | 25.0 | 22.0 |
| Entire of coloring material and solid content of resin | 17.0 | 22.0 |

TABLE 5

| | | | Effective | | Manufacturing | Manufacturing | Manufacturing |
|---|---|---|---|---|---|---|---|
| Component (percent by mass) | | | component | | Example 21 | Example 22 | Example 23 |
| Coloring material | | Surface-modified black | 20.0 | percent | — | — | — |
| (pigment dispersion) | | pigment dispersion, | | | | | |
| | | (Preparation Example 1, | | | | | |
| | | pigment solid content of | | | | | |
| | | 20 percent by mass) | | | | | |
| | | Surface-modified | 20.0 | percent | — | — | — |
| | | magenta pigment | | | | | |
| | | dispersion, (Preparation | | | | | |
| | | Example 2, pigment | | | | | |
| | | solid content of 20 | | | | | |
| | | percent by mass) | | | | | |
| | | Surface-modified cyan | 20.0 | percent | — | — | — |
| | | pigment dispersion, | | | | | |
| | | (Preparation Example 3, | | | | | |
| | | pigment solid content of | | | | | |
| | | 20 percent by mass) | | | | | |
| | | Surface-modified yellow | 20.0 | percent | — | — | — |
| | | pigment dispersion, | | | | | |
| | | (Preparation Example 4, | | | | | |
| | | pigment solid content of | | | | | |
| | | 20 percent by mass) | | | | | |
| | | Liquid dispersion of | 20.0 | percent | 26.67 | — | — |
| | | fine polymer particle | | | | | |
| | | containing magenta | | | | | |
| | | pigment (Preparation | | | | | |
| | | Example 5, pigment | | | | | |
| | | solid content of 15 | | | | | |
| | | percent by mass) | | | | | |
| | | Liquid dispersion of | 20.0 | percent | — | 26.67 | — |
| | | fine polymer particle | | | | | |
| | | containing cyan pigment | | | | | |
| | | (Preparation Example 6, | | | | | |
| | | pigment solid content of | | | | | |
| | | 15 percent by mass) | | | | | |
| | | Liquid dispersion of | 20.0 | percent | — | — | 26.67 |
| | | fine polymer particle | | | | | |
| | | containing yellow | | | | | |
| | | pigment (Preparation | | | | | |
| | | Example 7, pigment | | | | | |
| | | solid content of 15 | | | | | |
| | | percent by mass) | | | | | |
| | | Liquid dispersion of | 20.0 | percent | — | — | — |
| | | fine polymer particle | | | | | |
| | | containing carbon black | | | | | |
| | | pigment (Preparation | | | | | |
| | | Example 8, pigment | | | | | |
| | | solid content of 15 | | | | | |
| | | percent by mass) | | | | | |
| | | Liquid dispersion of | 54.5 | percent | — | — | — |
| | | polymer dispersion | | | | | |
| | | containing white | | | | | |
| | | pigment (Preparation | | | | | |
| | | Example 9, pigment | | | | | |
| | | solid content of 50 | | | | | |
| | | percent by mass) | | | | | |
| | | Liquid dispersion of | 52.5 | percent | — | — | — |
| | | polymer dispersion | | | | | |
| | | containing white | | | | | |
| | | pigment (AC-AW62, | | | | | |
| | | pigment solid content | | | | | |
| | | of 50 percent by | | | | | |
| | | mass, manufactured | | | | | |
| | | by Dainichiseika | | | | | |
| | | Color & Chemicals | | | | | |
| | | Mfg. Co., Ltd.) | | | | | |
| Resin | Urethane | SUPERFLEX ® 460 | 38.0 | percent | — | — | — |
| | resin | (Resin solid portion of | | | | | |
| | | 38 percent by mass, Tg | | | | | |
| | | of −21 degrees C.) | | | | | |
| | | SUPERFLEX ® 460S | 38.0 | percent | — | — | — |
| | | (Resin solid portion of | | | | | |
| | | 38 percent by mass, Tg | | | | | |
| | | of −28 degrees C.) | | | | | |
| | | SUPERFLEX ® 470 | 38.0 | percent | 5.26 | 5.26 | 5.26 |
| | | (Resin solid portion of | | | | | |
| | | 38 percent by mass, Tg | | | | | |
| | | of −31 degrees C.) | | | | | |
| | | SUPERFLEX ® 420 | 32.0 | percent | — | — | — |
| | | (Resin solid portion of | | | | | |
| | | 32 percent by mass, Tg | | | | | |
| | | of −10 degrees C.) | | | | | |
| | | TAKELAC ™ WS-6021 | 30.0 | percent | — | — | — |
| | | (Resin solid portion of | | | | | |
| | | 30 percent by mass, Tg | | | | | |
| | | of −60 degrees C.) | | | | | |
| | | TAKELAC ™ W-6110 | 33.4 | percent | — | — | — |
| | | (Resin solid portion of | | | | | |
| | | 33.4 percent by mass, Tg | | | | | |
| | | of −20 degrees C.) | | | | | |
| | | TAKELAC ™ W-6061 | 30.0 | percent | — | — | — |
| | | (Resin solid portion of | | | | | |
| | | 30 percent by mass, Tg | | | | | |
| | | of 25 degrees C.) | | | | | |
| | Acrylic | Acrylic silicone resin | 40.0 | percent | 25.00 | 25.00 | 25.00 |
| | resin | (Synthesis Example 1, | | | | | |
| | | resin solid portion of | | | | | |
| | | 40 percent by mass, Tg | | | | | |
| | | of −10 degrees C.) | | | | | |
| Organic | Organic | Glycerin (boiling point | 100 | percent | 15.00 | 15.00 | 15.00 |
| solvent | solvent A | of 290 degree C./760 | | | | | |
| | | mmHg, equilibrium | | | | | |
| | | moisture content of | | | | | |
| | | 49 weight percent) | | | | | |
| | | Diglycerin (boiling | 100 | percent | — | — | — |
| | | point of 265 to 270 | | | | | |
| | | degree C./15 mmHg, | | | | | |
| | | equilibrium moisture | | | | | |
| | | content of 38 | | | | | |
| | | weight percent) | | | | | |
| | | Tetraethylene glycol | 100 | percent | — | — | — |
| | | (boiling point of 328 | | | | | |
| | | degrees C./760 mmHg, | | | | | |
| | | equilibrium moisture | | | | | |
| | | content of 37 | | | | | |
| | | weight percent) | | | | | |
| | | Triethylene glycol | 100 | percent | — | — | — |
| | | (boiling point of 288 | | | | | |
| | | degree C./760 mmHg, | | | | | |
| | | equilibrium moisture | | | | | |
| | | content of 39 | | | | | |
| | | weight percent) | | | | | |
| | | Ethylene glycol (boiling | 100 | percent | 10.00 | 10.00 | 10.00 |
| | | point of 197.3 degree | | | | | |
| | | C./760 mmHg, | | | | | |
| | | equilibrium moisture | | | | | |
| | | content of 44 | | | | | |
| | | weight percent) | | | | | |
| | Other | 1,3-butane diol | 100 | percent | — | — | — |
| | organic | Propylene glycol | 100 | percent | — | — | — |
| | solvent | 3-methyl-1,3-butane | 100 | percent | — | — | — |
| | | diol | | | | | |
| | | 1,2-butanediol | 100 | percent | 5.00 | 5.00 | 5.00 |
| | | 1,2-hexane diol | 100 | percent | — | — | — |
| | | Triethylene glycol | 100 | percent | — | — | — |
| | | monobutyl ether | | | | | |
| | | 2-ethyl-1,3-hexanediol | 100 | percent | — | — | — |
| | | 2,2,4-trimethyl-1,3- | 100 | percent | — | — | — |
| | | pentanediol | | | | | |

| | | | | | |
|---|---|---|---|---|---|
| Compound represented by | 100 | percent | 5.00 | 5.00 | 5.00 |
| Chemical Formula I (boiling point | | | | | |
| of 215.2 degrees C./760 mmHg, | | | | | |
| equilibrium moisture content of | | | | | |
| 42 weight percent) | | | | | |

| | | | | | | |
|---|---|---|---|---|---|---|
| Surfactant | TEGO Wet 270 | 100 | percent | — | — | — |
| | SILFACE SAG503A | 100 | percent | — | — | — |
| | Surfynol 104E (effective | 50.0 | percent | — | — | — |
| | component: 50 percent) | | | | | |
| | UNIDYNE ™ | 100 | percent | 0.06 | 0.06 | 0.06 |
| | DSN403N | | | | | |
| | EMULGEN LS-106 | 100 | percent | — | — | — |
| Mildew-proofing | Proxel GXL | 20.0 | percent | — | — | — |
| agent | | | | | | |
| Foam inhibitor | 2,4,7,9- | 100 | percent | — | — | — |
| (defoaming agent) | tetramethyldecane- | | | | | |
| | 4,7-diol | | | | | |
| | 2,5,8,11- | 100 | percent | 0.30 | 0.30 | 0.30 |
| | tetramethyldodecane- | | | | | |
| | 5,8-diol | | | | | |
| pH regulator | 2-amino-2-ethyl-1,3- | 100 | percent | 0.30 | 0.30 | 0.30 |
| | propane diol | | | | | |

| | | | |
|---|---|---|---|
| Highly pure water | Balance | Balance | Balance |
| Total (percent by mass) | 100 | 100 | 100 |
| Proportion of organic solvent A | 25.0 | 25.0 | 25.0 |
| Entire of coloring material and solid content of resin | 17.3 | 17.3 | 17.3 |

| | | | Effective | | Manufacturing | Manufacturing |
|---|---|---|---|---|---|---|
| Component (percent by mass) | | | component | | Example 24 | Example 25 |
| Coloring material | | Surface-modified black | 20.0 | percent | — | — |
| (pigment dispersion) | | pigment dispersion, | | | | |
| | | (Preparation Example 1, | | | | |
| | | pigment solid content of | | | | |
| | | 20 percent by mass) | | | | |
| | | Surface-modified | 20.0 | percent | — | — |
| | | magenta pigment | | | | |
| | | dispersion, (Preparation | | | | |
| | | Example 2, pigment | | | | |
| | | solid content of 20 | | | | |
| | | percent by mass) | | | | |
| | | Surface-modified cyan | 20.0 | percent | — | — |
| | | pigment dispersion, | | | | |
| | | (Preparation Example 3, | | | | |
| | | pigment solid content of | | | | |
| | | 20 percent by mass) | | | | |
| | | Surface-modified yellow | 20.0 | percent | — | — |
| | | pigment dispersion, | | | | |
| | | (Preparation Example 4, | | | | |
| | | pigment solid content of | | | | |
| | | 20 percent by mass) | | | | |
| | | Liquid dispersion of | 20.0 | percent | — | — |
| | | fine polymer particle | | | | |
| | | containing magenta | | | | |
| | | pigment (Preparation | | | | |
| | | Example 5, pigment | | | | |
| | | solid content of 15 | | | | |
| | | percent by mass) | | | | |
| | | Liquid dispersion of | 20.0 | percent | — | — |
| | | fine polymer particle | | | | |
| | | containing cyan pigment | | | | |
| | | (Preparation Example 6, | | | | |
| | | pigment solid content of | | | | |
| | | 15 percent by mass) | | | | |
| | | Liquid dispersion of | 20.0 | percent | — | — |
| | | fine polymer particle | | | | |
| | | containing yellow | | | | |
| | | pigment (Preparation | | | | |
| | | Example 7, pigment | | | | |
| | | solid content of 15 | | | | |
| | | percent by mass) | | | | |
| | | Liquid dispersion of | 20.0 | percent | 33.33 | — |
| | | fine polymer particle | | | | |
| | | containing carbon black | | | | |
| | | pigment (Preparation | | | | |
| | | Example 8, pigment | | | | |
| | | solid content of 15 | | | | |
| | | percent by mass) | | | | |
| | | Liquid dispersion of | 54.5 | percent | — | — |
| | | polymer dispersion | | | | |
| | | containing white | | | | |
| | | pigment (Preparation | | | | |
| | | Example 9, pigment | | | | |
| | | solid content of 50 | | | | |
| | | percent by mass) | | | | |
| | | Liquid dispersion of | 52.5 | percent | — | 20.00 |
| | | polymer dispersion | | | | |
| | | containing white | | | | |
| | | pigment (AC-AW62, | | | | |
| | | pigment solid content | | | | |
| | | of 50 percent by | | | | |
| | | mass, manufactured | | | | |
| | | by Dainichiseika | | | | |
| | | Color & Chemicals | | | | |
| | | Mfg. Co., Ltd.) | | | | |
| Resin | Urethane | SUPERFLEX ® 460 | 38.0 | percent | — | — |
| | resin | (Resin solid portion of | | | | |
| | | 38 percent by mass, Tg | | | | |
| | | of −21 degrees C.) | | | | |
| | | SUPERFLEX ® 460S | 38.0 | percent | — | — |
| | | (Resin solid portion of | | | | |
| | | 38 percent by mass, Tg | | | | |
| | | of −28 degrees C.) | | | | |
| | | SUPERFLEX ® 470 | 38.0 | percent | 5.26 | 5.26 |
| | | (Resin solid portion of | | | | |
| | | 38 percent by mass, Tg | | | | |
| | | of −31 degrees C.) | | | | |
| | | SUPERFLEX ® 420 | 32.0 | percent | — | — |
| | | (Resin solid portion of | | | | |
| | | 32 percent by mass, Tg | | | | |
| | | of −10 degrees C.) | | | | |
| | | TAKELAC ™ WS-6021 | 30.0 | percent | — | — |
| | | (Resin solid portion of | | | | |
| | | 30 percent by mass, Tg | | | | |
| | | of −60 degrees C.) | | | | |
| | | TAKELAC ™ W-6110 | 33.4 | percent | — | — |
| | | (Resin solid portion of | | | | |
| | | 33.4 percent by mass, Tg | | | | |
| | | of −20 degrees C.) | | | | |
| | | TAKELAC ™ W-6061 | 30.0 | percent | — | — |
| | | (Resin solid portion of | | | | |
| | | 30 percent by mass, Tg | | | | |
| | | of 25 degrees C.) | | | | |
| | Acrylic | Acrylic silicone resin | 40.0 | percent | 25.00 | 25.00 |
| | resin | (Synthesis Example 1, | | | | |
| | | resin solid portion of | | | | |
| | | 40 percent by mass, Tg | | | | |
| | | of −10 degrees C.) | | | | |
| Organic | Organic | Glycerin (boiling point | 100 | percent | 13.00 | 10.00 |
| solvent | solvent A | of 290 degree C./760 | | | | |
| | | mmHg, equilibrium | | | | |
| | | moisture content of | | | | |
| | | 49 weight percent) | | | | |
| | | Diglycerin (boiling | 100 | percent | — | — |
| | | point of 265 to 270 | | | | |
| | | degree C./15 mmHg, | | | | |
| | | equilibrium moisture | | | | |
| | | content of 38 | | | | |
| | | weight percent) | | | | |
| | | Tetraethylene glycol | 100 | percent | — | — |
| | | (boiling point of 328 | | | | |
| | | degrees C./760 mmHg, | | | | |
| | | equilibrium moisture | | | | |
| | | content of 37 | | | | |
| | | weight percent) | | | | |
| | | Triethylene glycol | 100 | percent | — | — |
| | | (boiling point of 288 | | | | |
| | | degree C./760 mmHg, | | | | |
| | | equilibrium moisture | | | | |
| | | content of 39 | | | | |
| | | weight percent) | | | | |
| | | Ethylene glycol (boiling | 100 | percent | 10.00 | 10.00 |
| | | point of 197.3 degree | | | | |
| | | C./760 mmHg, | | | | |
| | | equilibrium moisture | | | | |
| | | content of 44 | | | | |
| | | weight percent) | | | | |
| | Other | 1,3-butane diol | 100 | percent | — | — |
| | organic | Propylene glycol | 100 | percent | — | — |
| | solvent | 3-methyl-1,3-butane | 100 | percent | — | — |
| | | diol | | | | |
| | | 1,2-butanediol | 100 | percent | 5.00 | 5.00 |
| | | 1,2-hexane diol | 100 | percent | — | — |
| | | Triethylene glycol | 100 | percent | — | — |
| | | monobutyl ether | | | | |
| | | 2-ethyl-1,3-hexanediol | 100 | percent | — | — |
| | | 2,2,4-trimethyl-1,3- | 100 | percent | — | — |
| | | pentanediol | | | | |

| | | | | |
|---|---|---|---|---|
| Compound represented by | 100 | percent | 5.00 | 5.00 |
| Chemical Formula I (boiling point | | | | |
| of 215.2 degrees C./760 mmHg, | | | | |
| equilibrium moisture content of | | | | |
| 42 weight percent) | | | | |

| | | | | | |
|---|---|---|---|---|---|
| Surfactant | TEGO Wet 270 | 100 | percent | — | — |
| | SILFACE SAG503A | 100 | percent | — | — |
| | Surfynol 104E (effective | 50.0 | percent | — | — |
| | component: 50 percent) | | | | |
| | UNIDYNE ™ | 100 | percent | 0.06 | 0.06 |
| | DSN403N | | | | |
| | EMULGEN LS-106 | 100 | percent | — | — |
| Mildew-proofing | Proxel GXL | 20.0 | percent | — | — |
| agent | | | | | |
| Foam inhibitor | 2,4,7,9- | 100 | percent | — | — |
| (defoaming agent) | tetramethyldecane- | | | | |
| | 4,7-diol | | | | |
| | 2,5,8,11- | 100 | percent | 0.30 | 0.30 |
| | tetramethyldodecane- | | | | |
| | 5,8-diol | | | | |
| pH regulator | 2-amino-2-ethyl-1,3- | 100 | percent | 0.30 | 0.30 |
| | propane diol | | | | |

| | | |
|---|---|---|
| Highly pure water | Balance | Balance |
| Total (percent by mass) | 100 | 100 |
| Proportion of organic solvent A | 23.0 | 20.0 |
| Entire of coloring material and solid content of resin | 18.7 | 22.5 |

TABLE 6

| | | | Effective | | Manufacturing | Manufacturing | Manufacturing |
|---|---|---|---|---|---|---|---|
| Component (percent by mass) | | | component | | Example 26 | Example 27 | Example 28 |
| Coloring material | | Surface-modified black | 20.0 | percent | — | — | — |
| (pigment dispersion) | | pigment dispersion, | | | | | |
| | | (Preparation Example 1, | | | | | |
| | | pigment solid content of | | | | | |
| | | 20 percent by mass) | | | | | |
| | | Surface-modified | 20.0 | percent | — | — | — |
| | | magenta pigment | | | | | |
| | | dispersion, (Preparation | | | | | |
| | | Example 2, pigment | | | | | |
| | | solid content of 20 | | | | | |
| | | percent by mass) | | | | | |
| | | Surface-modified cyan | 20.0 | percent | — | — | — |
| | | pigment dispersion, | | | | | |
| | | (Preparation Example 3, | | | | | |
| | | pigment solid content of | | | | | |
| | | 20 percent by mass) | | | | | |
| | | Surface-modified yellow | 20.0 | percent | — | — | — |
| | | pigment dispersion, | | | | | |
| | | (Preparation Example 4, | | | | | |
| | | pigment solid content of | | | | | |
| | | 20 percent by mass) | | | | | |
| | | Liquid dispersion of | 20.0 | percent | 33.33 | — | — |
| | | fine polymer particle | | | | | |
| | | containing magenta | | | | | |
| | | pigment (Preparation | | | | | |
| | | Example 5, pigment | | | | | |
| | | solid content of 15 | | | | | |
| | | percent by mass) | | | | | |
| | | Liquid dispersion of | 20.0 | percent | — | 26.67 | — |
| | | fine polymer particle | | | | | |
| | | containing cyan pigment | | | | | |
| | | (Preparation Example 6, | | | | | |
| | | pigment solid content of | | | | | |
| | | 15 percent by mass) | | | | | |
| | | Liquid dispersion of | 20.0 | percent | — | — | 26.67 |
| | | fine polymer particle | | | | | |
| | | containing yellow | | | | | |
| | | pigment (Preparation | | | | | |
| | | Example 7, pigment | | | | | |
| | | solid content of 15 | | | | | |
| | | percent by mass) | | | | | |
| | | Liquid dispersion of | 20.0 | percent | — | — | — |
| | | fine polymer particle | | | | | |
| | | containing carbon black | | | | | |
| | | pigment (Preparation | | | | | |
| | | Example 8, pigment | | | | | |
| | | solid content of 15 | | | | | |
| | | percent by mass) | | | | | |
| | | Liquid dispersion of | 54.5 | percent | — | — | — |
| | | polymer dispersion | | | | | |
| | | containing white | | | | | |
| | | pigment (Preparation | | | | | |
| | | Example 9, pigment | | | | | |
| | | solid content of 50 | | | | | |
| | | percent by mass) | | | | | |
| | | Liquid dispersion of | 52.5 | percent | — | — | — |
| | | polymer dispersion | | | | | |
| | | containing white | | | | | |
| | | pigment (AC-AW62, | | | | | |
| | | pigment solid content | | | | | |
| | | of 50 percent by | | | | | |
| | | mass, manufactured | | | | | |
| | | by Dainichiseika | | | | | |
| | | Color & Chemicals | | | | | |
| | | Mfg. Co., Ltd.) | | | | | |
| Resin | Urethane | SUPERFLEX ® 460 | 38.0 | percent | — | — | — |
| | resin | (Resin solid portion of | | | | | |
| | | 38 percent by mass, Tg | | | | | |
| | | of −21 degrees C.) | | | | | |
| | | SUPERFLEX ® 460S | 38.0 | percent | — | — | — |
| | | (Resin solid portion of | | | | | |
| | | 38 percent by mass, Tg | | | | | |
| | | of −28 degrees C.) | | | | | |
| | | SUPERFLEX ® 470 | 38.0 | percent | 15.79 | 15.79 | 15.79 |
| | | (Resin solid portion of | | | | | |
| | | 38 percent by mass, Tg | | | | | |
| | | of −31 degrees C.) | | | | | |
| | | SUPERFLEX ® 420 | 32.0 | percent | — | — | — |
| | | (Resin solid portion of | | | | | |
| | | 32 percent by mass, Tg | | | | | |
| | | of −10 degrees C.) | | | | | |
| | | TAKELAC ™ WS-6021 | 30.0 | percent | 10.00 | 10.00 | 10.00 |
| | | (Resin solid portion of | | | | | |
| | | 30 percent by mass, Tg | | | | | |
| | | of −60 degrees C.) | | | | | |
| | | TAKELAC ™ W-6110 | 33.4 | percent | — | — | — |
| | | (Resin solid portion of | | | | | |
| | | 33.4 percent by mass, Tg | | | | | |
| | | of −20 degrees C.) | | | | | |
| | | TAKELAC ™ W-6061 | 30.0 | percent | 7.50 | 7.50 | 7.50 |
| | | (Resin solid portion of | | | | | |
| | | 30 percent by mass, Tg | | | | | |
| | | of 25 degrees C.) | | | | | |
| | Acrylic | Acrylic silicone resin | 40.0 | percent | — | — | — |
| | resin | (Synthesis Example 1, | | | | | |
| | | resin solid portion of | | | | | |
| | | 40 percent by mass, Tg | | | | | |
| | | of −10 degrees C.) | | | | | |
| Organic | Organic | Glycerin (boiling point | 100 | percent | 19.00 | 23.00 | 23.00 |
| solvent | solvent A | of 290 degree C./760 | | | | | |
| | | mmHg, equilibrium | | | | | |
| | | moisture content of | | | | | |
| | | 49 weight percent) | | | | | |
| | | Diglycerin (boiling | 100 | percent | 1.00 | 1.00 | 1.00 |
| | | point of 265 to 270 | | | | | |
| | | degree C./15 mmHg, | | | | | |
| | | equilibrium moisture | | | | | |
| | | content of 38 | | | | | |
| | | weight percent) | | | | | |
| | | Tetraethylene glycol | 100 | percent | — | — | — |
| | | (boiling point of 328 | | | | | |
| | | degrees C./760 mmHg, | | | | | |
| | | equilibrium moisture | | | | | |
| | | content of 37 | | | | | |
| | | weight percent) | | | | | |
| | | Triethylene glycol | 100 | percent | — | — | — |
| | | (boiling point of 288 | | | | | |
| | | degree C./760 mmHg, | | | | | |
| | | equilibrium moisture | | | | | |
| | | content of 39 | | | | | |
| | | weight percent) | | | | | |
| | | Ethylene glycol (boiling | 100 | percent | — | — | — |
| | | point of 197.3 degree | | | | | |
| | | C./760 mmHg, | | | | | |
| | | equilibrium moisture | | | | | |
| | | content of 44 | | | | | |
| | | weight percent) | | | | | |
| | Other | 1,3-butane diol | 100 | percent | — | — | — |
| | organic | Propylene glycol | 100 | percent | 5.00 | 6.00 | 6.00 |
| | solvent | 3-methyl-1,3-butane | 100 | percent | | | |
| | | diol | | | | | |
| | | 1,2-butanediol | 100 | percent | | | |
| | | 1,2-hexane diol | 100 | percent | — | — | — |
| | | Triethylene glycol | 100 | percent | 2.00 | 2.00 | 2.00 |
| | | monobutyl ether | | | | | |
| | | 2-ethyl-1,3-hexanediol | 100 | percent | — | — | — |
| | | 2,2,4-trimethyl-1,3- | 100 | percent | — | — | — |
| | | pentanediol | | | | | |

| | | | | | |
|---|---|---|---|---|---|
| Compound represented by | 100 | percent | 5.00 | 5.00 | 5.00 |
| Chemical Formula I (boiling point | | | | | |
| of 215.2 degrees C./760 mmHg, | | | | | |
| equilibrium moisture content of | | | | | |
| 42 weight percent) | | | | | |

| | | | | | | |
|---|---|---|---|---|---|---|
| Surfactant | TEGO Wet 270 | 100 | percent | — | — | — |
| | SILFACE SAG503A | 100 | percent | 0.30 | 0.30 | 0.30 |
| | Surfynol 104E (effective | 50.0 | percent | — | — | — |
| | component: 50 percent) | | | | | |
| | UNIDYNE ™ | 100 | percent | — | — | — |
| | DSN403N | | | | | |
| | EMULGEN LS-106 | 100 | percent | — | — | — |
| Mildew-proofing | Proxel GXL | 20.0 | percent | 0.05 | 0.05 | 0.05 |
| agent | | | | | | |
| Foam inhibitor | 2,4,7,9- | 100 | percent | 0.20 | 0.20 | 0.20 |
| (defoaming agent) | tetramethyldecane- | | | | | |
| | 4,7-diol | | | | | |
| | 2,5,8,11- | 100 | percent | — | — | — |
| | tetramethyldodecane- | | | | | |
| | 5,8-diol | | | | | |
| pH regulator | 2-amino-2-ethyl-1,3- | 100 | percent | 0.20 | 0.20 | 0.20 |
| | propane diol | | | | | |

| | | | |
|---|---|---|---|
| Highly pure water | Balance | Balance | Balance |
| Total (percent by mass) | 100 | 100 | 100 |
| Proportion of organic solvent A | 20.0 | 24.0 | 24.0 |
| Entire of coloring material and solid content of resin | 17.9 | 16.6 | 16.6 |

| | | | Effective | | Manufacturing | Manufacturing |
|---|---|---|---|---|---|---|
| Component (percent by mass) | | | component | | Example 29 | Example 30 |
| Coloring material | | Surface-modified black | 20.0 | percent | — | — |
| (pigment dispersion) | | pigment dispersion, | | | | |
| | | (Preparation Example 1, | | | | |
| | | pigment solid content of | | | | |
| | | 20 percent by mass) | | | | |
| | | Surface-modified | 20.0 | percent | — | — |
| | | magenta pigment | | | | |
| | | dispersion, (Preparation | | | | |
| | | Example 2, pigment | | | | |
| | | solid content of 20 | | | | |
| | | percent by mass) | | | | |
| | | Surface-modified cyan | 20.0 | percent | — | — |
| | | pigment dispersion, | | | | |
| | | (Preparation Example 3, | | | | |
| | | pigment solid content of | | | | |
| | | 20 percent by mass) | | | | |
| | | Surface-modified yellow | 20.0 | percent | — | — |
| | | pigment dispersion, | | | | |
| | | (Preparation Example 4, | | | | |
| | | pigment solid content of | | | | |
| | | 20 percent by mass) | | | | |
| | | Liquid dispersion of | 20.0 | percent | — | — |
| | | fine polymer particle | | | | |
| | | containing magenta | | | | |
| | | pigment (Preparation | | | | |
| | | Example 5, pigment | | | | |
| | | solid content of 15 | | | | |
| | | percent by mass) | | | | |
| | | Liquid dispersion of | 20.0 | percent | — | — |
| | | fine polymer particle | | | | |
| | | containing cyan pigment | | | | |
| | | (Preparation Example 6, | | | | |
| | | pigment solid content of | | | | |
| | | 15 percent by mass) | | | | |
| | | Liquid dispersion of | 20.0 | percent | — | — |
| | | fine polymer particle | | | | |
| | | containing yellow | | | | |
| | | pigment (Preparation | | | | |
| | | Example 7, pigment | | | | |
| | | solid content of 15 | | | | |
| | | percent by mass) | | | | |
| | | Liquid dispersion of | 20.0 | percent | 33.33 | — |
| | | fine polymer particle | | | | |
| | | containing carbon black | | | | |
| | | pigment (Preparation | | | | |
| | | Example 8, pigment | | | | |
| | | solid content of 15 | | | | |
| | | percent by mass) | | | | |
| | | Liquid dispersion of | 54.5 | percent | — | — |
| | | polymer dispersion | | | | |
| | | containing white | | | | |
| | | pigment (Preparation | | | | |
| | | Example 9, pigment | | | | |
| | | solid content of 50 | | | | |
| | | percent by mass) | | | | |
| | | Liquid dispersion of | 52.5 | percent | — | 20.00 |
| | | polymer dispersion | | | | |
| | | containing white | | | | |
| | | pigment (AC-AW62, | | | | |
| | | pigment solid content | | | | |
| | | of 50 percent by | | | | |
| | | mass, manufactured | | | | |
| | | by Dainichiseika | | | | |
| | | Color & Chemicals | | | | |
| | | Mfg. Co., Ltd.) | | | | |
| Resin | Urethane | SUPERFLEX ® 460 | 38.0 | percent | — | — |
| | resin | (Resin solid portion of | | | | |
| | | 38 percent by mass, Tg | | | | |
| | | of −21 degrees C.) | | | | |
| | | SUPERFLEX ® 460S | 38.0 | percent | — | — |
| | | (Resin solid portion of | | | | |
| | | 38 percent by mass, Tg | | | | |
| | | of −28 degrees C.) | | | | |
| | | SUPERFLEX ® 470 | 38.0 | percent | 15.79 | 15.79 |
| | | (Resin solid portion of | | | | |
| | | 38 percent by mass, Tg | | | | |
| | | of −31 degrees C.) | | | | |
| | | SUPERFLEX ® 420 | 32.0 | percent | — | — |
| | | (Resin solid portion of | | | | |
| | | 32 percent by mass, Tg | | | | |
| | | of −10 degrees C.) | | | | |
| | | TAKELAC ™ WS-6021 | 30.0 | percent | 10.00 | 10.00 |
| | | (Resin solid portion of | | | | |
| | | 30 percent by mass, Tg | | | | |
| | | of −60 degrees C.) | | | | |
| | | TAKELAC ™ W-6110 | 33.4 | percent | — | — |
| | | (Resin solid portion of | | | | |
| | | 33.4 percent by mass, Tg | | | | |
| | | of −20 degrees C.) | | | | |
| | | TAKELAC ™ W-6061 | 30.0 | percent | 7.50 | 7.50 |
| | | (Resin solid portion of | | | | |
| | | 30 percent by mass, Tg | | | | |
| | | of 25 degrees C.) | | | | |
| | Acrylic | Acrylic silicone resin | 40.0 | percent | — | — |
| | resin | (Synthesis Example 1, | | | | |
| | | resin solid portion of | | | | |
| | | 40 percent by mass, Tg | | | | |
| | | of −10 degrees C.) | | | | |
| Organic | Organic | Glycerin (boiling point | 100 | percent | 19.00 | 19.00 |
| solvent | solvent A | of 290 degree C./760 | | | | |
| | | mmHg, equilibrium | | | | |
| | | moisture content of | | | | |
| | | 49 weight percent) | | | | |
| | | Diglycerin (boiling | 100 | percent | 1.00 | 1.00 |
| | | point of 265 to 270 | | | | |
| | | degree C./15 mmHg, | | | | |
| | | equilibrium moisture | | | | |
| | | content of 38 | | | | |
| | | weight percent) | | | | |
| | | Tetraethylene glycol | 100 | percent | — | — |
| | | (boiling point of 328 | | | | |
| | | degrees C./760 mmHg, | | | | |
| | | equilibrium moisture | | | | |
| | | content of 37 | | | | |
| | | weight percent) | | | | |
| | | Triethylene glycol | 100 | percent | — | — |
| | | (boiling point of 288 | | | | |
| | | degree C./760 mmHg, | | | | |
| | | equilibrium moisture | | | | |
| | | content of 39 | | | | |
| | | weight percent) | | | | |
| | | Ethylene glycol (boiling | 100 | percent | — | — |
| | | point of 197.3 degree | | | | |
| | | C./760 mmHg, | | | | |
| | | equilibrium moisture | | | | |
| | | content of 44 | | | | |
| | | weight percent) | | | | |
| | Other | 1,3-butane diol | 100 | percent | — | — |
| | organic | Propylene glycol | 100 | percent | 5.00 | 4.00 |
| | solvent | 3-methyl-1,3-butane | 100 | percent | | |
| | | diol | | | | |
| | | 1,2-butanediol | 100 | percent | | |
| | | 1,2-hexane diol | 100 | percent | — | — |
| | | Triethylene glycol | 100 | percent | 2.00 | 2.00 |
| | | monobutyl ether | | | | |
| | | 2-ethyl-1,3-hexanediol | 100 | percent | — | — |
| | | 2,2,4-trimethyl-1,3- | 100 | percent | — | — |
| | | pentanediol | | | | |

| | | | | |
|---|---|---|---|---|
| Compound represented by | 100 | percent | 5.00 | 5.00 |
| Chemical Formula I (boiling point | | | | |
| of 215.2 degrees C./760 mmHg, | | | | |
| equilibrium moisture content of | | | | |
| 42 weight percent) | | | | |

| | | | | | |
|---|---|---|---|---|---|
| Surfactant | TEGO Wet 270 | 100 | percent | — | — |
| | SILFACE SAG503A | 100 | percent | 0.30 | 0.50 |
| | Surfynol 104E (effective | 50.0 | percent | — | — |
| | component: 50 percent) | | | | |
| | UNIDYNE ™ | 100 | percent | — | — |
| | DSN403N | | | | |
| | EMULGEN LS-106 | 100 | percent | — | — |
| Mildew-proofing | Proxel GXL | 20.0 | percent | 0.05 | 0.05 |
| agent | | | | | |
| Foam inhibitor | 2,4,7,9- | 100 | percent | 0.20 | 0.20 |
| (defoaming agent) | tetramethyldecane- | | | | |
| | 4,7-diol | | | | |
| | 2,5,8,11- | 100 | percent | — | — |
| | tetramethyldodecane- | | | | |
| | 5,8-diol | | | | |
| pH regulator | 2-amino-2-ethyl-1,3- | 100 | percent | 0.25 | 0.20 |
| | propane diol | | | | |

| | | |
|---|---|---|
| Highly pure water | Balance | Balance |
| Total (percent by mass) | 100 | 100 |
| Proportion of organic solvent A | 20.0 | 20.0 |
| Entire of coloring material and solid content of resin | 17.9 | 21.7 |

TABLE 7

| | | | Effective | Manufacturing | Manufacturing | Manufacturing | Manufacturing | Manufacturing |
|---|---|---|---|---|---|---|---|---|
| Component (percent by mass) | | | component | Example 31 | Example 32 | Example 33 | Example 34 | Example 35 |
| Coloring material | | Surface-modified | 20.0 | — | — | — | — | — |
| (pigment dispersion) | | black pigment | percent | | | | | |
| | | dispersion, | | | | | | |
| | | (Preparation | | | | | | |
| | | Example 1, pigment | | | | | | |
| | | solid content of 20 | | | | | | |
| | | percent by mass) | | | | | | |
| | | Surface-modified | 20.0 | — | — | — | — | — |
| | | magenta pigment | percent | | | | | |
| | | dispersion, | | | | | | |
| | | (Preparation | | | | | | |
| | | Example 2, pigment | | | | | | |
| | | solid content of 20 | | | | | | |
| | | percent by mass) | | | | | | |
| | | Surface-modified | 20.0 | — | — | — | — | — |
| | | cyan pigment | percent | | | | | |
| | | dispersion, | | | | | | |
| | | (Preparation | | | | | | |
| | | Example 3, pigment | | | | | | |
| | | solid content of 20 | | | | | | |
| | | percent by mass) | | | | | | |
| | | Surface-modified | 20.0 | — | — | — | — | — |
| | | yellow pigment | percent | | | | | |
| | | dispersion, | | | | | | |
| | | (Preparation | | | | | | |
| | | Example 4, pigment | | | | | | |
| | | solid content of 20 | | | | | | |
| | | percent by mass) | | | | | | |
| | | Liquid dispersion of | 20.0 | 26.67 | — | — | — | — |
| | | fine polymer particle | percent | | | | | |
| | | containing magenta | | | | | | |
| | | pigment (Preparation | | | | | | |
| | | Example 5, | | | | | | |
| | | pigment solid content | | | | | | |
| | | of 15 percent by | | | | | | |
| | | mass | | | | | | |
| | | Liquid dispersion of | 20.0 | — | 26.67 | — | — | — |
| | | fine polymer particle | percent | | | | | |
| | | containing cyan | | | | | | |
| | | pigment (Preparation | | | | | | |
| | | Example 6, | | | | | | |
| | | pigment solid content | | | | | | |
| | | of 15 percent by | | | | | | |
| | | mass) | | | | | | |
| | | Liquid dispersion of | 20.0 | — | — | 26.67 | — | — |
| | | fine polymer particle | percent | | | | | |
| | | containing yellow | | | | | | |
| | | pigment (Preparation | | | | | | |
| | | Example 7, | | | | | | |
| | | pigment solid content | | | | | | |
| | | of 15 percent by | | | | | | |
| | | mass) | | | | | | |
| | | Liquid dispersion of | 20.0 | — | — | — | 33.33 | — |
| | | fine polymer particle | percent | | | | | |
| | | containing carbon | | | | | | |
| | | black pigment | | | | | | |
| | | (Preparation | | | | | | |
| | | Example 8, | | | | | | |
| | | pigment solid content | | | | | | |
| | | of 15 percent by | | | | | | |
| | | mass) | | | | | | |
| | | Liquid dispersion of | 54.5 | — | — | — | — | — |
| | | polymer dispersion | percent | | | | | |
| | | containing white | | | | | | |
| | | pigment (Preparation | | | | | | |
| | | Example 9, | | | | | | |
| | | pigment solid content | | | | | | |
| | | of 50 percent by | | | | | | |
| | | mass) | | | | | | |
| | | Liquid dispersion of | 52.5 | — | — | — | — | 20.00 |
| | | polymer dispersion | percent | | | | | |
| | | containing white | | | | | | |
| | | pigment (AC- | | | | | | |
| | | AW62, pigment solid | | | | | | |
| | | content of 50 percent | | | | | | |
| | | by mass, | | | | | | |
| | | manufactured by | | | | | | |
| | | Dainichiseika Color | | | | | | |
| | | & Chemicals Mfg. | | | | | | |
| | | Co., Ltd.) | | | | | | |
| Resin | Urethane | SUPERFLEX ® 460 | 38.0 | 31.58 | 31.58 | 31.58 | 31.58 | — |
| | resin | (Resin solid portion | percent | | | | | |
| | | of 38 percent by | | | | | | |
| | | mass, Tg of −21 | | | | | | |
| | | degrees C.) | | | | | | |
| | | SUPERFLEX ® | 38.0 | — | — | — | — | 31.58 |
| | | 460S (Resin solid | percent | | | | | |
| | | portion of 38 percent | | | | | | |
| | | by mass, Tg of −28 | | | | | | |
| | | degrees C.) | | | | | | |
| | | SUPERFLEX ® 470 | 38.0 | — | — | — | — | — |
| | | (Resin solid portion | percent | | | | | |
| | | of 38 percent by | | | | | | |
| | | mass, Tg of −31 | | | | | | |
| | | degrees C.) | | | | | | |
| | | SUPERFLEX ® 420 | 32.0 | — | — | — | — | — |
| | | (Resin solid portion | percent | | | | | |
| | | of 32 percent by | | | | | | |
| | | mass, Tg of −10 | | | | | | |
| | | degrees C.) | | | | | | |
| | | TAKELAC ™ WS- | 30.0 | — | — | — | — | — |
| | | 6021 (Resin solid | percent | | | | | |
| | | portion of 30 percent | | | | | | |
| | | by mass, Tg of −60 | | | | | | |
| | | degrees C.) | | | | | | |
| | | TAKELAC ™ W- | 33.4 | — | — | — | — | — |
| | | 6110 (Resin solid | percent | | | | | |
| | | portion of 33.4 | | | | | | |
| | | percent by mass, Tg | | | | | | |
| | | of −20 degrees C.) | | | | | | |
| | | TAKELAC ™ W- | 30.0 | — | — | — | — | — |
| | | 6061 (Resin solid | percent | | | | | |
| | | portion of 30 percent | | | | | | |
| | | by mass, Tg of 25 | | | | | | |
| | | degrees C.) | | | | | | |
| | Acrylic | Acrylic silicone resin | 40.0 | — | — | — | — | — |
| | resin | (Synthesis Example | percent | | | | | |
| | | 1, resin solid portion | | | | | | |
| | | of 40 percent by | | | | | | |
| | | mass, Tg of −10 | | | | | | |
| | | degrees C.) | | | | | | |
| Organic | Organic | Glycerin (boiling | 100 | — | — | — | — | — |
| solvent | solvent | point of 290 degree | percent | | | | | |
| | A | C./760 mmHg, | | | | | | |
| | | equilibrium moisture | | | | | | |
| | | content of 49 weight | | | | | | |
| | | percent) | | | | | | |
| | | Diglycerin (boiling | 100 | — | — | — | — | — |
| | | point of 265 to 270 | percent | | | | | |
| | | degree C./15 mmHg, | | | | | | |
| | | equilibrium moisture | | | | | | |
| | | content of 38 weight | | | | | | |
| | | percent) | | | | | | |
| | | Tetraethylene glycol | 100 | — | — | — | — | — |
| | | (boiling point of 328 | percent | | | | | |
| | | degrees | | | | | | |
| | | C./760 mmHg, | | | | | | |
| | | equilibrium moisture | | | | | | |
| | | content of 37 weight | | | | | | |
| | | percent) | | | | | | |
| | | Triethylene glycol | 100 | — | — | — | — | — |
| | | (boiling point of 288 | percent | | | | | |
| | | degree C./760 mmHg, | | | | | | |
| | | equilibrium moisture | | | | | | |
| | | content of 39 weight | | | | | | |
| | | percent) | | | | | | |
| | | Ethylene glycol | 100 | — | — | — | — | — |
| | | (boiling point of | percent | | | | | |
| | | 197.3 degree C./760 | | | | | | |
| | | mmHg, equilibrium | | | | | | |
| | | moisture content of | | | | | | |
| | | 44 weight percent) | | | | | | |
| | Other | 1,3-butane diol | 100 | — | — | — | — | — |
| | organic | | percent | | | | | |
| | solvent | Propylene glycol | 100 | 24.00 | 24.00 | 24.00 | 22.00 | 19.00 |
| | | | percent | | | | | |

| | | | | | | |
|---|---|---|---|---|---|---|
| 3-methyl-1,3-butane | 100 | — | — | — | — | — |
| diol | percent | | | | | |
| 1,2-butanediol | 100 | — | — | — | — | — |
| | percent | | | | | |
| 1,2-hexane diol | 100 | 6.00 | 6.00 | 6.00 | 6.00 | 6.00 |
| | percent | | | | | |
| Triethylene glycol | 100 | — | — | — | — | — |
| monobutyl ether | percent | | | | | |
| 2-ethyl-1,3- | 100 | — | — | — | — | — |
| hexanediol | percent | | | | | |
| 2,2,4-trimethyl-1,3- | 100 | — | — | — | — | — |
| pentanediol | percent | | | | | |

| | | | | | | |
|---|---|---|---|---|---|---|
| Compound represented by | 100 | 6.00 | 6.00 | 6.00 | 6.00 | 6.00 |
| Chemical Formula I (boiling | percent | | | | | |
| point of 215.2 degrees C./760 | | | | | | |
| mmHg, equilibrium moisture | | | | | | |
| content of 42 weight percent) | | | | | | |

| | | | | | | | |
|---|---|---|---|---|---|---|---|
| Surfactant | TEGO Wet 270 | 100 | 0.20 | 0.20 | 0.20 | 0.20 | 0.20 |
| | | percent | | | | | |
| | SILFACE SAG503A | 100 | — | — | — | — | — |
| | | percent | | | | | |
| | Surfynol 104E | 50.0 | — | — | — | — | — |
| | (effective | percent | | | | | |
| | component: 50 | | | | | | |
| | percent) | | | | | | |
| | UNIDYNE ™ | 100 | — | — | — | — | — |
| | DSN403N | percent | | | | | |
| | EMULGEN LS-106 | 100 | — | — | — | — | — |
| | | percent | | | | | |
| Mildew-proofing | Proxel GXL | 20.0 | 0.05 | 0.05 | 0.05 | 0.05 | 0.05 |
| agent | | percent | | | | | |
| Foam inhibitor | 2,4,7,9- | 100 | 0.30 | 0.30 | 0.30 | 0.30 | 0.30 |
| (defoaming agent) | tetramethyldecane- | percent | | | | | |
| | 4,7-diol | | | | | | |
| | 2,5,8,11- | 100 | — | — | — | — | — |
| | tetramethyldodecane- | percent | | | | | |
| | 5,8-diol | | | | | | |
| pH regulator | 2-amino-2-ethyl-1,3- | 100 | 0.30 | 0.30 | 0.30 | 0.30 | 0.30 |
| | propane diol | percent | | | | | |

| | | | | | |
|---|---|---|---|---|---|
| Highly pure water | Balance | Balance | Balance | Balance | Balance |
| Total (percent by mass) | 100 | 100 | 100 | 100 | 100 |
| Proportion of organic solvent A | 0.0 | 0.0 | 0.0 | 0.0 | 0.0 |
| Entire of coloring material and | 17.3 | 17.3 | 17.3 | 18.7 | 22.5 |
| solid content of resin | | | | | |

TABLE 8

| | | | Effective | Manufacturing | Manufacturing | Manufacturing | Manufacturing | Manufacturing |
|---|---|---|---|---|---|---|---|---|
| Component (percent by mass) | | | component | Example 36 | Example 37 | Example 38 | Example 39 | Example 40 |
| Coloring material | | Surface-modified | 20.0 | — | — | — | — | — |
| (pigment dispersion) | | black pigment | percent | | | | | |
| | | dispersion, | | | | | | |
| | | (Preparation | | | | | | |
| | | Example 1, pigment | | | | | | |
| | | solid content of 20 | | | | | | |
| | | percent by mass) | | | | | | |
| | | Surface-modified | 20.0 | — | — | — | — | — |
| | | magenta pigment | percent | | | | | |
| | | dispersion, | | | | | | |
| | | (Preparation | | | | | | |
| | | Example 2, pigment | | | | | | |
| | | solid content of 20 | | | | | | |
| | | percent by mass) | | | | | | |
| | | Surface-modified | 20.0 | — | — | — | — | — |
| | | cyan pigment | percent | | | | | |
| | | dispersion, | | | | | | |
| | | (Preparation | | | | | | |
| | | Example 3, pigment | | | | | | |
| | | solid content of 20 | | | | | | |
| | | percent by mass) | | | | | | |
| | | Surface-modified | 20.0 | — | — | — | — | — |
| | | yellow pigment | percent | | | | | |
| | | dispersion, | | | | | | |
| | | (Preparation | | | | | | |
| | | Example 4, pigment | | | | | | |
| | | solid content of 20 | | | | | | |
| | | percent by mass) | | | | | | |
| | | Liquid dispersion of | 20.0 | 26.67 | — | — | — | — |
| | | fine polymer particle | percent | | | | | |
| | | containing magenta | | | | | | |
| | | pigment (Preparation | | | | | | |
| | | Example 5, | | | | | | |
| | | pigment solid content | | | | | | |
| | | of 15 percent by | | | | | | |
| | | mass) | | | | | | |
| | | Liquid dispersion of | 20.0 | — | 26.67 | — | — | — |
| | | fine polymer particle | percent | | | | | |
| | | containing cyan | | | | | | |
| | | pigment (Preparation | | | | | | |
| | | Example 6, | | | | | | |
| | | pigment solid content | | | | | | |
| | | of 15 percent by | | | | | | |
| | | mass) | | | | | | |
| | | Liquid dispersion of | 20.0 | — | — | 26.67 | — | — |
| | | fine polymer particle | percent | | | | | |
| | | containing yellow | | | | | | |
| | | pigment (Preparation | | | | | | |
| | | Example 7, | | | | | | |
| | | pigment solid content | | | | | | |
| | | of 15 percent by | | | | | | |
| | | mass) | | | | | | |
| | | Liquid dispersion of | 20.0 | — | — | — | 33.33 | — |
| | | fine polymer particle | percent | | | | | |
| | | containing carbon | | | | | | |
| | | black pigment | | | | | | |
| | | (Preparation | | | | | | |
| | | Example 8, | | | | | | |
| | | pigment solid content | | | | | | |
| | | of 15 percent by | | | | | | |
| | | mass) | | | | | | |
| | | Liquid dispersion of | 54.5 | — | — | — | — | — |
| | | polymer dispersion | percent | | | | | |
| | | containing white | | | | | | |
| | | pigment (Preparation | | | | | | |
| | | Example 9, | | | | | | |
| | | pigment solid content | | | | | | |
| | | of 50 percent by | | | | | | |
| | | mass) | | | | | | |
| | | Liquid dispersion of | 52.5 | — | — | — | — | 20.00 |
| | | polymer dispersion | percent | | | | | |
| | | containing white | | | | | | |
| | | pigment (AC- | | | | | | |
| | | AW62, pigment solid | | | | | | |
| | | content of 50 percent | | | | | | |
| | | by mass, | | | | | | |
| | | manufactured by | | | | | | |
| | | Dainichiseika Color | | | | | | |
| | | & Chemicals Mfg. | | | | | | |
| | | Co., Ltd.) | | | | | | |
| Resin | Urethane | SUPERFLEX ® 460 | 38.0 | — | — | — | — | — |
| | resin | (Resin solid portion | percent | | | | | |
| | | of 38 percent by | | | | | | |
| | | mass, Tg of −21 | | | | | | |
| | | degrees C.) | | | | | | |
| | | SUPERFLEX ® | 38.0 | — | — | — | — | — |
| | | 460S (Resin solid | percent | | | | | |
| | | portion of 38 percent | | | | | | |
| | | by mass, Tg of −28 | | | | | | |
| | | degrees C.) | | | | | | |
| | | SUPERFLEX ® 470 | 38.0 | 5.26 | 5.26 | 5.26 | 5.26 | 5.26 |
| | | (Resin solid portion | percent | | | | | |
| | | of 38 percent by | | | | | | |
| | | mass, Tg of −31 | | | | | | |
| | | degrees C.) | | | | | | |
| | | SUPERFLEX ® 420 | 32.0 | — | — | — | — | — |
| | | (Resin solid portion | percent | | | | | |
| | | of 32 percent by | | | | | | |
| | | mass, Tg of −10 | | | | | | |
| | | degrees C.) | | | | | | |
| | | TAKELAC ™ WS- | 30.0 | — | — | — | — | — |
| | | 6021 (Resin solid | percent | | | | | |
| | | portion of 30 percent | | | | | | |
| | | by mass, Tg of −60 | | | | | | |
| | | degrees C.) | | | | | | |
| | | TAKELAC ™ W- | 33.4 | — | — | — | — | — |
| | | 6110 (Resin solid | percent | | | | | |
| | | portion of 33.4 | | | | | | |
| | | percent by mass, Tg | | | | | | |
| | | of −20 degrees C.) | | | | | | |
| | | TAKELAC ™ W- | 30.0 | — | — | — | — | — |
| | | 6061 (Resin solid | percent | | | | | |
| | | portion of 30 percent | | | | | | |
| | | by mass, Tg of 25 | | | | | | |
| | | degrees C.) | | | | | | |
| | Acrylic | Acrylic silicone resin | 40.0 | 25.00 | 25.00 | 25.00 | 25.00 | 25.00 |
| | resin | (Synthesis Example | percent | | | | | |
| | | 1, resin solid portion | | | | | | |
| | | of 40 percent by | | | | | | |
| | | mass, Tg of −10 | | | | | | |
| | | degrees C.) | | | | | | |
| Organic | Organic | Glycerin (boiling | 100 | 20.00 | 20.00 | 20.00 | 18.00 | 15.00 |
| solvent | solvent | point of 290 degree | percent | | | | | |
| | A | C./760 mmHg, | | | | | | |
| | | equilibrium moisture | | | | | | |
| | | content of 49 weight | | | | | | |
| | | percent) | | | | | | |
| | | Diglycerin (boiling | 100 | — | — | — | — | — |
| | | point of 265 to 270 | percent | | | | | |
| | | degree C./15 mmHg, | | | | | | |
| | | equilibrium moisture | | | | | | |
| | | content of 38 weight | | | | | | |
| | | percent) | | | | | | |
| | | Tetraethylene glycol | 100 | — | — | — | — | — |
| | | (boiling point of 328 | percent | | | | | |
| | | degrees | | | | | | |
| | | C./760 mmHg, | | | | | | |
| | | equilibrium moisture | | | | | | |
| | | content of 37 weight | | | | | | |
| | | percent) | | | | | | |
| | | Triethylene glycol | 100 | — | — | — | — | — |
| | | (boiling point of 288 | percent | | | | | |
| | | degree C./760 mmHg, | | | | | | |
| | | equilibrium moisture | | | | | | |
| | | content of 39 weight | | | | | | |
| | | percent) | | | | | | |
| | | Ethylene glycol | 100 | — | — | — | — | — |
| | | (boiling point of | percent | | | | | |
| | | 197.3 degree C./760 | | | | | | |
| | | mmHg, equilibrium | | | | | | |
| | | moisture content of | | | | | | |
| | | 44 weight percent) | | | | | | |
| | Other | 1,3-butane diol | 100 | — | — | — | — | — |
| | organic | | percent | | | | | |
| | solvent | Propylene glycol | 100 | 2.00 | 2.00 | 2.00 | 2.00 | 2.00 |
| | | | percent | | | | | |

| | | | | | | |
|---|---|---|---|---|---|---|
| 3-methyl-1,3-butane | 100 | 7.00 | 7.00 | 7.00 | 7.00 | 7.00 |
| diol | percent | | | | | |
| 1,2-butanediol | 100 | 5.00 | 5.00 | 5.00 | 5.00 | 5.00 |
| | percent | | | | | |
| 1,2-hexane diol | 100 | — | — | — | — | — |
| | percent | | | | | |
| Triethylene glycol | 100 | — | — | — | — | — |
| monobutyl ether | percent | | | | | |
| 2-ethyl-1,3- | 100 | — | — | — | — | — |
| hexanediol | percent | | | | | |
| 2,2,4-trimethyl-1,3- | 100 | — | — | — | — | — |
| pentanediol | percent | | | | | |

| | | | | | | |
|---|---|---|---|---|---|---|
| Compound represented by | 100 | — | — | — | — | — |
| Chemical Formula I (boiling | percent | | | | | |
| point of 215.2 degrees C./760 | | | | | | |
| mmHg, equilibrium moisture | | | | | | |
| content of 42 weight percent) | | | | | | |

| | | | | | | | |
|---|---|---|---|---|---|---|---|
| Surfactant | TEGO Wet 270 | 100 | — | — | — | — | — |
| | | percent | | | | | |
| | SILFACE SAG503A | 100 | — | — | — | — | — |
| | | percent | | | | | |
| | Surfynol 104E | 50.0 | — | — | — | — | — |
| | (effective | percent | | | | | |
| | component: 50 | | | | | | |
| | percent) | | | | | | |
| | UNIDYNE ™ | 100 | 0.06 | 0.06 | 0.06 | 0.06 | 0.06 |
| | DSN403N | percent | | | | | |
| | EMULGEN LS-106 | 100 | — | — | — | — | — |
| | | percent | | | | | |
| Mildew-proofing | Proxel GXL | 20.0 | — | — | — | — | — |
| agent | | percent | | | | | |
| Foam inhibitor | 2,4,7,9- | 100 | — | — | — | — | — |
| (defoaming agent) | tetramethyldecane- | percent | | | | | |
| | 4,7-diol | | | | | | |
| | 2,5,8,11- | 100 | 0.30 | 0.30 | 0.30 | 0.30 | 0.30 |
| | tetramethyldodecane- | percent | | | | | |
| | 5,8-diol | | | | | | |
| pH regulator | 2-amino-2-ethyl-1,3- | 100 | 0.30 | 0.30 | 0.30 | 0.30 | 0.30 |
| | propane diol | percent | | | | | |

| | | | | | |
|---|---|---|---|---|---|
| Highly pure water | Balance | Balance | Balance | Balance | Balance |
| Total (percent by mass) | 100 | 100 | 100 | 100 | 100 |
| Proportion of organic solvent A | 20.0 | 20.0 | 20.0 | 18.0 | 15.0 |
| Entire of coloring material and | 17.3 | 17.3 | 17.3 | 18.7 | 22.5 |
| solid content of resin | | | | | |

TABLE 9

| | | | Effective | Manufacturing | Manufacturing | Manufacturing | Manufacturing | Manufacturing |
|---|---|---|---|---|---|---|---|---|
| Component (percent by mass) | | | component | Example 41 | Example 42 | Example 43 | Example 44 | Example 45 |
| Coloring material | | Surface-modified | 20.0 | — | — | — | — | — |
| (pigment dispersion) | | black pigment | percent | | | | | |
| | | dispersion, | | | | | | |
| | | (Preparation | | | | | | |
| | | Example 1, pigment | | | | | | |
| | | solid content of 20 | | | | | | |
| | | percent by mass) | | | | | | |
| | | Surface-modified | 20.0 | — | — | — | — | — |
| | | magenta pigment | percent | | | | | |
| | | dispersion, | | | | | | |
| | | (Preparation | | | | | | |
| | | Example 2, pigment | | | | | | |
| | | solid content of 20 | | | | | | |
| | | percent by mass) | | | | | | |
| | | Surface-modified | 20.0 | — | — | — | — | — |
| | | cyan pigment | percent | | | | | |
| | | dispersion, | | | | | | |
| | | (Preparation | | | | | | |
| | | Example 3, pigment | | | | | | |
| | | solid content of 20 | | | | | | |
| | | percent by mass) | | | | | | |
| | | Surface-modified | 20.0 | — | — | — | — | — |
| | | yellow pigment | percent | | | | | |
| | | dispersion, | | | | | | |
| | | (Preparation | | | | | | |
| | | Example 4, pigment | | | | | | |
| | | solid content of 20 | | | | | | |
| | | percent by mass) | | | | | | |
| | | Liquid dispersion of | 20.0 | 26.67 | — | — | — | — |
| | | fine polymer particle | percent | | | | | |
| | | containing magenta | | | | | | |
| | | pigment (Preparation | | | | | | |
| | | Example 5, | | | | | | |
| | | pigment solid content | | | | | | |
| | | of 15 percent by | | | | | | |
| | | mass | | | | | | |
| | | Liquid dispersion of | 20.0 | — | 26.67 | — | — | — |
| | | fine polymer particle | percent | | | | | |
| | | containing cyan | | | | | | |
| | | pigment (Preparation | | | | | | |
| | | Example 6, | | | | | | |
| | | pigment solid content | | | | | | |
| | | of 15 percent by | | | | | | |
| | | mass) | | | | | | |
| | | Liquid dispersion of | 20.0 | — | — | 26.67 | — | — |
| | | fine polymer particle | percent | | | | | |
| | | containing yellow | | | | | | |
| | | pigment (Preparation | | | | | | |
| | | Example 7, | | | | | | |
| | | pigment solid content | | | | | | |
| | | of 15 percent by | | | | | | |
| | | mass) | | | | | | |
| | | Liquid dispersion of | 20.0 | — | — | — | 33.33 | — |
| | | fine polymer particle | percent | | | | | |
| | | containing carbon | | | | | | |
| | | black pigment | | | | | | |
| | | (Preparation | | | | | | |
| | | Example 8, | | | | | | |
| | | pigment solid content | | | | | | |
| | | of 15 percent by | | | | | | |
| | | mass) | | | | | | |
| | | Liquid dispersion of | 54.5 | — | — | — | — | — |
| | | polymer dispersion | percent | | | | | |
| | | containing white | | | | | | |
| | | pigment (Preparation | | | | | | |
| | | Example 9, | | | | | | |
| | | pigment solid content | | | | | | |
| | | of 50 percent by | | | | | | |
| | | mass) | | | | | | |
| | | Liquid dispersion of | 52.5 | — | — | — | — | 18.00 |
| | | polymer dispersion | percent | | | | | |
| | | containing white | | | | | | |
| | | pigment (AC- | | | | | | |
| | | AW62, pigment solid | | | | | | |
| | | content of 50 percent | | | | | | |
| | | by mass, | | | | | | |
| | | manufactured by | | | | | | |
| | | Dainichiseika Color | | | | | | |
| | | & Chemicals Mfg. | | | | | | |
| | | Co., Ltd.) | | | | | | |
| Resin | Urethane | SUPERFLEX ® 460 | 38.0 | — | — | — | — | — |
| | resin | (Resin solid portion | percent | | | | | |
| | | of 38 percent by | | | | | | |
| | | mass, Tg of −21 | | | | | | |
| | | degrees C.) | | | | | | |
| | | SUPERFLEX ® | 38.0 | — | — | — | — | — |
| | | 460S (Resin solid | percent | | | | | |
| | | portion of 38 percent | | | | | | |
| | | by mass, Tg of −28 | | | | | | |
| | | degrees C.) | | | | | | |
| | | SUPERFLEX ® 470 | 38.0 | — | — | — | — | — |
| | | (Resin solid portion | percent | | | | | |
| | | of 38 percent by | | | | | | |
| | | mass, Tg of −31 | | | | | | |
| | | degrees C.) | | | | | | |
| | | SUPERFLEX ® 420 | 32.0 | — | — | — | — | — |
| | | (Resin solid portion | percent | | | | | |
| | | of 32 percent by | | | | | | |
| | | mass, Tg of −10 | | | | | | |
| | | degrees C.) | | | | | | |
| | | TAKELAC ™ WS- | 30.0 | — | — | — | — | — |
| | | 6021 (Resin solid | percent | | | | | |
| | | portion of 30 percent | | | | | | |
| | | by mass, Tg of −60 | | | | | | |
| | | degrees C.) | | | | | | |
| | | TAKELAC ™ W- | 33.4 | — | — | — | — | — |
| | | 6110 (Resin solid | percent | | | | | |
| | | portion of 33.4 | | | | | | |
| | | percent by mass, Tg | | | | | | |
| | | of −20 degrees C.) | | | | | | |
| | | TAKELAC ™ W- | 30.0 | 33.33 | 33.33 | 33.33 | 33.33 | 30.00 |
| | | 6061 (Resin solid | percent | | | | | |
| | | portion of 30 percent | | | | | | |
| | | by mass, Tg of 25 | | | | | | |
| | | degrees C.) | | | | | | |
| | Acrylic | Acrylic silicone resin | 40.0 | — | — | — | — | — |
| | resin | (Synthesis Example | percent | | | | | |
| | | 1, resin solid portion | | | | | | |
| | | of 40 percent by | | | | | | |
| | | mass, Tg of −10 | | | | | | |
| | | degrees C.) | | | | | | |
| Organic | Organic | Glycerin (boiling | 100 | 19.00 | 19.00 | 19.00 | 17.00 | 15.00 |
| solvent | solvent | point of 290 degree | percent | | | | | |
| | A | C./760 mmHg, | | | | | | |
| | | equilibrium moisture | | | | | | |
| | | content of 49 weight | | | | | | |
| | | percent) | | | | | | |
| | | Diglycerin (boiling | 100 | — | — | — | — | — |
| | | point of 265 to 270 | percent | | | | | |
| | | degree C./15 mmHg, | | | | | | |
| | | equilibrium moisture | | | | | | |
| | | content of 38 weight | | | | | | |
| | | percent) | | | | | | |
| | | Tetraethylene glycol | 100 | — | — | — | — | — |
| | | (boiling point of 328 | percent | | | | | |
| | | degrees C./760 mmHg, | | | | | | |
| | | equilibrium moisture | | | | | | |
| | | content of 37 weight | | | | | | |
| | | percent) | | | | | | |
| | | Triethylene glycol | 100 | — | — | — | — | — |
| | | (boiling point of 288 | percent | | | | | |
| | | degree C./760 mmHg, | | | | | | |
| | | equilibrium moisture | | | | | | |
| | | content of 39 weight | | | | | | |
| | | percent) | | | | | | |
| | | Ethylene glycol | 100 | — | — | — | — | — |
| | | (boiling point of | percent | | | | | |
| | | 197.3 degree C./760 | | | | | | |
| | | mmHg, equilibrium | | | | | | |
| | | moisture content of | | | | | | |
| | | 44 weight percent) | | | | | | |
| | Other | 1,3-butane diol | 100 | — | — | — | — | — |
| | organic | | percent | | | | | |
| | solvent | Propylene glycol | 100 | — | — | — | — | — |
| | | | percent | | | | | |

| | | | | | | |
|---|---|---|---|---|---|---|
| 3-methyl-1,3-butane | 100 | — | — | — | — | — |
| diol | percent | | | | | |
| 1,2-butanediol | 100 | — | — | — | — | — |
| | percent | | | | | |
| 1,2-hexane diol | 100 | 7.00 | 7.00 | 7.00 | 7.00 | 5.00 |
| | percent | | | | | |
| Triethylene glycol | 100 | — | — | — | — | — |
| monobutyl ether | percent | | | | | |
| 2-ethyl-1,3- | 100 | — | — | — | — | — |
| hexanediol | percent | | | | | |
| 2,2,4-trimethyl-1,3- | 100 | — | — | — | — | — |
| pentanediol | percent | | | | | |

| | | | | | | |
|---|---|---|---|---|---|---|
| Compound represented by | 100 | 6.00 | 6.00 | 6.00 | 6.00 | 8.00 |
| Chemical Formula I (boiling | percent | | | | | |
| point of 215.2 degrees C./760 | | | | | | |
| mmHg, equilibrium moisture | | | | | | |
| content of 42 weight percent) | | | | | | |

| | | | | | | | |
|---|---|---|---|---|---|---|---|
| Surfactant | TEGO Wet 270 | 100 | — | — | — | — | — |
| | | percent | | | | | |
| | SILFACE SAG503A | 100 | — | — | — | — | — |
| | | percent | | | | | |
| | Surfynol 104E | 50.0 | — | — | — | — | — |
| | (effective | percent | | | | | |
| | component: 50 | | | | | | |
| | percent) | | | | | | |
| | UNIDYNE ™ | 100 | — | — | — | — | — |
| | DSN403N | percent | | | | | |
| | EMULGEN LS-106 | 100 | — | — | — | — | — |
| | | percent | | | | | |
| Mildew-proofing | Proxel GXL | 20.0 | 0.05 | 0.05 | 0.05 | 0.05 | 0.05 |
| agent | | percent | | | | | |
| Foam inhibitor | 2,4,7,9- | 100 | — | — | — | — | — |
| (defoaming agent) | tetramethyldecane- | percent | | | | | |
| | 4,7-diol | | | | | | |
| | 2,5,8,11- | 100 | 0.20 | 0.20 | 0.20 | 0.20 | 0.20 |
| | tetramethyldodecane- | percent | | | | | |
| | 5,8-diol | | | | | | |
| pH regulator | 2-amino-2-ethyl-1,3- | 100 | 0.20 | 0.20 | 0.20 | 0.20 | 0.20 |
| | propane diol | percent | | | | | |

| | | | | | |
|---|---|---|---|---|---|
| Highly pure water | Balance | Balance | Balance | Balance | Balance |
| Total (percent by mass) | 100 | 100 | 100 | 100 | 100 |
| Proportion of organic solvent A | 19.0 | 19.0 | 19.0 | 17.0 | 15.0 |
| Entire of coloring material and | 15.3 | 15.3 | 15.3 | 16.7 | 18.5 |
| solid content of resin | | | | | |

Properties of White Ink and Color Ink

Each of the properties was analyzed for the inks 1 to 45 to evaluate the discharging stability and decapped discharging. The results are shown in Table 10.

Viscosity

The viscosity of the ink was measured with a viscometer (RE-85L, manufactured by TOKI SANGYO CO., LTD.) at 25 degrees C.

pH

The pH of the ink was measured at 25 degrees C. using a pH meter (HM-30R type, manufactured by DKK-TOA CORPORATION).

Static Surface Tension

Static surface tension of ink was measured at 25 degrees C. using an automatic surface tensiometer (DY-300, manufactured by KYOWA INTERFACE SCIENCE Co., Ltd.).

Discharging Stability

One litter of each ink adjusted for a discharging head for each color was flown by passage at 23±1 degrees C. from the ink cartridge of the inkjet printing device (IPSiO Gxe-5500, manufactured by Ricoh Co., Ltd.). Immediately after the passage, the inkjet printing device continuously printed a chart of a solid image created by Microsoft Word 2000 with an area of 80 percent of A4 paper on My Paper (manufactured by Ricoh Co, Ltd.) with a run length of 200. After the printing, the nozzle check chart was printed and evaluated regarding discharging disturbance of each nozzle according to the following criteria.

The print mode used was: a modified mode in which Plain Paper—Standard Fast was modified to No Color Calibration from the user setting for plain paper by the driver installed onto the printer. Grade A and B are allowable for a practical purpose.

Evaluation Criteria
A: No disturbed discharging
B: Slight disturbed discharging
C: Nozzles with discharging defects or without discharging were present
D: Significant disturbed discharging or many non-discharging nozzles

Decapped Discharging

The ink cartridge of an inkjet printing device (IPSiO GXe-5500, manufactured by Ricoh Co., Ltd.) supplied individually adjusted ink to the discharging head of each color at 23±1 degrees C. The cap was forcibly removed from the head to create a decapped state. The head was thereafter left to stand for 17 minutes. A nozzle check chart was printed, followed by evaluated regarding discharging defects, i.e., disturbed discharging, according to the following evaluation criteria. Grade A and B are allowable for a practical purpose.

Evaluation Criteria
A: No disturbed discharging
B: Slight disturbed discharging
C: Nozzles with discharging defects or no discharging present
D: Significant disturbed discharging or many non-discharging nozzles

TABLE 10

| | | Ink property values | | | Discharging stability | |
|---|---|---|---|---|---|---|
| Manufacturing | | | | Static surface | | Discharging |
| Example | | Viscosity | | tension | Continuous | with |
| of Ink | Color | (mPa · s) | pH | (mN/m) | discharging | decapped |
| 1 | Magenta | 9.92 | 8.95 | 31.6 | B | B |
| 2 | Cyan | 9.75 | 9.01 | 31.7 | B | B |
| 3 | Yellow | 9.79 | 9.03 | 31.6 | B | B |
| 4 | Black | 10.27 | 8.99 | 31.1 | B | B |
| 5 | White | 10.70 | 9.06 | 32.1 | B | B |
| 6 | Magenta | 11.32 | 9.36 | 31.1 | A | A |
| 7 | Cyan | 11.18 | 9.43 | 30.2 | A | A |
| 8 | Yellow | 11.26 | 9.37 | 29.9 | A | A |
| 9 | Black | 11.33 | 9.42 | 30.6 | A | A |
| 10 | White | 12.11 | 9.48 | 31.4 | A | A |
| 11 | Magenta | 11.82 | 9.31 | 29.8 | A | A |
| 12 | Cyan | 12.03 | 9.35 | 29.9 | A | A |
| 13 | Yellow | 11.64 | 9.42 | 29.7 | A | A |
| 14 | Black | 11.65 | 9.41 | 30.0 | A | A |
| 15 | White | 12.45 | 9.30 | 29.6 | A | B |
| 16 | Black | 11.79 | 8.97 | 33.5 | A | A |
| 17 | Magenta | 12.00 | 9.02 | 33.8 | A | A |
| 18 | Cyan | 12.02 | 9.01 | 33.5 | A | A |
| 19 | Yellow | 11.62 | 9.01 | 33.9 | A | A |
| 20 | White | 12.43 | 9.10 | 34.5 | A | A |
| 21 | Magenta | 12.32 | 9.41 | 35.1 | A | A |
| 22 | Cyan | 12.13 | 9.35 | 34.4 | A | A |
| 23 | Yellow | 12.24 | 9.32 | 33.9 | A | A |
| 24 | Black | 12.35 | 9.31 | 34.5 | A | A |
| 25 | White | 12.45 | 9.40 | 35.2 | A | B |
| 26 | Magenta | 12.01 | 9.11 | 30.1 | A | B |
| 27 | Cyan | 12.03 | 9.05 | 30.5 | A | A |
| 28 | Yellow | 11.94 | 9.02 | 29.9 | A | A |
| 29 | Black | 12.05 | 9.01 | 30.7 | A | B |
| 30 | White | 12.35 | 9.10 | 31.0 | A | B |
| 31 | Magenta | 11.82 | 9.38 | 32.1 | C | D |
| 32 | Cyan | 11.68 | 9.44 | 31.2 | C | D |
| 33 | Yellow | 11.76 | 9.38 | 30.9 | C | D |
| 34 | Black | 11.83 | 9.43 | 31.6 | D | D |
| 35 | White | 12.61 | 9.46 | 31.9 | D | D |
| 36 | Magenta | 12.42 | 9.31 | 35.3 | C | C |
| 37 | Cyan | 12.23 | 9.25 | 34.7 | C | C |
| 38 | Yellow | 12.34 | 9.29 | 34.0 | C | C |
| 39 | Black | 12.45 | 9.25 | 34.6 | D | D |
| 40 | White | 12.55 | 9.32 | 35.3 | D | D |
| 41 | Magenta | 9.83 | 8.97 | 41.7 | B | B |
| 42 | Cyan | 9.63 | 9.05 | 41.5 | B | B |
| 43 | Yellow | 9.68 | 9.04 | 41.8 | B | B |
| 44 | Black | 10.18 | 9.01 | 41.4 | B | B |
| 45 | White | 10.61 | 9.08 | 42.2 | B | B |

### Manufacturing Example of Pre-Processing Fluid

### Preparation Example 1: Manufacturing of Pre-Processing Fluid 1

A total of 12.5 parts by mass of magnesium sulfate was weighed and placed in a glass beaker. A total of highly pure water of 50.00 parts was added followed by stirring for five minutes. Next, 3.00 parts by mass of propylene glycol, 0.05 parts by mass of Proxel GXL, 0.1 parts by mass of 1,2,3-benzotriazoles were further added followed by stirring for 15 minutes. Thereafter, highly pure water was added as balance to make the total 100 parts by mass followed by stirring for 10 minutes. The thus-obtained mixture was filtered with a polyvinilydene fluoride membrane filter with an average pore diameter of 10.0 μm under pressure to remove dust such as insoluble matter to prepare pre-processing fluid 1.

### Manufacturing Examples 2 to 12: Manufacturing of Pre-Processing Fluids 2 to 12

Pre-processing fluids 2 to 12 were obtained in the same manner as in Manufacturing Example 1 except that the prescription of pre-processing fluid was changed to those shown in Table 11. The content of each material is represented in percent by mass in Table 11 below. It does not represent the content of solid content or effective component but all included.

The details of each material shown in Tables 11 to 13 below are as follows.

Cationic Polymer
SHALLOL DC-902P: polydimethyl diallyl ammonium chloride, solid content of 51.0 percent by mass, manufactured by DKS Co., Ltd.
DK8610: polyamine resin, solid content of 55.0 percent by mass. manufactured by SEIKO PMC CORPORATION

Nonionic Resin Particle
TAKELAC^{trademark} W-635: Polyurethane dispersion, solid content of 35 percent, manufactured by Mitsui Chemicals, Inc.
SUMIKAFLEX 850HQ: Copolymer of ethylene-vinyl chloride-vinyl acetate, solid content of 50 percent by mass, manufactured by Sumitomo Chemical Company
SUMIKAFLEX 951HQ: Copolymer of ethylene-vinyl acetate-vinyl versatate, solid content of 55 percent by mass, manufactured by Sumitomo Chemical Company

Wax
AQUACER 497: Paraffin wax, effective component of 50 percent by mass, manufactured by BYK Japan
AQUACER 539: Modified paraffin wax, effective component of 35 percent by mass, manufactured by BYK Japan
AQUACER 531: Modified polyethylene wax, effective component of 45 percent by mass, manufactured by BYK Japan

Mildew-Proofing Agent
PROXEL GXL: mildew-proofing agent mainly composed of 1,2-benzisothiazolin-3-one, component of 20 percent, containing dipropylene glycol, manufactured by Avecia Inkjet Limited

TABLE 11

| | | Pre- | Pre- | Pre- | Pre- |
|---|---|---|---|---|---|
| | | processing | processing | processing | processing |
| Component (percent by mass) | | fluid 1 | fluid 2 | fluid 3 | fluid 4 |
| Inorganic | Magnesium sulfate | 12.50 | 12.50 | 12.50 | — |
| metal salt | Calcium chloride | — | — | — | — |
| Organic acid | Ammonium lactate | — | — | — | — |
| ammonium salt | | | | | |
| Organic acid | Calcium lactate | — | — | — | — |
| metal salt | | | | | |
| Cationic | SHALLOL DC-902P | — | — | — | 19.61 |
| polymer | (manufactured by DKS | | | | |
| | Co., Ltd.) | | | | |
| | DK8610, manufactured | — | — | — | — |
| | by PMC | | | | |
| Nonionic | TAKELAC ™ W-635, | — | — | 17.14 | — |
| resin | manufactured by Mitsui | | | | |
| emulsion | Chemicals, Inc. | | | | |
| | SUMIKAFLEX850HQ, | — | 12.00 | — | 12.00 |
| | manufactured by | | | | |
| | Sumitomo Chemical | | | | |
| | Company | | | | |
| | SUMIKAFLEX951HQ, | — | — | — | — |
| | manufactured by | | | | |
| | Sumitomo Chemical | | | | |
| | Company | | | | |
| Organic | Propylene glycol | 3.00 | 3.00 | 3.00 | — |
| solvent | | | | | |
| WAX | AQUACER497, | — | — | 2.00 | 1.00 |
| | manufactured by BYK | | | | |
| | Japan KK | | | | |
| | AQUACER539, | — | — | — | 1.43 |
| | manufactured by BYK | | | | |
| | Japan KK | | | | |
| | AQUACER531, | — | — | — | — |
| | manufactured by BYK | | | | |
| | Japan KK | | | | |
| Mildew- | Proxel GXL | 0.05 | 0.05 | 0.05 | 0.05 |
| proofing | | | | | |
| agent | | | | | |
| Corrosion | 1,2,3-benzotriazole | 0.10 | 0.10 | 0.10 | 0.10 |
| Inhibitor | | | | | |
| Highly pure water | | Balance | Balance | Balance | Balance |
| Total (percent by mass) | | 100 | 100 | 100 | 100 |
| | | Pre- | Pre- | Pre- | Pre- |
| | | processing | processing | processing | processing |
| Component (percent by mass) | | fluid 5 | fluid 6 | fluid 7 | fluid 8 |
| Inorganic | Magnesium sulfate | — | — | — | — |
| metal salt | Calcium chloride | 15.00 | — | 15.00 | — |
| Organic acid | Ammonium lactate | — | — | — | — |
| ammonium salt | | | | | |
| Organic acid | Calcium lactate | — | — | — | — |
| metal salt | | | | | |
| Cationic | SHALLOL DC-902P | — | — | — | — |
| polymer | (manufactured by DKS | | | | |
| | Co., Ltd.) | | | | |
| | DK8610, manufactured | — | 22.73 | — | 22.73 |
| | by PMC | | | | |
| Nonionic | TAKELAC ™ W-635, | — | — | — | — |
| resin | manufactured by Mitsui | | | | |
| emulsion | Chemicals, Inc. | | | | |
| | SUMIKAFLEX850HQ, | 20.00 | — | 20.00 | — |
| | manufactured by | | | | |
| | Sumitomo Chemical | | | | |
| | Company | | | | |
| | SUMIKAFLEX951HQ, | — | 13.64 | — | 13.64 |
| | manufactured by | | | | |
| | Sumitomo Chemical | | | | |
| | Company | | | | |
| Organic | Propylene glycol | — | — | — | — |
| solvent | | | | | |
| WAX | AQUACER497, | — | — | 5.00 | — |
| | manufactured by BYK | | | | |
| | Japan KK | | | | |
| | AQUACER539, | — | — | — | 5.71 |
| | manufactured by BYK | | | | |
| | Japan KK | | | | |
| | AQUACER531, | — | — | — | — |
| | manufactured by BYK | | | | |
| | Japan KK | | | | |
| Mildew- | Proxel GXL | 0.05 | 0.05 | 0.05 | 0.05 |
| proofing | | | | | |
| agent | | | | | |
| Corrosion | 1,2,3-benzotriazole | 0.10 | 0.10 | 0.10 | 0.10 |
| Inhibitor | | | | | |
| Highly pure water | | Balance | Balance | Balance | Balance |
| Total (percent by mass) | | 100 | 100 | 100 | 100 |
| | | Pre- | Pre- | Pre- | Pre- |
| | | processing | processing | processing | processing |
| Component (percent by mass) | | fluid 9 | fluid 10 | fluid 11 | fluid 12 |
| Inorganic | Magnesium sulfate | — | — | — | — |
| metal salt | Calcium chloride | 15.00 | 15.00 | — | — |
| Organic acid | Ammonium lactate | — | — | 15.00 | — |
| ammonium salt | | | | | |
| Organic acid | Calcium lactate | — | — | — | 15.00 |
| metal salt | | | | | |
| Cationic | SHALLOL DC-902P | — | — | — | — |
| polymer | (manufactured by DKS | | | | |
| | Co., Ltd.) | | | | |
| | DK8610, manufactured | — | — | — | — |
| | by PMC | | | | |
| Nonionic | TAKELAC ™ W-635, | — | — | 17.14 | 17.14 |
| resin | manufactured by Mitsui | | | | |
| emulsion | Chemicals, Inc. | | | | |
| | SUMIKAFLEX850HQ, | 20.00 | 20.00 | — | — |
| | manufactured by | | | | |
| | Sumitomo Chemical | | | | |
| | Company | | | | |
| | SUMIKAFLEX951HQ, | — | — | — | — |
| | manufactured by | | | | |
| | Sumitomo Chemical | | | | |
| | Company | | | | |
| Organic | Propylene glycol | — | — | 3.00 | 3.00 |
| solvent | | | | | |
| WAX | AQUACER497, | — | — | 2.00 | 2.00 |
| | manufactured by BYK | | | | |
| | Japan KK | | | | |
| | AQUACER539, | — | — | — | — |
| | manufactured by BYK | | | | |
| | Japan KK | | | | |
| | AQUACER531, | — | 5.55 | — | — |
| | manufactured by BYK | | | | |
| | Japan KK | | | | |
| Mildew- | Proxel GXL | 0.05 | 0.05 | 0.05 | 0.05 |
| proofing | | | | | |
| agent | | | | | |
| Corrosion | 1,2,3-benzotriazole | 0.10 | 0.10 | 0.10 | 0.10 |
| Inhibitor | | | | | |

| | | | | |
|---|---|---|---|---|
| Highly pure water | Balance | Balance | Balance | Balance |
| Total (percent by mass) | 100 | 100 | 100 | 100 |

Image Forming Using Ink Set

### Examples 1 to 19 and Comparative Examples 1 to 5

In an environment in which the temperature and moisture were controlled at 23±0.5 degrees C. and 50±5 percent RH, an inkjet printer, Direct to Garment Printer RICOH Ri 6000, manufactured by RICOH CO., LTD., was used to attach the same amount of ink to printing media by changing the drive voltage of piezoelectric element.

A pre-processing fluid was applied to a printing medium by a printing method according to the combination of the pre-processing fluid, printing medium, and printing method shown in Table 12. If a dark polyester T-shirt was used, the T-shirt was dried at 130 degrees C. in an oven for 90 seconds. In the case of a dark colored cotton T-shirt, the T-shirt was dried at 165 degrees C. in an oven for 90 seconds.

Next, the white ink and the color ink in the ink set shown in Table 12 were filled in the inkjet printer mentioned above. They formed a solid white image on the region where the pre-processing fluid was applied by discharging the white ink in the amount shown in Table 12. The color ink was applied in the amount shown in Table 12 to the solid image 17 seconds after the application of the white ink. The chart illustrated in FIG. 3 was thus obtained. The printing media were not heated between the application of the white ink and the application of the color ink.

Thereafter, when the printing medium on which the chart was formed was a PET film, it was dried in an oven at 70 degrees C. for 5 minutes. For a dark polyester T-shirt, at 130 degrees C. for 3 minutes and for a dark colored cotton T-shirt, at 165 degrees C. for 2 minutes.

In FIG. 3, W represents the white solid image, Y represents the yellow solid image formed on the W, M represents the magenta solid image formed on the W, C represents the cyan solid image formed on the W, R represents the red solid image formed on the W, B represents the blue solid image formed on the W, G represents the green solid image formed on the W, K represents the black solid image formed on the W, k1 to k6 represent the black letter R formed on the W, and y represents the yellow letter R formed on the W. The image illustrated in FIG. 3 was created based on an image digitized using PhotoShop^{registered}, a software product of Adobe Inc., without color calibration and printed at 600 dpi×600 dpi. The details of each printing medium shown in Table 11 below are as follows.
Lumirror^{trademark} #50-T11, transparent PET film subjected to readily attachable treatment, manufactured by Toray Industries, Inc.
00085—CVT, dark colored cotton T-shirt, Printstar 00085—CVT Black, manufactured by TOMS CO., LTD.
00300-ACT, dark polyester T-shirt, Glimmer 00300-ACT Black, manufactured by TOMS CO., LTD.

For each sample image obtained, Hunter's Brightness, rub resistance, and discharging stability (continuous discharging and decapped discharging) were evaluated in the following manner. The results are shown in Table 12.

Hunter's Brightness

The image density of the white solid image portion in each of the sample images obtained in Examples 1 to 17 and Comparative Examples 1 to 5 was measured to obtain L, a, and b using a spectrodensitometer, X-rite eXact, manufactured by X-rite Inc. Hunter's Brightness was calculated according to the following expression 1 and evaluated according to the evaluation criteria below.

The image density was measured for a sample image placed on five overlapped sheets of color quality paper, middle thick paper, black paper, manufactured by Hokuetsu Corporation. Grade A and B are allowable for a practical purpose.

Hunter's Brightness 100−sqr[(100−L)²+(a²+b²) expression 1

Evaluation Criteria
A+: Hunter's Brightness was 85 or more
A: Hunter's Brightness was 80 to less than 85
B: Hunter's brightness was from 75 to less than 80
C: Hunter's brightness was from 70 to less than 75
D: Hunter's Brightness was less than 70

Rub Resistance

The test was conducted based on the friction tester I type (clockmeter) using a friction tester I type according to the method regulated in JIS L 0849 (Test methods for colour fastness to rubbing) format. Drying friction and Wet friction were tested in accordance with the drying test regulated in JIS L 0849 format, and evaluated according to the following evaluation criteria. Grade A, B, and C are allowable for a practical purpose.

Evaluation Criteria
A: Color standard class 4-5 to 5
B: Color standard class 3-4 to 4
C: Color standard class 2-3 to 3
D: Color standard class 2 or lower

Continuous Discharging

One litter of each ink adjusted for a discharging head for each color was flown by passage at 23±1 degrees C. from the ink cartridge of the inkjet printing device (IPSiO Gxe-5500, manufactured by Ricoh Co., Ltd.). Immediately after the passage, the inkjet printing device continuously printed a chart of a solid image created by Microsoft Word 2000 with an area of 80 percent of A4 paper on My Paper (manufactured by Ricoh Co, Ltd.) with a run length of 200. After the printing, the nozzle check chart was printed and evaluated regarding discharging disturbance of each nozzle according to the following criteria.

The print mode used was: a modified mode in which Plain Paper—Standard Fast was modified to No Color Calibration from the user setting for plain paper by the driver installed onto the printer. Grade A and B are allowable for a practical purpose.

Evaluation Criteria
A: No disturbed discharging
B: Slight disturbed discharging
C: Nozzles with discharging defects or no discharging present
D: Significant disturbed discharging or many non-discharging nozzles

Evaluation on Decapped Discharging

The ink cartridge of an inkjet printing device (IPSiO GXe-5500, manufactured by Ricoh Co., Ltd.) supplied individually-adjusted ink to the discharging head of each color at 23±1 degrees C. The cap was forcibly removed from the head to create a decapped state. The head was thereafter left to stand for 17 minutes. A nozzle check chart was printed, followed by evaluated regarding discharging defects, i.e., disturbed discharging, according to the following evaluation criteria. Grade A and B are allowable for a practical purpose.

Evaluation Criteria
A: No disturbed discharging
B: Slight disturbed discharging
C: Nozzles with discharging defects or without discharging were present
D: Significant disturbed discharging or many non-discharging nozzles

TABLE 12

| | | | Pre-processing fluid | | |
|---|---|---|---|---|---|
| | | | | | Amount |
| | Recording medium | | | Method of | (g/m²) |
| | Product name | Material | No. | application | attached |
| Example 1 | Lumirror^{trademark} | PET film | None | — | — |
| | #50-T11 | | | | |
| Example 2 | 00085-CVT | Cotton | None | — | — |
| Example 3 | 00085-CVT | Cotton | Pre-processing | Hand | 352 |
| | | | fluid 3 | spray | |
| Example 4 | 00085-CVT | Cotton | Pre-processing | Hand | 352 |
| | | | fluid 1 | spray | |
| Example 5 | 00085-CVT | Cotton | Pre-processing | Hand | 352 |
| | | | fluid 2 | spray | |
| Example 6 | 00085-CVT | Cotton | Pre-processing | Hand | 352 |
| | | | fluid 3 | spray | |
| Example 7 | 00085-CVT | Cotton | Pre-processing | Hand | 352 |
| | | | fluid 3 | spray | |
| Example 8 | 00085-CVT | Cotton | Pre-processing | Hand | 352 |
| | | | fluid 3 | spray | |
| Example 9 | 00085-CVT | Cotton | Pre-processing | Hand | 352 |
| | | | fluid 4 | spray | |
| Example 10 | 00085-CVT | Cotton | Pre-processing | Hand | 352 |
| | | | fluid 5 | spray | |
| Example 11 | 00085-CVT | Cotton | Pre-processing | Hand | 352 |
| | | | fluid 6 | spray | |
| Example 12 | 00300-ACT | Polyester | Pre-processing | Hand | 352 |
| | | | fluid 5 | spray | |
| Example 13 | 00300-ACT | Polyester | Pre-processing | Hand | 352 |
| | | | fluid 6 | spray | |
| Example 14 | 00300-ACT | Polyester | Pre-processing | Hand | 352 |
| | | | fluid 7 | spray | |
| Example 15 | 00300-ACT | Polyester | Pre-processing | Hand | 352 |
| | | | fluid 8 | spray | |
| Example 16 | 00300-ACT | Polyester | Pre-processing | Hand | 352 |
| | | | fluid 9 | spray | |
| Example 17 | 00300-ACT | Polyester | Pre-processing | Hand | 352 |
| | | | fluid 10 | spray | |
| Example 18 | 00300-ACT | Polyester | Pre-processing | Hand | 352 |
| | | | fluid 11 | spray | |
| Example 19 | 00300-ACT | Polyester | Pre-processing | Hand | 352 |
| | | | fluid 12 | spray | |
| Comparative | 00085-CVT | Cotton | None | — | — |
| Example 1 | | | | | |
| Comparative | 00085-CVT | Cotton | Pre-processing | Hand | 352 |
| Example 2 | | | fluid 3 | spray | |
| Comparative | 00085-CVT | Cotton | Pre-processing | Hand | 352 |
| Example 3 | | | fluid 5 | spray | |
| Comparative | 00300-ACT | Polyester | Pre-processing | Hand | 352 |
| Example 4 | | | fluid 5 | spray | |
| Comparative | 00300-ACT | Polyester | Pre-processing | Hand | 352 |
| Example 5 | | | fluid 8 | spray | |

| | | Amount | Amount | Evaluation result | | | Discharging stability | |
|---|---|---|---|---|---|---|---|---|
| | | (g/m²) | (g/m²) | | Fastness to friction | | | Discharging |
| | | of white ink | of color ink | Hunter's | Dry | Wet | Continuous | with |
| | Ink set | attached | attached | brightness | friction | friction | discharging | decapped |
| Example 1 | Manufacturing | 21 | 11 ± 0.5 | A | C | C | A | A |
| | Examples 6 to | | | | | | | |
| | 10 | | | | | | | |
| Example 2 | Manufacturing | 220 | 19 ± 1 | A+ | A | B | A | A |
| | Examples 16 | | | | | | | |
| | to 20 | | | | | | | |
| Example 3 | Manufacturing | 220 | 19 ± 1 | A | C | C | B | B |
| | Examples 41 | | | | | | | |
| | to 45 | | | | | | | |
| Example 4 | Manufacturing | 220 | 19 ± 1 | B | A | A | A | A |
| | Examples 6 to | | | | | | | |
| | 10 | | | | | | | |
| Example 5 | Manufacturing | 220 | 19 ± 1 | A | A | A | A | A |
| | Examples 6 to | | | | | | | |
| | 10 | | | | | | | |
| Example 6 | Manufacturing | 220 | 19 ± 1 | A+ | A | B | A | A |
| | Examples 6 to | | | | | | | |
| | 10 | | | | | | | |
| Example 7 | Manufacturing | 220 | 19 ± 1 | A | C | C | B | B |
| | Examples 1 to | | | | | | | |
| | 5 | | | | | | | |
| Example 8 | Manufacturing | 220 | 19 ± 1 | A+ | A | B | A | A − B |
| | Examples 11 | | | | | | | |
| | to 15 | | | | | | | |
| Example 9 | Manufacturing | 220 | 19 ± 1 | A+ | A | B | A | A |
| | Examples 16 | | | | | | | |
| | to 20 | | | | | | | |
| Example 10 | Manufacturing | 220 | 19 ± 1 | A | A | A | A | A − B |
| | Examples 21 | | | | | | | |
| | to 25 | | | | | | | |
| Example 11 | Manufacturing | 220 | 19 ± 1 | A | A | A | A − B | A − B |
| | Examples 26 | | | | | | | |
| | to 30 | | | | | | | |
| Example 12 | Manufacturing | 220 | 19 ± 1 | B | A | B | A | A |
| | Examples 6 to | | | | | | | |
| | 10 | | | | | | | |
| Example 13 | Manufacturing | 220 | 19 ± 1 | B | A | B | A | A − B |
| | Examples 11 | | | | | | | |
| | to 15 | | | | | | | |
| Example 14 | Manufacturing | 220 | 19 ± 1 | A+ | A | B | A | A |
| | Examples 16 | | | | | | | |
| | to 20 | | | | | | | |
| Example 15 | Manufacturing | 220 | 19 ± 1 | A+ | A | A | A | A − B |
| | Examples 21 | | | | | | | |
| | to 25 | | | | | | | |
| Example 16 | Manufacturing | 220 | 19 ± 1 | B | A | A | A | A − B |
| | Examples 26 | | | | | | | |
| | to 30 | | | | | | | |
| Example 17 | Manufacturing | 220 | 19 ± 1 | A | A | B | A | A − B |
| | Examples 26 | | | | | | | |
| | to 30 | | | | | | | |
| Example 18 | Manufacturing | 220 | 19 ± 1 | A+ | A | A | A | A − B |
| | Examples 26 | | | | | | | |
| | to 30 | | | | | | | |
| Example 19 | Manufacturing | 220 | 19 ± 1 | A+ | A | A | A | A − B |
| | Examples 26 | | | | | | | |
| | to 30 | | | | | | | |
| Comparative | Manufacturing | 220 | 19 ± 1 | C | C | D | C − D | C − D |
| Example 1 | Examples 36 | | | | | | | |
| | to 40 | | | | | | | |
| Comparative | Manufacturing | 220 | 19 ± 1 | A+ | A | B | C − D | D |
| Example 2 | Examples 31 | | | | | | | |
| | to 35 | | | | | | | |
| Comparative | Manufacturing | 220 | 19 ± 1 | A | C | D | C − D | C − D |
| Example 3 | Examples 36 | | | | | | | |
| | to 40 | | | | | | | |
| Comparative | Manufacturing | 220 | 19 ± 1 | B | A | B | C − D | D |
| Example 4 | Examples 31 | | | | | | | |
| | to 35 | | | | | | | |
| Comparative | Manufacturing | 220 | 19 ± 1 | A | D | D | C − D | C − D |
| Example 5 | Examples 36 | | | | | | | |
| | to 40 | | | | | | | |

Aspects of the present disclosure are, for example, as follows.

1. An ink contains a coloring material, an organic solvent containing an organic solvent A and a compound represented by the following Chemical Formula I, and a resin, wherein the proportion of the entire of the coloring material and the solid content of the resin to the entire of the ink is 15 percent by mass or greater,
wherein the organic solvent A contains a polyol with a boiling point of 180 degrees C. or higher and with an equilibrium moisture content of 36 percent by mass or greater at 23 degrees C. and 80 percent RH.

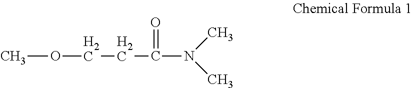

2. The ink according to 1 mentioned above further contains an organic solvent B that contains a polyol with a boiling point of from 140 to lower than 250 degrees C. and with an equilibrium moisture content of 30 percent by mass or greater at 23 degrees C. and 80 percent RH.

3. The ink according to 1 or 2 mentioned above, wherein the glass transition temperature of the resin is 0 degrees C. or lower.

4. The ink according to any one of 1 to 3 mentioned above further contains a surfactant.

5. The ink according to 4 mentioned above, wherein the surfactant contains at least one of an acetylene-based surfactant, a silicone-based surfactant, or a fluorochemical surfactant.

6. An ink set contains a white ink of any one of 1 to 5 mentioned above and a color ink of any one of 1 to 5 mentioned above.

7. A set contains the ink of any one of 1 to 5 mentioned above and a pre-processing fluid containing water, and a flocculant containing at least one member selected from an inorganic metal salt, an organic acid metal salt, an organic acid ammonium salt, and a cationic polymer.

8. The set according to 7 mentioned above, wherein the pre-processing fluid further contains a nonionic resin.

9. The set according to 8 mentioned above, wherein the proportion of the nonionic resin in the pre-processing fluid is from 5 to 10 percent by mass.

10. The set according to any one of 7 to 9 mentioned above, wherein the pre-processing fluid further contains a wax.

11. The set according to 10 mentioned above, wherein the wax contains paraffin wax.

12. A method of discharging an ink includes applying the ink of any one of 1 to 5 mentioned above to a printing medium.

13. The method according to 12 mentioned above further includes applying a pre-processing fluid containing water and a flocculant to the printing medium, wherein the flocculant contains at least one member selected from an inorganic metal salt, an organic acid metal salt, an organic acid ammonium salt, and a cationic polymer.

14. The method according to 12 or 13 further includes applying a white ink of the ink of any one of 1 to 5 mentioned above to the printing medium and applying a color ink of the ink of any one of 1 to 5 mentioned above to the printing medium.

15. The method according to 14 mentioned above, wherein the applying the color ink includes applying the color ink to the region of the printing medium where the white ink has been applied.

16. The ink according to any one of 12 to 15 mentioned above further includes drying.

17. The method according to any one of 14 to 16 mentioned above further includes applying a pre-processing fluid to a region of the printing medium where the white ink is to be applied before the white ink is applied, drying the pre-processing fluid at a temperature range of from 100 to 160 degrees C. for 60 to 300 seconds after the pre-processing fluid is applied, and drying the color ink at a temperature range of from 100 to 150 degrees C. for 60 to 300 seconds after the color ink is applied.

18. The method according to any one of 12 to 17 mentioned above, wherein the printing medium is dark colored fabric.

19. An ink discharging device includes the ink of any one of 1 to 5 mentioned above, a container containing the ink, and an ink applying unit for applying the ink to a printing medium.

20. The ink discharging device according to 19 mentioned above further includes a container containing a white ink of the ink of any one of 1 to 5 mentioned above, a container containing a color ink of the ink of any one of 1 to 5 mentioned above, a white ink applying unit for applying the white ink to the printing medium, and a color ink applying unit for applying the color ink to the region of the printing medium where the white ink has been applied.

21. The ink discharging device according to 19 or 20 mentioned above further includes a container containing a pre-processing fluid containing water and a flocculant, the flocculant containing at least one member selected from an inorganic metal salt, an organic acid metal salt, an organic acid ammonium salt, and a cationic polymer, and a pre-processing fluid applying unit for applying the pre-processing fluid to the region of the printing medium where the white ink is to be applied before the white ink is applied.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An ink, comprising:
a coloring material;
an organic solvent comprising an organic solvent A and a compound represented by the following Chemical Formula I 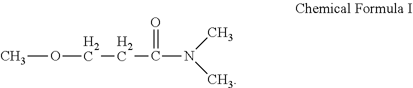
and
a resin,
wherein a proportion of an entire of the coloring material and a solid content of the resin to an entire of the ink is 15 percent by mass or greater, and
the organic solvent A comprises a polyol with a boiling point of 180 degrees C. or higher and with an equilibrium moisture content of 36 percent by mass or greater at 23 degrees C. and 80 percent RH.

2. The ink according to claim 1, further comprising an organic solvent B comprising a polyol with a boiling point of from 140 to lower than 250 degrees C. and with an equilibrium moisture content of 30 percent by mass or greater at 23 degrees C. and 80 percent RH.

3. The ink according to claim 1, wherein the resin has a glass transition temperature of 0 degrees C. or lower.

4. The ink according to claim 1, further comprising a surfactant.

5. The ink according to claim 4, wherein the surfactant comprises at least one of an acetylene-based surfactant, a silicone-based surfactant, or a fluorochemical surfactant.

6. An ink set, comprising:
a white ink of the ink of claim 1; and
a color ink of the ink of claim 1.

7. A set, comprising:
the ink of claim 1; and
a pre-processing fluid comprising
water; and
a flocculant comprising at least one member selected from the group consisting of an inorganic metal salt, an organic acid metal salt, an organic acid ammonium salt, and a cationic polymer.

8. The set according to claim 7, wherein the pre-processing fluid further comprises a nonionic resin.

9. The set according to claim 8, wherein a proportion of the nonionic resin in the pre-processing fluid is from 5 to 10 percent by mass.

10. The set according to claim 7, wherein the pre-processing fluid further comprises a wax.

11. The set according to claim 10, wherein the wax comprises paraffin wax.

12. A method of discharging an ink, comprising:
applying the ink of claim 1 to a printing medium.

13. The method according to claim 12, further comprising applying a pre-processing fluid comprising water and a flocculant to the printing medium,
wherein the flocculant comprises at least one member selected from the group consisting of an inorganic metal salt, an organic acid metal salt, an organic acid ammonium salt, and a cationic polymer.

14. The method according to claim 12, further comprising applying a white ink comprising the ink to the printing medium, and applying a color ink comprising the ink to the printing medium.

15. The method according to claim 14, wherein the applying a color ink includes applying the color ink to a region of the printing medium where the white ink has been applied.

16. The method according to claim 14, further comprising:
applying a pre-processing fluid to a region of the printing medium where the white ink is to be applied before the white ink is applied;
drying the pre-processing fluid at a temperature range of from 100 to 160 degrees C. for 60 to 300 seconds after the pre-processing fluid is applied; and
drying the color ink at a temperature range of from 100 to 150 degrees C. for 60 to 300 seconds after the color ink is applied.

17. The method according to claim 12, wherein the printing medium is dark-colored fabric.

18. An ink discharging device, comprising:
the ink of claim 1;
a container containing the ink; and
an ink applying unit configured to apply the ink to a printing medium.

19. The ink discharging device according to claim 18, further comprising:
a container containing a white ink comprising the ink;
a container containing a color ink comprising the ink;
a white ink applying unit configured to apply the white ink to the printing medium; and
a color ink applying unit configured to apply the color ink to a region of the printing medium where the white ink has been applied.

20. The ink discharging device according to claim 19, further comprising:
a container containing a pre-processing fluid comprising water and a flocculant, the flocculant comprising at least one member selected from the group consisting of an inorganic metal salt, an organic acid metal salt, an organic acid ammonium salt, and a cationic polymer; and
a pre-processing fluid applying unit configured to apply the pre-processing fluid to a region of the printing medium where the white ink is to be applied before the white ink is applied.
